(19) United States
(12) Patent Application Publication
(10) Pub. No.: US 2005/0144096 A1
(43) Pub. Date: Jun. 30, 2005

(54) Financial visualization and analysis systems

(76) Inventors: George S. Caramanna II, Scottsdale, AZ (US); Andreas Schloissnik, Phoenix, AZ (US)

Correspondence Address: STONEMAN LAW OFFICES, LTD, 3113 NORTH 3RD STREET, PHOENIX, AZ, 85012, US

(21) Appl. No.: 11/021,461

(22) Filed: Dec. 23, 2004

Related U.S. Application Data
(60) Provisional application No. 60/532,489, filed on Dec. 26, 2003.
(60) Provisional application No. 60/614,631, filed on Sep. 30, 2004.

(51) Int. Cl. G06F 17/60

(52) U.S. Cl. 705/30

(57) ABSTRACT

A method and system of financial analysis for use by trained and untrained users which provides improved visualization, understanding, and analysis of companies' financial performances. Particularly, it allows the end user to prepare a sophisticated financial analysis by creating an effective bridge between financial analysis and the underlying financial information. It uses interfaces similar to digital video editors to permit sequential analysis with annotation of financial data in the same manner as editing and compositing film or video materials. It presents the financial data and related non-financial data in a visual analog format for discussion and analysis by one or more users. The income statement, balance sheet and statement of cash flows are analyzed as a whole rather than separately as individualized statements. And it provides for direct interfaces with all underlying financial and related data. The analysis steps created by a user may be captured and recorded for later play back, communication and analysis. A recorded analysis may be a modifiable allowing analysis, input and comment by other individuals to form a comparative analysis that is an analytical sum of all contributors.

### CROSS-REFERENCE TO RELATED APPLICATIONS

The present application is related to and claims priority from prior provisional application Ser. No. 60/532,489, filed Dec. 26, 2003, entitled “FINANCIAL VISUALIZATION AND ANALYSIS SYSTEMS”, and prior provisional application Ser. No. 60/614,631, filed Sep. 30, 2004, entitled “FINANCIAL VISUALIZATION AND ANALYSIS SYSTEMS”, the contents of both of which are incorporated herein by this reference and are not admitted to be prior art with respect to the present invention by the mention in this cross-reference section.

### BACKGROUND

This invention relates to financial visualization and analysis systems. More particularly, it relates to a method and system of financial analysis for use by trained and untrained users which provides improved visualization, understanding, and analysis of companies' financial performances.

Typically, people without professional training in accounting and finance must rely on professionals for effective financial analysis. The complexities of double entry accounting and arcane rules of the associated financial reporting make the simplest analysis of financial situations a daunting task for the untrained user.

Today's non-professionals wishing to analyze the financial strengths and weaknesses of a business, large or small, must rely on professionals or use a variety of disjointed tools which often do not provide a straightforward analysis. Consequently, when using existing financial analysis tools, non-professionals still must understand the principles of accounting to make evaluations as to how the various bits of information provided relate to each other to determine the overall financial health of a company.

Additionally, often even professionals must use the same disjointed tools to obtain the require insights to the financial health of a company. This means they must then prepare a summary financial report as a separate and usually static document for their client. The prior systems are time-consuming and generally lack ways for accommodating changes or additions such as comparisons with other similar companies. Finally, these systems do not provide a method for the client to work interactively with the report to satisfy questions which inevitably arise.

Finally, managers and financial analysts are often forced to use simplistic “seat of the pants” methods of preparing projections and forecasts.

Therefore, it is highly desirable to provide an interactive system of financial analysis which is usable by both professionals and non-professionals.

### OBJECTS AND FEATURES OF THE INVENTION

A primary object and feature of the present invention is to overcome the above-mentioned shortcomings and others. A further object and feature is to provide a system for assisting in the analysis and presentation of financial data in a visual analog format which is easily understood by users without a professional financial background.

It is a further object and feature of the present invention to provide such a system which permits analysis of a company's income statement, balance sheet and statement of cash flows and data as a whole. Another object and feature of the present invention is to permit creation of visual timeline-controlled financial analysis presentations which can be distributed to users. Yet another object and feature of the present invention is to provide financial analysis presentation creation and editing tools which operate similarly to video editing tools. Still another object and feature of the present invention is to permit users to use familiar audio/video playback functions to view a financial analysis presentation. A further object and feature of the present invention is to permit creation of visual timeline-controlled financial analysis presentations that can allow users to annotate a financial analysis presentation and share the revised version with other users.

Other objects and features of this invention will become apparent with reference to the following descriptions.

### SUMMARY OF THE INVENTION

In accordance with a preferred embodiment hereof, this invention provides a system, relating to assisting sequential presentation of at least one analysis of at least one set of data records by at least one first analyzer, comprising the steps of: providing at least one computer application adapted to assist computer-manipulating of such at least one set of data records by such at least one first analyzer to assist providing at least one sequential presentation of at least one set of analyses; wherein such step of providing at least one computer application adapted to assist computer-manipulating of such at least one set of data records by such at least one first analyzer to assist providing at least one sequential presentation of at least one set of analyses comprises the steps of providing, as part of such computer application, at least one first software tool adapted to permit such at least one first analyzer to add at least one sequentially-appropriate annotation to such at least one analysis, and providing as part of such computer application at least one second software tool adapted to permit such at least one first analyzer to sequentially organize such at least one set of analyses; and permitting access to such resulting at least one sequential presentation of such at least one set of analyses. Moreover, it provides such a system wherein such step of providing at least one computer application adapted to assist computer-manipulating of such at least one set of data records by such at least one first analyzer to provide at least one sequential presentation of at least one set of analyses comprises the step of providing at least one third software tool, as part of such computer application, adapted to permit editing of such at least one sequentially-appropriate annotation by such at least one first analyzer. Additionally, it provides such a system wherein such step of providing at least one computer application adapted to assist computer-manipulating of such at least one set of data records by such at least one first analyzer to assist providing at least one sequential presentation of at least one set of analyses comprises the step of providing at least one fourth software tool, as part of such computer application, adapted to editing such at least one analysis by such at least one first analyzer. Also, it provides such a system wherein such step of providing at least one computer application adapted to assist computer-manipulating of such at least one set of data records by such at least one first analyzer to assist providing at least one sequential presentation of at least one set of analyses comprises the step of providing at least one fifth software tool, as part of such computer application, adapted to re-sequence such at least one analysis by such at least one first analyzer. In addition, it provides such a system further comprising the step of permitting such at least one sequential presentation to reside on at least one Internet website.

In accordance with another preferred embodiment hereof, this invention provides a computer program, relating to assisting sequential presentation of at least one analysis of at least one set of data records having time-relevant values by at least one first analyzer, comprising: at least one computer processor adapted to assisting computer-manipulating of such at least one set of data records having time relevant values by such at least one first analyzer to assist providing such at least one sequential presentation of at least one set of analyses; at least one computer interface adapted to permitting use of such computer system by such at least one first analyzer to add at least one sequentially-appropriate annotation to such at least one analysis; at least one computer interface adapted to permitting use of such computer system by such at least one first analyzer to sequentially organize such at least one set of analyses; and at least one computer interface adapted to permitting use of such computer system by such at least one first analyzer to create at least one such sequential presentation from such at least one set of analyses. And, it provides such a computer system wherein such at least one computer processor adapted to assisting computer-manipulating of such at least one set of data records by such at least one first analyzer to provide such at least one set of analyses comprises at least one computer processor adapted to assisting recording at least one computer system selection made by such at least one first analyzer. Further, it provides such a computer system further comprising: at least one computer processor adapted to accepting at least one first set of data records having time-relevant values relating to at least one first entity; at least one computer processor adapted to providing at least one plurality of preset analysis calculation formulas; at least one computer processor adapted to performing at least two calculations using at least two of such plurality of preset analysis calculation formulas on such at least one first set of data records having time-relevant values to obtain at least two first performance measures; at least one computer processor adapted to calculating at least two second performance measures from such at least two first performance measures; and at least one computer display adapted to simultaneously displaying such at least two second performance measures in a single first graphical visualization. Even further, it provides such a computer system further comprising: at least one computer interface adapted to permitting selecting such at least two first performance measures for display by such at least one first analyzer; at least one computer interface adapted to permitting selecting at least one first analysis time period by such at least one first analyzer; and at least one computer display adapted to simultaneously displaying such at least two first performance measures in a single second graphical visualization relating to such at least one first analysis time period. Moreover, it provides such a computer system further comprising: at least one computer interface adapted to permitting selecting at least one second analysis time period by such at least one first analyzer; and at least one computer processor adapted to assisting comparison of such at least one first performance measure relating to such at least one first analysis time period to such at least one first performance measure relating to such at least one second analysis time period. Additionally, it provides such a computer system further comprising: at least one computer interface adapted to assisting input of at least one user-defined analysis calculation formula by such at least one first analyzer; at least one computer processor adapted to performing at least one calculation using such at least one user-defined analysis calculation formula on such at least one first set of data records having time-relevant values to obtain at least one user-defined performance measure relating to such at least one first analysis time period; at least one computer interface adapted to assisting selecting, by such at least one first analyzer, of such at least one user-defined performance measure for display; and at least one computer display adapted to simultaneously displaying at least two of such at least one user-defined performance measures in at least one second graphical visualization relating to such at least one first analysis time period. Also, it provides such a computer system further comprising: at least one computer processor adapted to comparing at least one of such at least two second performance measures to at least one quality-standard range of values; and at least one computer display adapted to displaying such at least one of such at least two second performance measures not within such at least one quality-standard range of values. In addition, it provides such a computer system further comprising at least one computer display adapted to permitting display of at least one subset of such at least one first set of data records having time-relevant values relating to such at least one first analysis time period relating to such at least one first entity. And, it provides such a computer system comprising: at least one computer interface adapted to permitting selecting at least one data record having time-relevant values from such displayed data records having time-relevant values by such at least one first analyzer; and at least one computer display adapted to displaying, simultaneously with such displayed data records having time-relevant values, at least one third graphical visualization relating to such selected at least one data record having time-relevant values; wherein such at least one third graphical visualization comprises at least one graphical representation of such selected at least one data record having time-relevant values relating to each sub-set time period included within such first analysis time period of such displayed data records having time-relevant values. Further, it provides such a computer system further comprising at least one computer display adapted to continuously displaying at least one numeric value, relating to such selected at least one data record having time-relevant values, relating to such at least one sub-set time period selected by such at least one first analyzer. Even further, it provides such a computer system comprising: at least one computer interface adapted to permitting such at least one first analyzer to select at least one percentage limit relating to calculating cumulative values boundaries relating to identifying such at least one second set of most-significant data records having time-relevant values; at least one computer processor adapted to identifying such at least one second set of most-significant data records having time-relevant values, included in such at least one first set of data records having time-relevant values, within such cumulative values boundaries; and at least one computer display adapted to presenting such identified second set of most-significant data records having time-relevant values to such at least one first analyzer. Moreover, it provides such a computer system wherein such at least one computer interface adapted to permitting such at least one first analyzer to select at least one percentage limit relating to calculating cumulative values boundaries comprises at least one computer interface adapted to permitting such at least one first analyzer to reselect such at least one percentage limit relating to calculating cumulative values boundaries until the desired number of such identified data records having time-relevant values are presented. Additionally, it provides such a computer system wherein such at least one annotation may be associated with at least one date. Also, it provides such a computer system wherein such at least one annotation may be associated with at least one selected analysis category. In addition, it provides such a computer system wherein such at least one annotation may be associated with such at least one selected such performance measure. And, it provides such a computer system wherein such at least one annotation may be associated with at least one selected datum of such at least one first set of data records having time-relevant values. Further, it provides such a computer system further comprising: at least one computer processor adapted to accepting at least one second set of data records having time-relevant values relating to at least one second entity; and at least one computer processor adapted to assisting comparison of such at least one second performance measure relating to such at least one first entity to such at least one second performance measure relating to such at least one second entity. Even further, it provides such a computer system further comprising; at least one computer display adapted to displaying at least one overall measure of the reliability of such financial data using pre-set reliability standards; at least one computer display adapted to displaying at least one overall measure of financial health of such at least one first entity; and wherein such at least one overall measure of financial health comprises at least one weighted average value calculated from such at least two first performance measures. Moreover, it provides such a computer system further comprising: at least one computer processor adapted to calculating trends of at least one set of future trend-values relating correspondingly to at least one set of historical data records having time-relevant historical values, using at least one trend-line approach; at least one computer processor adapted to re-calculating each such calculated future trend-value of such at least one set of calculated future trend-values considering each correspondingly related one of such at least one set of historical data records and varying each such future trend-value according to at least one direction and at least one amount of variation from at least one such trend line of such corresponding historical value, wherein at least one set of re-calculated values is provided; at least one computer display adapted to displaying at least one graphical analysis of such at least one set of re-calculated values; at least one computer interface adapted to permitting selecting of at least one of such at least one set of re-calculated values displayed within such at least one graphical analysis by such at least one first analyzer; at least one computer interface adapted to permitting modification of such selected re-calculated at least one value to produce at least one first amended re-calculated value by such at least one first analyzer; at least one computer processor adapted to re-calculating, using a Bezier curve calculation method, at least one second amended re-calculated value. Additionally, it provides such a computer system further comprises at least one computer processor adapted to re-calculating, using a rational B-spline calculation method, at least one second amended re-calculated value. Also, it provides such a computer system further comprises at least one computer processor adapted to re-calculating, using a polygon area calculation method, at least one second amended re-calculated value. In addition, it provides such a computer system further comprises at least one computer processor adapted to re-calculating, using a variable edge blur calculation method, at least one second amended re-calculated value. And, it provides such a computer system further comprising at least one computer processor adapted to identifying at least one fourth set of most-significant data records having time-relevant values, with respect to a plurality of performance measures, calculated from at least one third set of data records having time-relevant values used to calculate such plurality of performance measures. Further, it provides such a computer system comprising: at least one computer interface adapted to permitting selection of at least one percentage limit relating to calculating cumulative values boundaries relating to identifying such at least one fourth set of most-significant line items by such at least one first analyzer; at least one computer processor adapted to identifying such at least one fourth set of most-significant data records having time-relevant values, included in such at least one plurality of third set of data records having time-relevant values, within such cumulative values boundaries; and at least one computer display adapted to presenting such identified fourth set of most-significant data record having time-relevant values. Even further, it provides such a computer system wherein such at least one computer interface adapted to permitting selection of at least one percentage limit relating to calculating cumulative values boundaries for identifying such at least one fourth set of most-significant line items by such at least one first analyzer comprises at least one computer interface adapted to permitting continuously re-selecting, by such at least one first analyzer, such at least one percentage limit relating to calculating cumulative values boundaries until the desired number of such identified fourth set of most-significant data records having time-relevant values are presented. Moreover, it provides such a computer system wherein such at least one computer interface adapted to permitting use of such computer system by such at least one first analyzer to create at least one such sequential presentation from such at least one set of analyses comprises at least one computer interface adapted to assisting editing of such at least one such sequential presentation from such at least one set of analyses by such at least one first analyzer. Additionally, it provides such a computer system wherein such at least one computer processor adapted to assisting editing of at least one such sequential presentation from such at least one set of analyses by such at least one first analyzer comprises at least one computer interface adapted to permitting re-sequencing such at least two of such at least one set of analyses by such at least one first analyzer. Also, it provides such a computer system wherein such at least one sequential presentation may comprise at least one customized-sequence annotated sequential presentation from such at least one set of analyses. In addition, it provides such a computer system further comprises the step of preparing at least one such sequential presentation viewable independently from such computer program. And, it provides such a computer system further comprising at least one computer processor adapted to permitting granting permission to alter such at least one sequential presentation to at least one second analyzer. Further, it provides such a computer system further comprising at least one computer processor adapted to permitting granting permission to view such at least one sequential presentation to at least one third analyzer. Even further, it provides such a computer system wherein such at least one annotation comprises digitized text. Moreover, it provides such a computer system wherein such at least one annotation comprises digitized audio. Additionally, it provides such a computer system wherein such at least one annotation comprises digitized video. Also, it provides such a computer system wherein such at least one annotation comprises at least one digitized image.

In accordance with another preferred embodiment hereof, this invention provides a system, relating to assisting sequential presentation of at least one analysis of at least one set of financial records by at least one first analyzer, comprising the steps of: providing at least one computer application adapted to assist computer-manipulating of such at least one set of financial records by such at least one first analyzer to assist providing at least one sequential presentation of at least one set of analyses; wherein such step of providing at least one computer application adapted to assist computer-manipulating of such at least one set of financial records by such at least one first analyzer to assist providing at least one sequential presentation of at least one set of analyses comprises the steps of providing as part of such computer application at least one first software tool, as part of such computer application, adapted to permit such at least one first analyzer to add at least one sequentially-appropriate annotation to such at least one analysis, and providing as part of such computer application at least one second software tool, as part of such computer application, adapted to permit such at least one first analyzer to sequentially organize such at least one set of analyses; and permitting access to such resulting at least one sequential presentation of such at least one set of analyses. In addition, it provides such a system wherein such step of providing at least one computer application adapted to assist computer-manipulating of such at least one set of financial records by such at least one first analyzer to assist providing at least one sequential presentation of at least one set of analyses comprises the step of providing at least one fourth software tool, as part of such computer application, adapted to editing such at least one analysis by such at least one first analyzer. And, it provides such a system wherein such step of providing at least one computer application adapted to assist computer-manipulating of such at least one set of financial records by such at least one first analyzer to assist providing at least one sequential presentation of at least one set of analyses comprises the step of providing at least one fifth software tool, as part of such computer application, adapted to re-sequence such at least one analysis by such at least one first analyzer. Further, it provides such a system further comprising the step of permitting such at least one such sequential presentation resulting from such computer application labors to reside on at least one Internet website.

In accordance with another preferred embodiment hereof, this invention provides a computer system relating to identifying a second set of line items having time-relevant line item values from within at least one report containing at least one first set of line items having time-relevant values comprising the steps of: assisting presenting such at least one report containing such first set of line items having time-relevant values to at least one user; permitting such at least one user to select at least one percentage limit relating to calculating cumulative values boundaries; identifying such at least one second set of line items having time-relevant values, included in such at least one first set of line items having time-relevant values, within such cumulative values boundaries; and presenting such identified second set of line items values having time-relevant values to such at least one user. Even further, it provides such a computer system wherein such step of permitting such at least one user to select at least one percentage limit relating to calculating cumulative values boundaries comprises the step of permitting such at least one user to continuously reselect such at least one percentage limit relating to calculating cumulative values boundaries until the desired number of such identified line items having time-relevant values are presented. Even further, it provides such a computer system wherein such at least one report is at least one financial report.

In accordance with another preferred embodiment hereof, this invention provides a computer system relating to time-based graphical analysis of at least one line item having time-relevant values within at least one report relating to at least one time period comprising the steps of: assisting presenting such at least one report containing such line items having time-relevant values to at least one user; permitting selecting such at least one line item having time-relevant values from such displayed at least one report by at least one user; and displaying, simultaneously with such displayed at least one report, such at least one time-based graphical analysis relating to such selected at least one line item having time-relevant values; wherein such at least one time-based graphical analysis comprises at least one graphical representation of such selected at least one line item having time-relevant values relating to each sub-set time period contained within such at least one time period of such displayed at least one report. Even further, it provides such a computer system wherein such at least one report is at least one financial report.

In accordance with another preferred embodiment hereof, this invention provides a computer system relating to forecasting at least one set of future values relating to at least one set of historical data records having time-relevant historical values comprising the steps of: using at least one trend-line approach, calculating trends of such at least one set of future trend-values relating correspondingly to such at least one set of historical data records having time-relevant historical values; re-calculating each such calculated future trend-value of such at least one set of calculated future trend-values considering each correspondingly related one of such at least one set of historical data records and varying each such future trend-value according to at least one direction and at least one amount of variation from at least one such trend line of such corresponding historical value, wherein at least one set of re-calculated values is provided; displaying at least one graphical analysis of such at least one set of re-calculated values; permitting selecting of at least one of such at least one set of re-calculated values displayed within such at least one graphical analysis; permitting modification of such selected re-calculated at least one value to produce at least one first amended re-calculated value; re-calculating, using a Bezier curve calculation method, at least one second amended re-calculated value. Even further, it provides such a computer system further comprises re-calculating, using a rational B-spline calculation method, at least one second amended re-calculated value. Even further, it provides such a computer system further comprises re-calculating, using a polygon area calculation method, at least one second amended re-calculated value. Even further, it provides such a computer system further comprises re-calculating, using a variable edge blur calculation method, at least one second amended re-calculated value. Even further, it provides such a computer system wherein such at least one set of data records having time-relevant historical values is at least one set of financial data records having time-relevant historical values.

In accordance with another preferred embodiment hereof, this invention provides a computer system relating to identifying at least one second set of most-significant line items having time-relevant values, with respect to at least one plurality of performance measures, calculated from at least one first set of line items having time-relevant values, used to calculate such plurality of performance measures, comprising the steps of: permitting selection of at least one percentage limit relating to calculating cumulative values boundaries relating to identifying such at least one second set of most-significant line items by at least one user; identifying such at least one second set of most-significant line items having time-relevant values, included in such at least one plurality of first set of line items having time-relevant values, within such cumulative values boundaries; and presenting such identified second set of most-significant line items values having time-relevant line item values to such at least one user. Even further, it provides such a computer system wherein such step of permitting selection of at least one percentage limit relating to calculating cumulative values boundaries relating to identifying such at least one second set of most-significant line items by at least one user comprises permitting continuously reselection of at least one percentage limit relating to calculating cumulative values boundaries relating to identifying such at least one second set of most-significant line items by such at least one user. Even further, it provides such a computer system wherein such at least one first set of line items having time-relevant values is at least one set of financial records.

In accordance with a preferred embodiment hereof, this invention provides a computer program, relating to assisting sequential presentation of at least one analysis of at least one set of data records having time-relevant values by at least one first analyzer, comprising: computer processor means for assisting computer-manipulating of such at least one set of data records having time relevant values by such at least one first analyzer to assist providing such at least one sequential presentation of at least one set of analyses; computer interface means for permitting use of such computer system by such at least one first analyzer to add at least one sequentially-appropriate annotation to such at least one analysis; computer interface means for permitting use of such computer system by such at least one first analyzer to sequentially organize such at least one set of analyses; and computer interface means for permitting use of such computer system by such at least one first analyzer to create at least one such sequential presentation from such at least one set of analyses. Moreover, it provides such a computer system wherein such computer processor means for assisting computer-manipulating of such at least one set of data records by such at least one first analyzer to provide such at least one set of analyses comprises computer processor means for assisting recording at least one computer system selection made by such at least one first analyzer. Additionally, it provides such a computer system further comprising: computer processor means for accepting at least one first set of data records having time-relevant values relating to at least one first entity; computer processor means for providing at least one plurality of preset analysis calculation formulas; computer processor means for performing at least two calculations using at least two of such plurality of preset analysis calculation formulas on such at least one first set of data records having time-relevant values to obtain at least two first performance measures; computer processor means for calculating at least two second performance measures from such at least two first performance measures; and computer display means for simultaneously displaying such at least two second performance measures in a single first graphical visualization. Also, it provides such a computer system further comprising: computer interface means for permitting selecting such at least two first performance measures for display by such at least one first analyzer; computer interface means for permitting selecting at least one first analysis time period by such at least one first analyzer; and computer display means for simultaneously displaying such at least two first performance measures in a single second graphical visualization relating to such at least one first analysis time period. In addition,.it provides such a computer system further comprising: computer interface means for permitting selecting at least one second analysis time period by such at least one first analyzer; and computer processor means for assisting comparison of such at least one first performance measure relating to such at least one first analysis time period to such at least one first performance measure relating to such at least one second analysis time period. And, it provides such a computer system further comprising: computer interface means for assisting input of at least one user-defined analysis calculation formula by such at least one first analyzer; computer processor means for performing at least one calculation using such at least one user-defined analysis calculation formula on such at least one first set of data records having time-relevant values to obtain at least one user-defined performance measure relating to such at least one first analysis time period; computer interface means for assisting selecting, by such at least one first analyzer, of such at least one user-defined performance measure for display; and computer display means for simultaneously displaying at least two of such at least one user-defined performance measures in at least one second graphical visualization relating to such at least one first analysis time period. Further, it provides such a computer system further comprising: computer processor means for comparing at least one of such at least two second performance measures to at least one quality-standard range of values; and computer display means for displaying such at least one of such at least two second performance measures not within such at least one quality-standard range of values. Even further, it provides such a computer system further comprising computer display means for permitting display of at least one subset of such at least one first set of data records having time-relevant values relating to such at least one first analysis time period relating to such at least one first entity. Moreover, it provides such a computer system comprising: computer interface means for permitting selecting at least one data record having time-relevant values from such displayed data records having time-relevant values by such at least one first analyzer; and computer display means for displaying, simultaneously with such displayed data records having time-relevant values, at least one third graphical visualization relating to such selected at least one data record having time-relevant values; wherein such at least one third graphical visualization comprises at least one graphical representation of such selected at least one data record having time-relevant values relating to each sub-set time period included within such first analysis time period of such displayed data records having time-relevant values. Additionally, it provides such a computer system further comprising computer display means for continuously displaying at least one numeric value, relating to such selected at least one data record having time-relevant values, relating to such at least one sub-set time period selected by such at least one first analyzer. Also, it provides such a computer system comprising: computer interface means for permitting such at least one first analyzer to select at least one percentage limit relating to calculating cumulative values boundaries relating to identifying such at least one second set of most-significant data records having time-relevant values; computer processor means for identifying such at least one second set of most-significant data records having time-relevant values, included in such at least one first set of data records having time-relevant values, within such cumulative values boundaries; and computer display means for presenting such identified second set of most-significant data records having time-relevant values to such at least one first analyzer. In addition, it provides such a computer system wherein such computer interface means for permitting such at least one first analyzer to select at least one percentage limit relating to calculating cumulative values boundaries comprises computer interface means for permitting such at least one first analyzer to reselect such at least one percentage limit relating to calculating cumulative values boundaries until the desired number of such identified data records having time-relevant values are presented. And, it provides such a computer system wherein such at least one annotation may be associated with at least one date. Further, it provides such a computer system wherein such at least one annotation may be associated with at least one selected analysis category. Even further, it provides such a computer system wherein such at least one annotation may be associated with such at least one selected such performance measure. Moreover, it provides such a computer system wherein such at least one annotation may be associated with at least one selected datum of such at least one first set of data records having time-relevant values. Additionally, it provides such a computer system further comprising: computer processor means for accepting at least one second set of data records having time-relevant values relating to at least one second entity; and computer processor means for assisting comparison of such at least one second performance measure relating to such at least one first entity to such at least one second performance measure relating to such at least one second entity. Also, it provides such a computer system further comprising; computer display means for displaying at least one overall measure of the reliability of such financial data using pre-set reliability standards; computer display means for displaying at least one overall measure of financial health of such at least one first entity; and wherein such at least one overall measure of financial health comprises at least one weighted average value calculated from such at least two first performance measures. In addition, it provides such a computer system further comprising: computer processor means for calculating trends of at least one set of future trend-values relating correspondingly to at least one set of historical data records having time-relevant historical values, using at least one trend-line approach; computer processor means for re-calculating each such calculated future trend-value of such at least one set of calculated future trend-values considering each correspondingly related one of such at least one set of historical data records and varying each such future trend-value according to at least one direction and at least one amount of variation from at least one such trend line of such corresponding historical value, wherein at least one set of re-calculated values is provided; computer display means for displaying at least one graphical analysis of such at least one set of re-calculated values; computer interface means for permitting selecting of at least one of such at least one set of re-calculated values displayed within such at least one graphical analysis by such at least one first analyzer; computer interface means for permitting modification of such selected re-calculated at least one value to produce at least one first amended re-calculated value by such at least one first analyzer; computer processor means for re-calculating, using a Bezier curve calculation method, at least one second amended re-calculated value. And, it provides such a computer system further comprises computer processor means for re-calculating, using a rational B-spline calculation method, at least one second amended re-calculated value. Further, it provides such a computer system further comprises computer processor means for re-calculating, using a polygon area calculation method, at least one second amended re-calculated value. Even further, it provides such a computer system further comprises computer processor means for re-calculating, using a variable edge blur calculation method, at least one second amended re-calculated value. Even further, it provides such a computer system further comprising computer processor means for identifying at least one fourth set of most-significant data records having time-relevant values, with respect to a plurality of performance measures, calculated from at least one third set of data records having time-relevant values used to calculate such plurality of performance measures. Even further, it provides such a computer system comprising: computer interface means for permitting selection of at least one percentage limit relating to calculating cumulative values boundaries relating to identifying such at least one fourth set of most-significant line items by such at least one first analyzer; computer processor means for identifying such at least one fourth set of most-significant data records having time-relevant values, included in such at least one plurality of third set of data records having time-relevant values, within such cumulative values boundaries; and computer display means for presenting such identified fourth set of most-significant data record having time-relevant values. Even further, it provides such a computer system wherein such computer interface means for permitting selection of at least one percentage limit relating to calculating cumulative values boundaries for identifying such at least one fourth set of most-significant line items by such at least one first analyzer comprises computer interface means for permitting continuously re-selecting, by such at least one first analyzer, such at least one percentage limit relating to calculating cumulative values boundaries until the desired number of such identified fourth set of most-significant data records having time-relevant values are presented. Even further, it provides such a computer system wherein such computer interface means for permitting use of such computer system by such at least one first analyzer to create at least one such sequential presentation from such at least one set of analyses comprises computer interface means for assisting editing of such at least one such sequential presentation from such at least one set of analyses by such at least one first analyzer. Even further, it provides such a computer system wherein such computer processor means for assisting editing of at least one such sequential presentation from such at least one set of analyses by such at least one first analyzer comprises computer interface means for permitting re-sequencing such at least two of such at least one set of analyses by such at least one first analyzer. Even further, it provides such a computer system wherein such at least one sequential presentation may comprise at least one customized-sequence annotated sequential presentation from such at least one set of analyses. Even further, it provides such a computer system further comprising computer processor means for preparing at least one such sequential presentation viewable independently from such computer program. Even further, it provides such a computer system further comprising computer processor means for permitting granting permission to alter such at least one sequential presentation to at least one second analyzer. Even further, it provides such a computer system further comprising computer processor means for permitting granting permission to view such at least one sequential presentation to at least one third analyzer.

In accordance with a preferred embodiment hereof, this invention provides a computer program, relating to assisting sequential presentation of at least one analysis of at least one set of data records having time-relevant values by at least one first analyzer, comprising the steps of: assisting computer-manipulating of such at least one set of data records having time relevant values by such at least one first analyzer to assist providing such at least one sequential presentation of at least one set of analyses; permitting use of such computer system by such at least one first analyzer to add at least one sequentially-appropriate annotation to such at least one analysis; permitting use of such computer system by such at least one first analyzer to sequentially organize such at least one set of analyses; and permitting use of such computer system by such at least one first analyzer to create at least one such sequential presentation from such at least one set of analyses. Moreover, it provides such a computer system wherein the step of assisting computer-manipulating of such at least one set of data records by such at least one first analyzer to provide such at least one set of analyses comprises the step of assisting recording at least one computer system selection made by such at least one first analyzer. Additionally, it provides such a computer system further comprising the steps of: accepting at least one first set of data records having time-relevant values relating to at least one first entity; providing at least one plurality of preset analysis calculation formulas; performing at least two calculations using at least two of such plurality of preset analysis calculation formulas on such at least one first set of data records having time-relevant values to obtain at least two first performance measures; calculating at least two second performance measures from such at least two first performance measures; and simultaneously displaying such at least two second performance measures in a single first graphical visualization. Also, it provides such a computer system further comprising the steps of: permitting selecting such at least two first performance measures for display by such at least one first analyzer; permitting selecting at least one first analysis time period by such at least one first analyzer; and simultaneously displaying such at least two first performance measures in a single second graphical visualization relating to such at least one first analysis time period. In addition, it provides such a computer system further comprising the steps of: permitting selecting at least one second analysis time period by such at least one first analyzer; and assisting comparison of such at least one first performance measure relating to such at least one first analysis time period to such at least one first performance measure relating to such at least one second analysis time period. And, it provides such a computer system further comprising the steps of: assisting input of at least one user-defined analysis calculation formula by such at least one first analyzer; performing at least one calculation using such at least one user-defined analysis calculation formula on such at least one first set of data records having time-relevant values to obtain at least one user-defined performance measure relating to such at least one first analysis time period; assisting selecting, by such at least one first analyzer, of such at least one user-defined performance measure for display; and simultaneously displaying at least two of such at least one user-defined performance measures in at least one second graphical visualization relating to such at least one first analysis time period. Further, it provides such a computer system further comprising the steps of: comparing at least one of such at least two second performance measures to at least one quality-standard range of values; and displaying such at least one of such at least two second performance measures not within such at least one quality-standard range of values. Even further, it provides such a computer system further comprising the step of permitting display of at least one subset of such at least one first set of data records having time-relevant values relating to such at least one first analysis time period relating to such at least one first entity. Moreover, it provides such a computer system comprising the steps of: permitting selecting at least one data record having time-relevant values from such displayed data records having time-relevant values by such at least one first analyzer; and displaying, simultaneously with such displayed data records having time-relevant values, at least one third graphical visualization relating to such selected at least one data record having time-relevant values; wherein such at least one third graphical visualization comprises at least one graphical representation of such selected at least one data record having time-relevant values relating to each sub-set time period included within such first analysis time period of such displayed data records having time-relevant values. Additionally, it provides such a computer system further comprising the step of continuously displaying at least one numeric value, relating to such selected at least one data record having time-relevant values, relating to such at least one sub-set time period selected by such at least one first analyzer. Also, it provides such a computer system comprising the steps of: permitting such at least one first analyzer to select at least one percentage limit relating to calculating cumulative values boundaries relating to identifying such at least one second set of most-significant data records having time-relevant values; identifying such at least one second set of most-significant data records having time-relevant values, included in such at least one first set of data records having time-relevant values, within such cumulative values boundaries; and presenting such identified second set of most-significant data records having time-relevant values to such at least one first analyzer. In addition, it provides such a computer system wherein such step of permitting such at least one first analyzer to select at least one percentage limit relating to calculating cumulative values boundaries comprises the step of permitting such at least one first analyzer to reselect such at least one percentage limit relating to calculating cumulative values boundaries until the desired number of such identified data records having time-relevant values are presented. And, it provides such a computer system wherein such at least one annotation may be associated with at least one date. Further, it provides such a computer system wherein such at least one annotation may be associated with at least one selected analysis category. Even further, it provides such a computer system wherein such at least one annotation may be associated with such at least one selected such performance measure. Moreover, it provides such a computer system wherein such at least one annotation may be associated with at least one selected datum of such at least one first set of data records having time-relevant values. Additionally, it provides such a computer system further comprising the steps of: accepting at least one second set of data records having time-relevant values relating to at least one second entity; and assisting comparison of such at least one second performance measure relating to such at least one first entity to such at least one second performance measure relating to such at least one second entity. Also, it provides such a computer system further comprising the steps of; displaying at least one overall measure of the reliability of such financial data using pre-set reliability standards; displaying at least one overall measure of financial health of such at least one first entity; and wherein such at least one overall measure of financial health comprises at least one weighted average value calculated from such at least two first performance measures. In addition, it provides such a computer system further comprising the steps of: using at least one trend-line approach, calculating trends of at least one set of future trend-values relating correspondingly to at least one set of historical data records having time-relevant historical values; re-calculating each such calculated future trend-value of such at least one set of calculated future trend-values considering each correspondingly related one of such at least one set of historical data records and varying each such future trend-value according to at least one direction and at least one amount of variation from at least one such trend line of such corresponding historical value, wherein at least one set of re-calculated values is provided; displaying at least one graphical analysis of such at least one set of re-calculated values; permitting selecting of at least one of such at least one set of re-calculated values displayed within such at least one graphical analysis by such at least one first analyzer; permitting modification of such selected re-calculated at least one value to produce at least one first amended re-calculated value by such at least one first analyzer; re-calculating, using a Bezier curve calculation method, at least one second amended re-calculated value. And, it provides such a computer system further comprising the step re-calculating, using a rational B-spline calculation method, at least one second amended re-calculated value. Further, it provides such a computer system further comprising the step of re-calculating, using a polygon area calculation method, at least one second amended re-calculated value. Even further, it provides such a computer system further comprising the step of computer processor means for re-calculating, using a variable edge blur calculation method, at least one second amended re-calculated value. Even further, it provides such a computer system further comprising the step of identifying at least one fourth set of most-significant data records having time-relevant values, with respect to a plurality of performance measures, calculated from at least one third set of data records having time-relevant values, used to calculate such plurality of performance measures. Even further, it provides such a computer system comprising the steps of: permitting selection of at least one percentage limit relating to calculating cumulative values boundaries relating to identifying such at least one fourth set of most-significant line items by such at least one first analyzer; identifying such at least one fourth set of most-significant data records having time-relevant values, included in such at least one plurality of third set of data records having time-relevant values, within such cumulative values boundaries; and presenting such identified fourth set of most-significant data record having time-relevant values. Even further, it provides such a computer system wherein such step of permitting selection of at least one percentage limit relating to calculating cumulative values boundaries for identifying such at least one fourth set of most-significant line items by such at least one first analyzer comprises the step of permitting continuously re-selecting, by such at least one first analyzer, such at least one percentage limit relating to calculating cumulative values boundaries until the desired number of such identified fourth set of most-significant data records having time-relevant values are presented. The computer system wherein the step of permitting use of such computer system by such at least one first analyzer to create at least one such sequential presentation from such at least one set of analyses comprises the step of assisting editing of such at least one such sequential presentation from such at least one set of analyses by such at least one first analyzer. Even further, it provides such a computer system wherein the step of assisting editing of at least one such sequential presentation from such at least one set of analyses by such at least one first analyzer comprises the step of permitting re-sequencing such at least two of such at least one set of analyses by such at least one first analyzer. Even further, it provides such a computer system wherein such at least one sequential presentation may comprise at least one customized-sequence annotated sequential presentation from such at least one set of analyses. Even further, it provides such a computer system further comprises the step of preparing at least one such sequential presentation viewable independently from such computer program. Even further, it provides such a computer system further comprising the step of permitting granting permission to alter such at least one sequential presentation to at least one second analyzer. Even further, it provides such a computer system further comprising the step of permitting granting permission to view such at least one sequential presentation to at least one third analyzer.

### DEFINITIONS, ACRONYMS AND CROSS-REFERENCES

The following terms and acronyms are explained below as background and are used throughout the detailed description:

Bezier Curve. A line created from endpoints and two or more control points which can be adjusted to control the curve's shape. A type of curve with non-uniform arcs, defined by specifying control points that set the shape of the curve. A Bezier Curve is a special case of the B-spline curve; unlike a standard B-spline curve, the Bezier does not provide for local control, meaning that changing one control point affects the entire curve.

Consider N+1 control points pk (k=0 to N) in 3 space. The Bezier parametric curve function is of the form:

$$B ( u ) = {\sum }_{k = 0}^{N} p k \frac{N !}{k ! ( N - k ) !} {{u}^{k} ( 1 - u )}^{1 - k} for 0 \leq u \leq 1$$

B(u) is a continuous function in 3 space defining the curve with N discrete control points Pₖ. u=0 at the first control point (k=0) and u=1 at the last control point (k=N).

[image]

Client-Server. A model of interaction in a distributed system in which a program at one site sends a request to a program at another site and waits for a response. The requesting program is called the “client,” and the program that responds to the request is called the “server.” In the context of the World Wide Web, the client is typically a “Web browser” that runs on a user's computer; the program that responds to Web browser requests at a Web site is commonly referred to as a “Web server.”

Database. One or more large structured sets of persistent data maintained upon a computer system organized and structured according to a software system defining rules for organization as well responding to queries to read, write or modify data as well as provide statistical information regarding the contained data. As used herein for purposes of discussion, a database may be either a single unified system or a distributed system wherein certain database elements are located upon different systems, acting in harmony to appear as one unified database.

Domain Name System (DNS). An Internet service that translates domain names (which are alphabetic identifiers) into IP addresses (which are numeric identifiers for machines on a TCP/IP network).

EDGAR. The Securities and Exchange Commission's database of registration statements, periodic reports, and other forms filed electronically for all companies, foreign and domestic, which are required to file. Anyone can access and download this information for free.

eXtensible Business Reporting Language (XBRL). The XML-based standard for identifying and communicating the complex financial information in corporate business reports. There are several other XML-based standards that focus on specific aspects of financial transactions. XBRL, on the other hand, is not designed for financial transactions, but for business reporting. This includes annual reports, SEC filings, and a variety of other reports from companies to investors, regulators, and business analysts. XBRL is for performance data rather than market data, for entities rather than investment instruments, and reported data rather than document data. XBRL defines how the numbers and facts inside a financial statement and related reports relate to one another.

Extensible Markup Language (XML). XML describes a class of data objects known as XML documents and partially describes the behavior of computer programs which process these documents. More specifically, XML is a restricted form of the Standard Generalized Markup Language (also known as SGML). XML documents are made up of storage units defined as entities which in turn comprise either parsed or unparsed data in the form of characters or simply a character. XML is designed and intended to improve the functionality of the Internet by providing more flexible and adaptive forms of information. XML can be used to store any kind of structured information and in such encapsulated form, pass it between different computer systems which would otherwise be unable to communicate.

File Transport Protocol (FTP). The protocol used on the Internet for exchanging files. FTP is most commonly used to download a file from a server using the Internet or to upload a file to a server (e.g., uploading a Web page file to a server).

Hypertext Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other websites and other Web documents (commonly referred to as “hyperlinks”). For more information on HTML, see Ian S. Graham, The HTML Source Book, John Wiley and Sons, Inc., 1995 (ISBN 0471-11894-4).

Hypertext Transport Protocol (HTTP). The standard World Wide Web client-server protocol used for the exchange of information (such as HTML documents and client requests for such documents) between a Web browser and a Web server. HTTP includes a number of different types of messages that can be sent from the client to the server to request different types of server actions. For example, a “GET” message, which has the format GET, causes the server to return the document or file located at the specified Universal Resource Locator (URL).

HTTPS. HTTP over SSL (Secure Sockets Layer) can be best understood as a secure form of HTTP communication. Specifically, SSL is a protocol utilized for the authentication and encryption of HTTP traffic. In operation, the server and client exchange a set of encryption keys that are used to create a unique encryption key used to encrypt all data exchanged during the session.

Internet. A collection of interconnected (public and/or private) networks that are linked together by a set of standard protocols to form a distributed network. While this term is intended to refer to what is now commonly known as the Internet, it is also intended to encompass variations that may be made in the future, including changes and additions to existing standard protocols.

LAN. A Local Area Network of computer systems, typically within a building or office, permitting networking, the associated sharing of resources and files, such as application software, printers and client information, in an inter-office setting.

PHP. A server-side, cross-platform, HTML-embedded scripting language used to create dynamic web pages. PHP is Open Source software.

Rational B-spline. Mathematical representations of 2- or 3-dimensional objects, which can be standard shapes (such as a cone) or free-form shapes (such as a car) are usually referred to as NURBS (non-uniform rational B-splines). NURBS are used in computer graphics and the CAD/CAM industry and have come to be regarded as a standard way to create and represent complex objects. In addition to curves and surfaces, NURBS can also represent hypersurfaces. Most sophisticated graphic creation tools provide an interface for using NURBS, which are flexible enough to design a wide range of shapes—anything from points to straight lines to conic sections. NURBS are compact expressions that can be evaluated and displayed quickly. NURBS work especially well in 3-D modeling, allowing the designer to easily manipulate control vertices, called ISO curves, and control curvature and the smoothness of contours. NURBS are defined by both control points and weights. It takes very little data to define a NURB. A spline is a usually curvy pattern used to guide someone shaping something large, such as a boat hull. The B-spline is based (the B stands for basis) on four local functions or control points that lie outside the curve itself. Non-uniform is the idea that some sections of a defined shape (between any two points) can be shortened or elongated relative to other sections in the overall shape. Rational describes the ability to give more weight to some points in the shape than to other points in considering each positions relation to another object. (This is sometimes referred to as a 4th dimensional characteristic.)

Structured Query Language (SQL). SQL is a standard language used to communicate with relational database management systems (such as Oracle, Sybase, Microsoft SQL Server, Access, etc.) for the purpose of performing tasks such as data insertion, deletion, update, and general query for the return of data.

The Simple Object Access Protocol (SOAP). SOAP is a lightweight XML/HTTP-based protocol for the exchange of information in a decentralized distributed platform-independent environment. Fundamentally, SOAP consists of three parts. The first is an envelope that defines a framework for describing what is contained in the message and how it should be processed. The second is a set of encoding rules for expressing instances of application-defined data types. The third is a normalized convention for representing remote procedure calls and responses.

Transmission Control Protocol/Internet Protocol (TCP/IP). A standard Internet protocol (or set of protocols) which specifies how two computers exchange data over the Internet. TCP/IP handles issues such as packetization, packet addressing, and handshaking and error correction. For more information on TCP/IP, see Volumes I, II and III of Comer and Stevens, Internet working with TCP/IP, Prentice Hall, Inc., ISBNs 0-13-468505-9 (vol. 1), 0-13-125527-4 (vol. II), and 0-13-474222-2 (vol. III).

Uniform Resource Locator (URL). A unique address which fully specifies the location of a file or other resource on the Internet. The general format of a URL is protocol://machine address:port/path/filename. The port specification is optional, and, if not entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

Variable Edge Blur. A method within the video editing industry for simulating the blurring effects of motion to objects. In other words, allowing the edge of an object to fall within a visible range, rather than as a single point or line. As applied within the present invention variable edge blur calculations may be applied to projected values to indicate at least one potential range of outcomes due to uncertainty.

WAN. A Wide Area Network, such as the Internet.

World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the Hypertext Transfer Protocol-(HTTP), and the electronic pages are encoded using the Hypertext Markup Language (HTML). However, the terms “World Wide Web” and “Web” are intended to encompass future markup languages and transport protocols that may be used in place of or in addition to the Hypertext Markup Language (HTML) and the Hypertext Transfer Protocol (HTTP).

### BRIEF DESCRIPTION OF THE DRAWINGS

FIG. 1 shows a diagrammatical overview of the Internet communications used in the instant system according to a preferred embodiment of the present invention.

FIG. 2 shows a simplified functional diagrammatical overview of the relationship among the web site servers and users of the instant system according to a preferred embodiment of the present invention.

FIG. 3 shows a diagrammatical overview of the preferred primary communication paths, communication methods, components and information flows of the instant system according to a preferred embodiment of the present invention.

FIG. 4 shows a diagrammatical view of the preferred process for preparing a financial analysis presentation according to a preferred embodiment of the present invention.

FIG. 5 shows a diagrammatical view of the preferred relationship of the primary user interface screens according to a preferred embodiment of the present invention.

FIG. 6 shows a diagrammatical view of the preferred relationship of the primary user interface screens used in off-line playback of a presentation according to a preferred embodiment of the present invention.

FIG. 7 shows a diagrammatical view of the preferred licensing and business relationship of a licensor and licensee when the licensor provides the instant system as a service to the licensor.

FIG. 8 shows a diagrammatical view of the preferred licensing and business relationship of a licensor and licensee when the licensor provides the instant system for installation on the computing systems of the licensor.

FIG. 9 shows a diagrammatical view of the preferred licensing and business relationship of a licensor and licensee when the licensee is an individual.

FIG. 10 shows a diagrammatical view of the preferred primary analysis interface screen in mockup form according to a preferred embodiment of the present invention.

FIG. 11 shows a diagrammatical view of the preferred primary analysis interface screen according to a preferred embodiment of the present invention.

FIG. 12 shows a diagrammatical view of the preferred primary analysis interface screen illustrating selection of a timeframe and analysis of one profitability factor according to a preferred embodiment of the present invention.

FIG. 13 shows a diagrammatical view of the preferred primary analysis interface screen illustrating selection of a timeframe and analysis of multiple profitability factors according to a preferred embodiment of the present invention.

FIG. 14 shows a diagrammatical view of the preferred user interface presenting a composite overview screen of company financial performance according to an alternate preferred embodiment of the present invention.

FIG. 15 shows a diagrammatical view of the preferred user interface screen presenting an example of company profitability analysis according to an alternate preferred embodiment of the present invention.

FIG. 16 shows a diagrammatical view of the preferred user interface screen presenting an example of company liquidity analysis according to an alternate preferred embodiment of the present invention.

FIG. 17 shows a diagrammatical view of the preferred user interface screen presenting an example of company leverage analysis according to an alternate preferred embodiment of the present invention.

FIG. 18 shows a diagrammatical view of the preferred user interface screen presenting an example of company activity analysis according to an alternate preferred embodiment of the present invention.

FIG. 19 shows a diagrammatical view of the preferred user interface screen presenting an example of a detail report of company income by period according to an alternate preferred embodiment of the present invention.

FIG. 20 shows a diagrammatical view of the preferred user interface screen presenting an example of a detail balance sheet report for a company income by period according to an alternate preferred embodiment of the present invention.

FIG. 21 shows a diagrammatical view of the preferred user interface screen presenting an example of a sensitivity analysis using the Statement of Cash Flows report for a company by period according to an alternate preferred embodiment of the present invention.

FIG. 22 shows a diagrammatical view of the preferred user interface screen presenting an example of a profitability analysis with related annotations of company income by period according to an alternate preferred embodiment of the present invention.

FIG. 23 shows a diagrammatical view of the preferred user interface screen presenting an example of a profitability analysis using multiple analysis measures with related annotations of company income by period according to an alternate preferred embodiment of the present invention.

FIG. 24 shows an overall summary diagrammatical view of the preferred licensing and business relationship of a licensor, licensee and an end user, according to an alternate preferred embodiment of the present invention.

FIG. 25 shows a diagrammatical view of another alternate preferred user interface presenting a composite overview screen of company financial performance according to another alternate preferred embodiment of the present invention.

FIG. 26 shows a diagrammatical view of the another alternate preferred user interface presenting a company profitability analysis according to another alternate preferred embodiment of the present invention.

FIG. 27 shows a diagrammatical view of another alternate preferred user interface screen presenting an example of company liquidity analysis according to another alternate preferred embodiment of the present invention.

FIG. 28 shows a diagrammatical view of another alternate preferred user interface screen presenting an example of company leverage analysis according to another alternate preferred embodiment of the present invention.

FIG. 29 shows a diagrammatical view of another alternate preferred user interface screen presenting an example of company activity analysis according to another alternate preferred embodiment of the present invention.

FIG. 30 shows a diagrammatical view of another alternate preferred user interface screen presenting an example of a detail report of company income by period according to another alternate preferred embodiment of the present invention.

FIG. 31 shows a diagrammatical view of another alternate preferred user interface screen presenting an example of a detail balance sheet report for a company income by period according to another alternate preferred embodiment of the present invention.

FIG. 32 shows a diagrammatical view of another alternate preferred user interface screen presenting an example of a sensitivity analysis using the Statement of Cash Flows report for a company by period according to another alternate preferred embodiment of the present invention.

FIG. 33 shows a diagrammatical view of another alternate preferred user interface screen presenting an example of a profitability analysis with related annotations of company income by period according to another alternate preferred embodiment of the present invention.

FIG. 34 shows a diagrammatical view of another alternate preferred user interface screen presenting an example of a profitability analysis using multiple analysis measures with related annotations of company income by period according to another alternate preferred embodiment of the present invention.

FIG. 35 shows a diagrammatical view of another alternate preferred user interface screen presenting an example of a graphical analysis tool related to a selected line item from the Income statement according to another alternate preferred embodiment of the present invention.

FIG. 36 shows a diagrammatical view of another alternate preferred user interface screen presenting an example of the time period selection tool used for selecting the time periods of reports according to another alternate preferred embodiment of the present invention.

FIG. 37 shows a diagrammatical view of another alternate preferred user interface screen presenting an example of a graphical analysis for a selected report line item according to another alternate preferred embodiment of the present invention.

FIG. 38 shows a diagrammatical view of another alternate preferred user interface screen presenting an example of a composite sensitivity analysis tool in use with the composite overview screen of company financial performance according to a preferred embodiment of the present invention.

FIG. 39 shows a diagrammatical view of another alternate preferred user interface screen presenting an example of a financial projection for a company according to a preferred embodiment of the present invention.

### DETAILED DESCRIPTION OF THE BEST MODES AND PREFERRED EMBODIMENTS OF THE INVENTION

The systems and methods of the present invention allow the end user to prepare a sophisticated financial analysis by creating an effective bridge between financial analysis and the underlying financial information. These systems and methods preferably use interfaces in some ways similar to digital video editors to permit analysis of financial data in a similar manner as editing and compositing film or video materials. They preferably present the financial data and related non-financial data in a visual analog format for discussion and analysis by one or more users. The income statement, balance sheet and statement of cash flows are preferably analyzed as a whole rather than separately as individualized statements. The system and method according to this invention further preferably provides for direct interfaces with all underlying financial and related data. The analysis steps created by a user may (when desired) be captured and recorded for later play back, communication and analysis. A recorded analysis may preferably be modifiable, preferably allowing analysis, input and comment by other individuals to form a comparative analysis that is an analytical sum of all contributors.

With the intention of enabling the present invention to be more readily understood by those skilled in the art, while at the same time disclosing the advantages that are afforded by the present invention, the following description is subdivided to provide an overview of the primary components giving rise to a preferred embodiment of the present invention. Within each subsection of this description, reference is made by title to other system components when and as necessary to assist in understanding system inter-relationships.

Following the description of each sub-component and an identification of the pathways of communication between components, a description of the interaction of the components in functional application as taught by the present invention is provided.

A fundamental principle as taught by the present invention rests upon the premise that analysis of the financial performance of companies can be understood by users who do not have accounting or finance backgrounds. Additionally, users can benefit from access to tools and methods which preferably use a familiar interface method to facilitate communication and sharing.

In the accompanying drawings, well-known structures and devices are shown in block diagram form in order to provide an understanding of the interrelationship between components and the flow of information and control throughout the described preferred embodiment of the present invention. It will be apparent to one skilled in the art that the invention may, under appropriate circumstances, be practiced with a variety of different specific components (without detraction or departure from the scope of the present invention) provided to serve the generalized block diagram description. Further, for the purposes of the following discussion, it is to be understood that a transactional operation upon the database is one in which data is added, modified or deleted from the database. Specific statements made with respect to any of these operations are intended to clarify the nature of the operation being performed but should not be taken as a limitation of the operation should an alternative transactional operation be desired in a substantially similar situation or setting.

It is also to be understood that the objects comprising the preferred embodiment may be coded in a language of preference to the developer without departure from the spirit or teachings of present invention. More specifically, encoding in a particular specific language, such as C, Java, C++, C-Prime, or other language, is not to be seen as restrictive to the scope of the present invention.

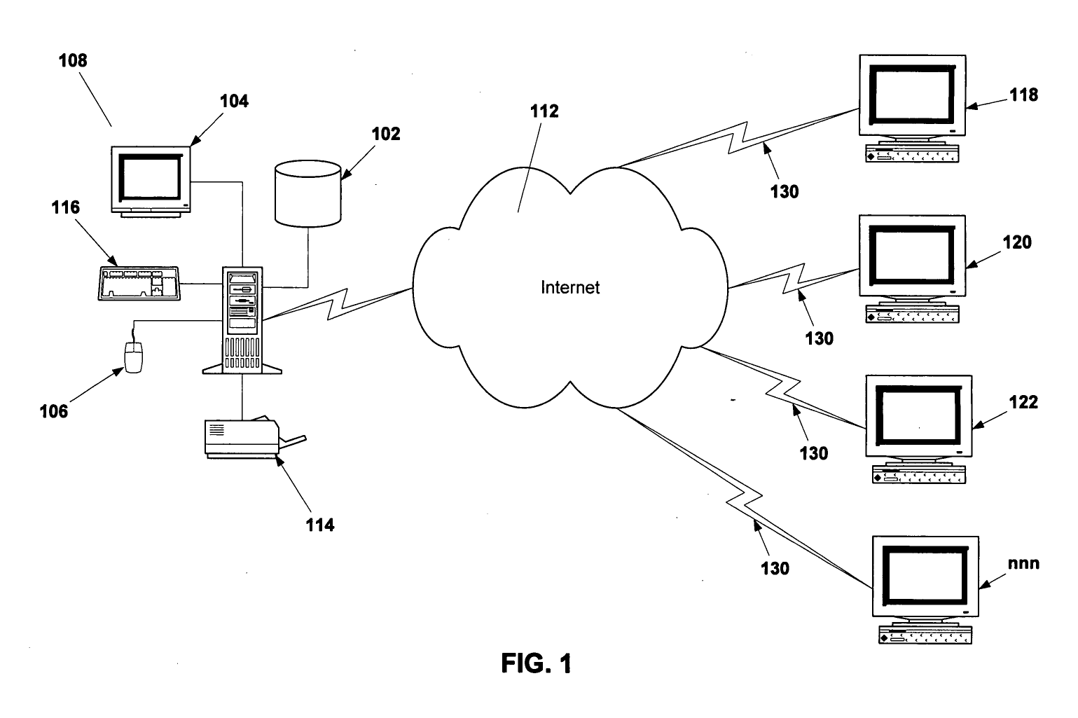

Referring now to FIG. 1, a diagrammatical overview of the Internet communications used in the instant system according to a preferred embodiment of the present invention is shown. The present invention preferably comprises a computer system server 108. The computer system server 108 comprises input and output devices of the sort well known in the art. For example, the computer system server 108 preferably comprises a display screen or monitor 104, a keyboard 116, a printer 114, a mouse 106, etc. The computer system server 108 further preferably comprises a database 102 for storage of the data and software comprising preferred embodiments of the present invention. The computer system server 108 is preferably connected to the Internet 112 that serves as the presently preferred communications medium using http 130 (hypertext transport protocol) as preferred protocol for the exchange of information (such as HTML documents and client requests for such documents) between a Web browser and a Web server. The Internet 112, as previously discussed, comprises a global network of networks and computers, public and private. The Internet 112, which utilizes TCP/IP (Transmission Control Protocol/Internet Protocol) to manage the connections between devices, is the preferable connection method by the users 118, 120, 122 and nnn in preferred embodiments of the present invention.

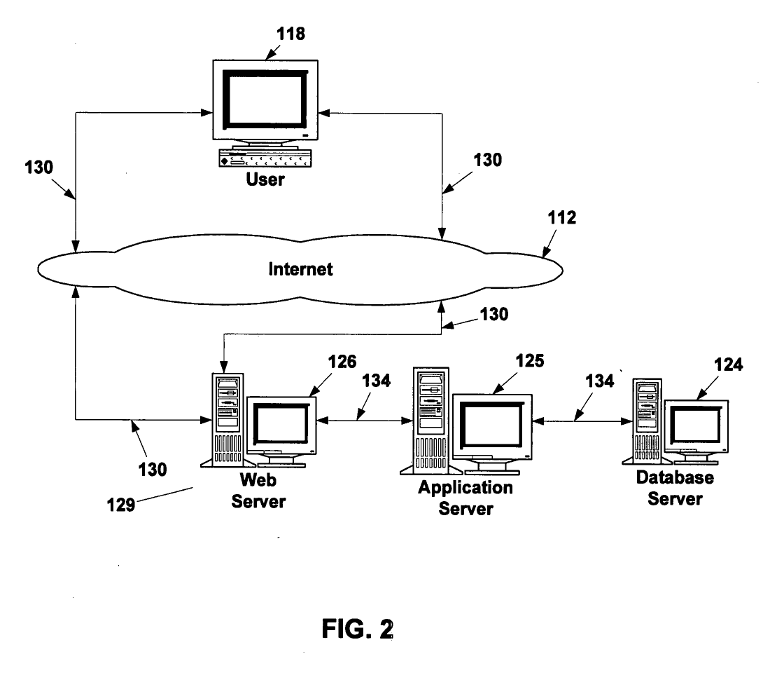

Referring to FIG. 2, a simplified functional diagrammatical overview of the relationship among the web site servers and users of the instant system according to a preferred embodiment of the present invention is shown. This figure shows the preferred relationships between a user 118 (exemplary of any number of users 118, 120, 122, nnn), the Internet 112, the web server 126, the application server 125 and the database server 124. Upon reading the teachings of this specification, those with ordinary skill in the art will now understand that, under appropriate circumstances, considering such issues user requirements and changes in technology, the web server 126, the application server 125 and the database server 124 may be combined into a single machine combined web server 129. As shown, a user 118 may request a page from the web site of the present invention operating on the combined web server 129. The user 118 is preferably connected via the Internet 112, and the web page request preferably initiates a call to the present invention using http 130. The present invention then preferably makes at least one request to the database server 124 and preferably generates an HTML page for transmission to the user 118 following the database server's completion of the present invention's request and transmission of the requested data back to the web server 126. The web server 126 preferably transmits the completed HTML frame page containing the data requested by the user 118 through the Internet 112 to the user 118. Upon reading the teachings of this specification, those with ordinary skill in the art will now understand that, under appropriate circumstances, considering such issues as user requirements and changes in technology, the above described database server 124, the web server 126 and the application server 125 may be combined and the above described interactions may be accomplished within the combined web server 129. Upon reading the teachings of this specification, those with ordinary skill in the art will now understand that, under appropriate circumstances, considering such issues as user requirements and changes in technology, the web server 126, the application server 125 and the database server 124 may communicate via an Ethernet-based local area network 134 or similar means.

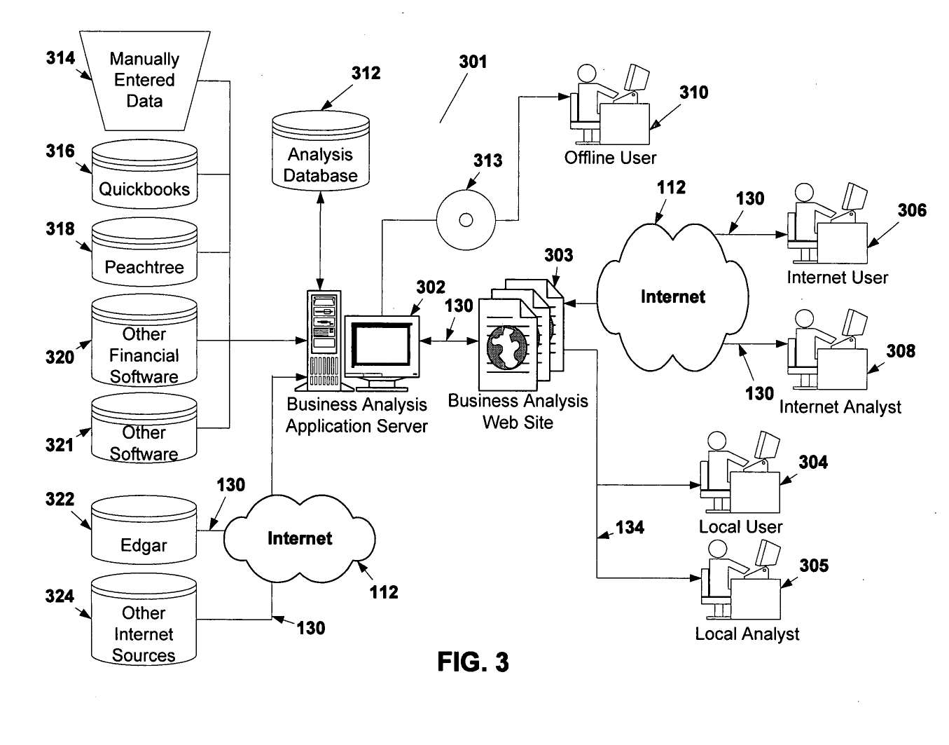

Referring now to FIG. 3, a diagrammatical overview of the preferred primary communication paths, communication components and information flows of the instant system according to a preferred embodiment of the present invention is presented. As shown, the business analysis system 301 encompasses a variety of modules and components. Each of these components and their relationships to other components will be described in summary and then in more detail.

The business analysis system 301 is preferably comprised of: 1) the business analysis application server 302 on which the instant software preferably resides; 2) the analysis database 312 which preferably serves as the central repository for the all imported financial data for individual companies, user preferences, standard financial ratios, analysis presentation preparation session information, completed analysis presentations and other system control information; and 3) the business analysis web site 303 which preferably serves as the primary access point for users.

As shown, preferably the business analysis system 301 is capable of interfacing with users and analysts in several ways. First, it is preferably possible for offline user 310 to utilize the capabilities of business analysis system 301 from a media such as a CD 313 which can be used independently of the business analysis system 301. Second, preferably an Internet user 306 or an Internet analyst 308 may access the business analysis system 301 via the Internet 112 and the business analysis web site 303 (at least herein embodying permitting such at least one sequential presentation to reside on at least one Internet website; and at least herein embodying preparing at least one such sequential presentation viewable independently from such computer program). Finally, a local user 304 or a local analyst 305 may preferably access the business analysis system 301 via a typical Ethernet-based local area network 134 connection. Regardless of access method, preferably all users use a browser-based interface.

As used herein, a local user 304, an Internet user 306 and an offline user 310 are considered to be consumers of an analysis presentation which has been prepared by a local analyst 305 or an Internet analyst 308. Preferably, a local user 304, an Internet user 306 and an offline user 310 are considered consumers of an analysis presentation because they may only view it and any underlying data associated with the analysis presentation. Preferably, they may not add or change an analysis presentation. Preferably, a local analyst 305 or an Internet analyst 308 may create an analysis presentation, modify an existing modifiable analysis presentation and view any analysis presentation for which they have authorization.

Preferably, the analysis database 312 is the repository for all imported financial data for individual companies, user preferences, standard financial ratios, analysis presentation preparation session information, completed analysis presentations and other system control information as may be required.

Preferably, the business analysis system 301 is capable of importing XBRL-based (extensible Business Reporting Language) financial data from a variety of sources. Examples of these sources include any financial accounting system, such as QuickBooks 316, Peachtree 318 or other financial software 320, which is capable of producing XBRL-based export files. Preferably, XBRL-based exports from these sources may be provided to the business analysis system 301 in a variety of ways, including most forms of digital storage media, including CD's, diskettes or other portable storage products. Additionally, the XBRL-based exports may preferably be transferred over a LAN or WAN (such as the Internet) if both the accounting software and the business analysis system 301 are connected appropriately.

Additionally, other non-financial data may be imported Other Software 321 for use either independently or in conjunction with financial data.

Additionally, for publicly traded companies, the Securities and Exchange Commission's reporting system EDGAR 322 can produce XBRL-based files. Additionally, any other Internet sources 324 which produce XBRL-based files are preferably acceptable as well. Preferably, XBRL-based exports from these sources may be provided to the business analysis system 301 via file transport protocol (FTP) over the Internet 112 or another comparable method of transferring data between to points on the Internet. Upon reading the teachings of this specification, those with ordinary skill in the art will now understand that, under appropriate circumstances, considering such issues such user requirements and to accommodate requirements for real-time access to the underlying financial data, direct programmatic access to the target financial accounting system may be used. Additionally, upon reading the teachings of this specification, those with ordinary skill in the art will now understand that, under appropriate circumstances, considering such issues as the need to accommodate exports of financial data in formats other than XBRL, other essentially-import methods such as custom import programs may be used. Preferably, the import processes may be scheduled to be performed automatically or on request on any appropriate frequency. Additionally, preferably the import processes and the analysis database 312 are structured to permit the import and storage of financial data from as many companies as desired (at least herein embodying at least one computer processor adapted to accepting at least one first set of data records having time-relevant values relating to at least one first entity; and at least herein embodying at least one computer processor adapted to accepting at least one second set of data records having time-relevant values relating to at least one second entity).

Upon reading the teachings of this specification, those with ordinary skill in the art will now understand that, under appropriate circumstances, considering such issues as licensor preferences, the nature of the desired analysis and changes in requirements, etc., non-financial data may be imported and subjected to the analysis tools and methods described herein.

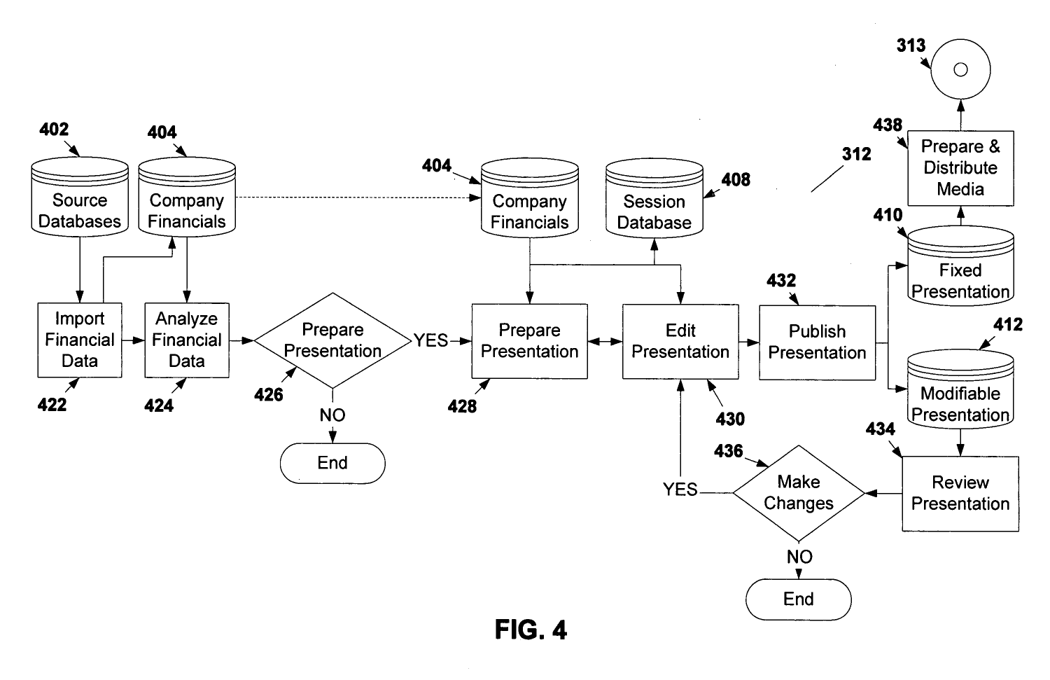

Referring now to FIG. 4, a diagrammatical view of the preferred process for preparing a financial analysis presentation according to a preferred embodiment of the present invention is shown. As depicted in the step import financial data 422, preferably the first step in the preparation of a financial analysis presentation is to obtain the required financial information from the selected source database 402 from a computer-based or manual accounting system (e.g., manually entered financial data 314, QuickBooks 316, Peachtree 318, other Financial Software 320, EDGAR 322 or other Internet sources 324 as shown in FIG. 3) and add it to the company financials 404 segment of the analysis database 312. Once the required information has been stored, preferably an authorized user may complete an analysis of the data in a variety of ways in step analyze financial data 424. The specific analysis tools preferably available to a user to complete the step analyze financial data 424 are provided below. In the next step, prepare presentation 426, preferably the user may choose to complete the analysis without saving any of the work or go forward and prepare an analysis presentation. Preferably, if the user chooses to prepare an analysis presentation, he or she will complete the step prepare presentation 428. In the step prepare presentation 428, preferably the software will create entries in the session database 408 which identify the details of the analysis actions performed by the user. Preferably, the content of the session database is organized by financial analysis segments within a presentation.

A financial analysis segment is preferably started each time the user sets the software to record mode and preferably ends when the user sets the record mode off. Within a financial analysis segment, the user's navigation selections and annotations are preferably captured (at least herein embodying at least one computer processor adapted to assisting recording at least one computer program selection made by such at least one first analyzer). Annotations may include insertion of audio and video files as attachments, insertion of links to web sites and documents, and comments (at least herein embodying wherein such at least one annotation comprises digitized text; and at least herein embodying wherein such at least one annotation comprises digitized audio; and at least herein embodying wherein at least one annotation comprises digitized video; and at least herein embodying wherein such at least one annotation comprises at least one digitized image). Preferably, each annotation may be associated with a date, with an analysis category, a performance measure, or a specific value in a company's financial records (at least herein embodying wherein such at least one annotation may be associated with at least one date; and at least herein embodying wherein such at least one annotation may be associated with at least one selected analysis category; and at least herein embodying wherein such at least one annotation may be associated with at least one selected such performance measure; and at least herein embodying wherein such at least one annotation may be associated with at least one selected datum of such at least one first set of data records having time-relevant values).

Preferably, each annotation is cataloged along with the financial information associated with it within a segment within an analysis presentation in the session database 408. In short, the session database 408 preferably permits an analysis presentation to be created, stored, edited and published without modifying the underlying information contained in the company financials 404. The session database will preferably also retain information regarding the user's decisions about modifiability of the final analysis presentation and users with access permission. Preferably, the session database retains the status of the analysis presentation which permits the user to return to the analysis presentation at different times. At any time the user may edit an existing or incomplete analysis presentation as depicted by the step edit presentation 430. Preferably, when a user is editing an existing presentation, he or she may create additional financial analysis segments, make additional annotations by inserting other attachments, insert additional web site links, change the sequence of the financial analysis segments, and delete selected financial analysis segments (at least herein embodying providing as part of such computer application at least one second software tool, as part of such computer application, adapted to permit such at least one first analyzer to sequentially organize such at least one set of analyses; and at least herein embodying at least one computer processor adapted to assisting computer-manipulating of such at least one set of data records having time relevant values by such at least one first analyzer to assist providing such at least one sequential presentation of at least one set of analyses; and at least herein embodying at least one computer interface adapted to permitting use of such computer program by such at least one first analyzer to sequentially organize such at least one set of analyses; and at least herein embodying providing at least one third software tool, as part of such computer application, adapted to permit editing of such at least one sequentially-appropriate annotation by such at least one first analyzer; and at least herein embodying at least one computer interface adapted to permitting use of such computer program by such at least one first analyzer to add at least one sequentially-appropriate annotation to such at least one analysis; and at least herein embodying at least one computer interface adapted to assisting editing of such at least one such sequential presentation from such at least one set of analyses by such at least one first analyzer; and at least herein embodying at least one computer interface adapted to permitting use of such computer program by such at least one first analyzer to create at least one such sequential presentation from such at least one set of analyses; and at least herein embodying providing at least one fourth software tool, as part of such computer application, adapted to editing such at least one analysis by such at least one first analyzer; and at least herein embodying providing at least one fifth software tool, as part of such computer application, adapted to re-sequence such at least one analysis by such at least one first analyzer; at least herein embodying providing at least one fifth software tool, as part of such computer application, adapted to re-sequence such at least one analysis by such at least one first analyzer; and at least herein embodying providing at least one fourth software tool, as part of such computer application, adapted to editing such at least one analysis by such at least one first analyzer; and at least herein embodying wherein such at least one sequential presentation may comprise at least one customized-sequence annotated sequential presentation from such at least one set of analyses; and at least herein embodying comprises at least one computer interface adapted to permitting re-sequencing such at least two of such at least one set of analyses by such at least one first analyzer).

Preferably the analysis presentation edit tools used in step edit presentation step 430 operate in a manner similar to the digital video editing tools which are generally available today (at least herein embodying manipulating of such at least one set of financial records by such at least one first analyzer to assist providing at least one sequential presentation of at least one set of analyses; and at least herein embodying providing at least one computer application adapted to assist computer-manipulating of such at least one set of data records by such at least one first analyzer to assist providing at least one sequential presentation of at least one set of analyses).

Referring again to FIG. 4, once a user has completed preparation of an analysis presentation, it may be published in the final step publish presentation 432. As shown in FIG. 4, the analysis presentation may preferably be published as a modifiable presentation 412 or a non-modifiable presentation 410. In summary, a non-modifiable presentation 410 preferably permits a user to view the recorded segments, annotations and underlying financial reports, but the user may not change the content or sequence of the analysis presentation; nor can the user view the financial transaction detail. Non-modifiable presentations are preferably suited for distribution on a removable storage media such as compact disk (CD) or digital video disk (DVD). For modifiable presentations 412, preferably a user may be granted permission to only view the analysis presentation, make changes in the segments, such as inserting additional attachments at the financial reporting level, or make changes in the segments, such as inserting additional attachments at the financial transaction detail level. Preferably, access and edit permissions are granted on a user-by-user basis (at least herein embodying at least one computer processor adapted to permitting granting permission to alter such at least one sequential presentation to at least one second analyzer; and at least herein embodying at least one computer processor adapted to permitting granting permission to view such at least one sequential presentation to at least one third analyzer). Both non-modifiable presentations and modifiable presentations, after being published, are preferably available to authorized users through the business analysis web site 303. Preferably, all underlying financial information, annotations, attachments and links are included with the non-modifiable presentation 410 when it is published to a removable storage media.

An authorized user may preferably access a modifiable presentation 412 to review it in task review presentation 434. If the user concludes that additional segments, or additional annotations or attachments, are required within a segment, the user can preferably make the desired adjustments in step edit presentation 430. Depending on the level of authorization, a user may either access only the financial reporting data or both the financial reporting data and the transaction detail, if present.

As shown in FIG. 4, once an analysis presentation is published as a fixed presentation 410, it may then preferably be copied to any selected removable storage media such as CD 313 in the step Prepare and Distribute Media 438. Preferably, at the discretion of the user, a fixed presentation 410 may require a password for access whether is accessible from the web site or from the removable storage media, such as CD 313. As shown in FIG. 4, the analysis database 312 is preferably primarily comprised of company financials 404, a session database 408, each fixed presentation 410 and each modifiable presentation 412. Preferably, the analysis database 312 may also include system and user management tables.

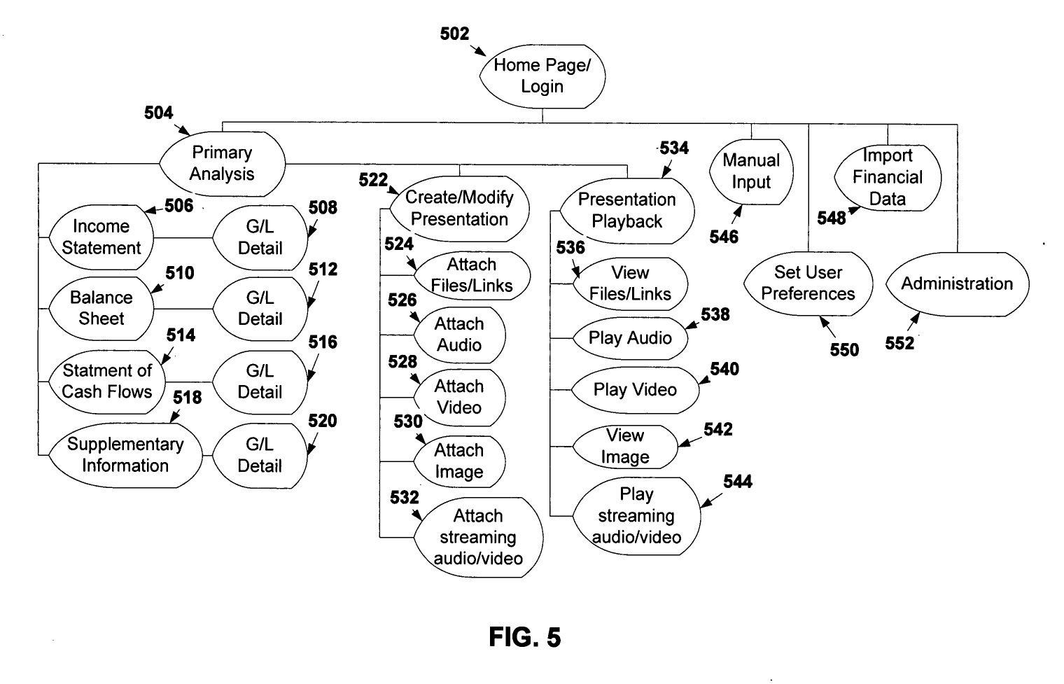

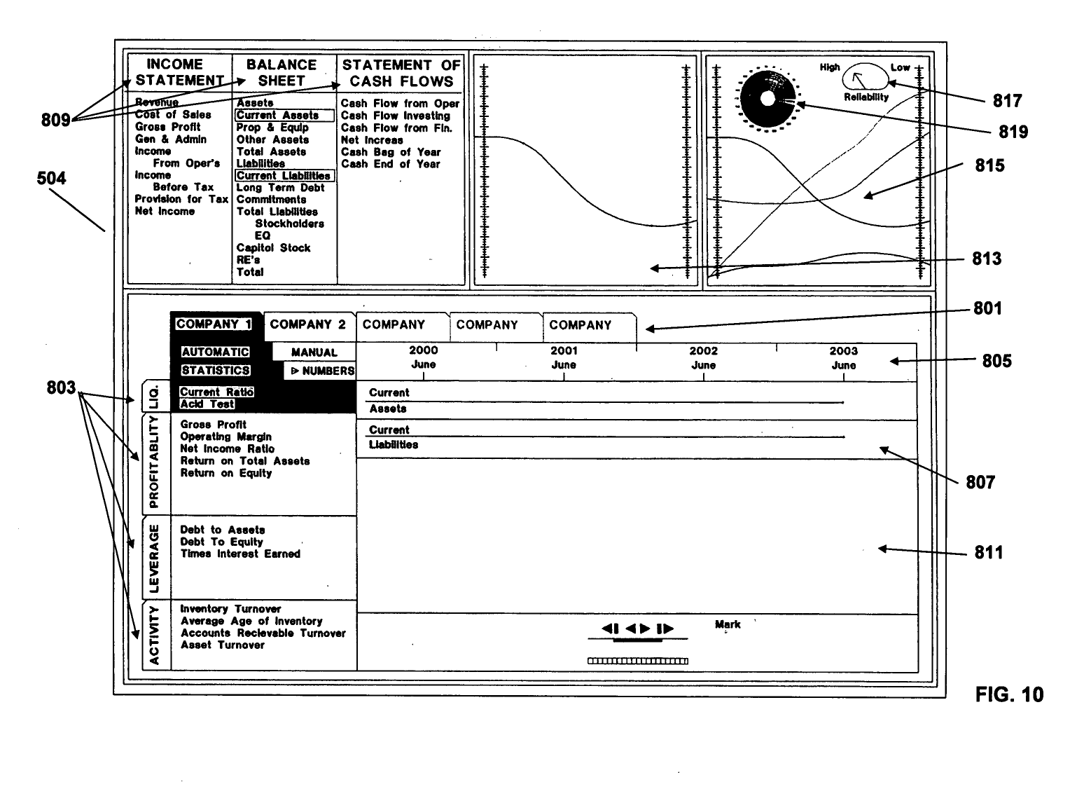

Referring now to FIG. 5, a diagrammatical view of the preferred relationship of the primary user interface screens according to a preferred embodiment of the present invention is shown. Preferably, each user must be authorized to access the instant system. Preferably, the owner or system administrator of the instant system will identify authorized users, their associated passwords, and their level of authorization. The levels of user authorizations preferably fall into three broad categories: 1) view only with no permission to create or modify an analysis presentation, 2) view the financial reports only with permission to create or modify an analysis presentation, and 3) view all financial transaction detail with permission to create or modify an analysis presentation. Additionally, users may be preferably further classified by skill level at least as novice or expert. Preferably, other skill classifications may be defined. Preferably, users classified as novice generally would not be allowed to add or modify analysis calculation formulas, whereas experts would be granted the option of adding or modifying analysis calculation formulas. Preferably, all users will be presented with the Home Page/Login 502 which will accept the required user ID and password. After successfully logging in, most non-administrative users will preferably be presented with the option to view the primary analysis screen 504 (as shown in FIG. 10) or then to set user preferences 550. The function set user preferences 550 will allow users to customize the presentation and operation of the system to suit their own needs. Preferably, one operational preference will include the ability for an authorized user to input custom ratio calculation formulas. Administrative users will be provided additional options, which include manual input 546, import financial data 548 and administration 552. Preferably, the function include manual input 546 permits authorized users to input financial information into the database manually, if it is not available in some digital format. Preferably, the function import financial data 548 permits authorized users to import financial data from any supported electronic source, as described in FIG. 3. Preferably, the function import financial data 548 permits an authorized user to set and modify overall system processing parameters such as user authorizations, update frequency for on-line financial data and any default values.

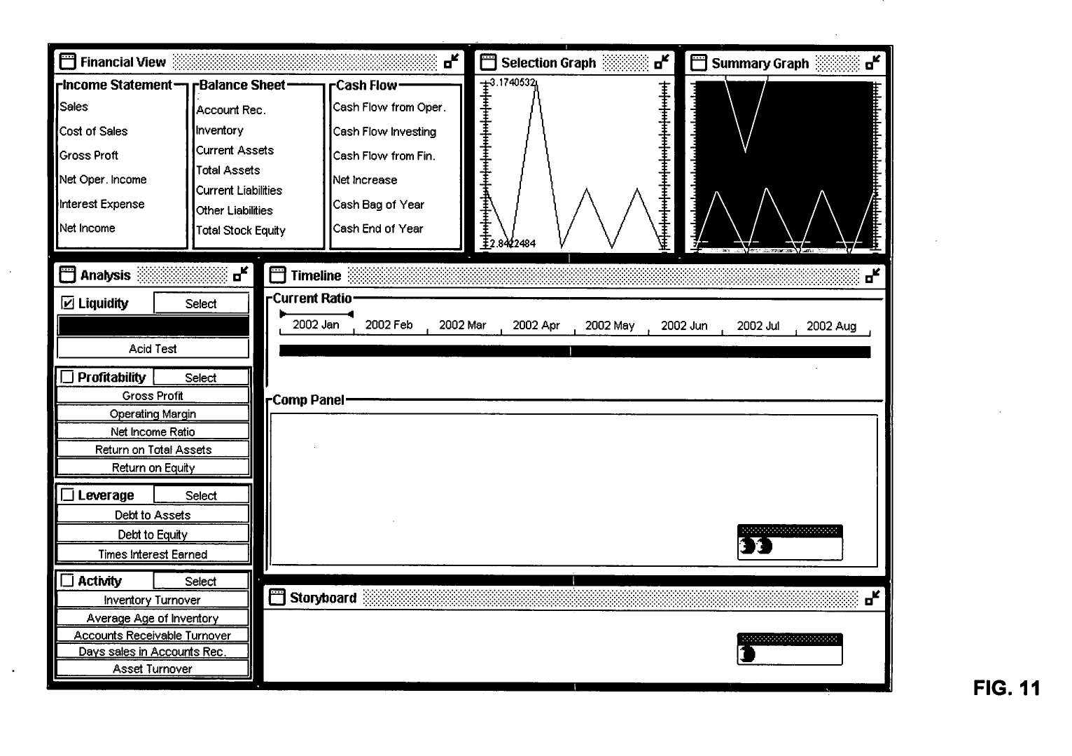

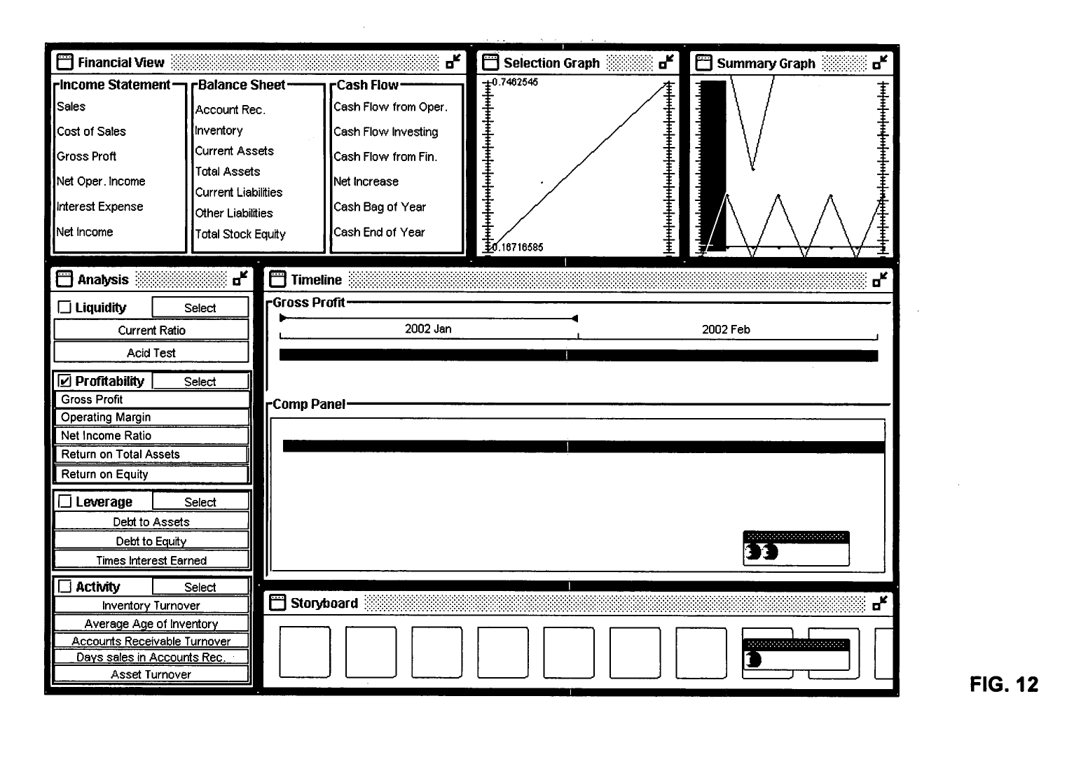

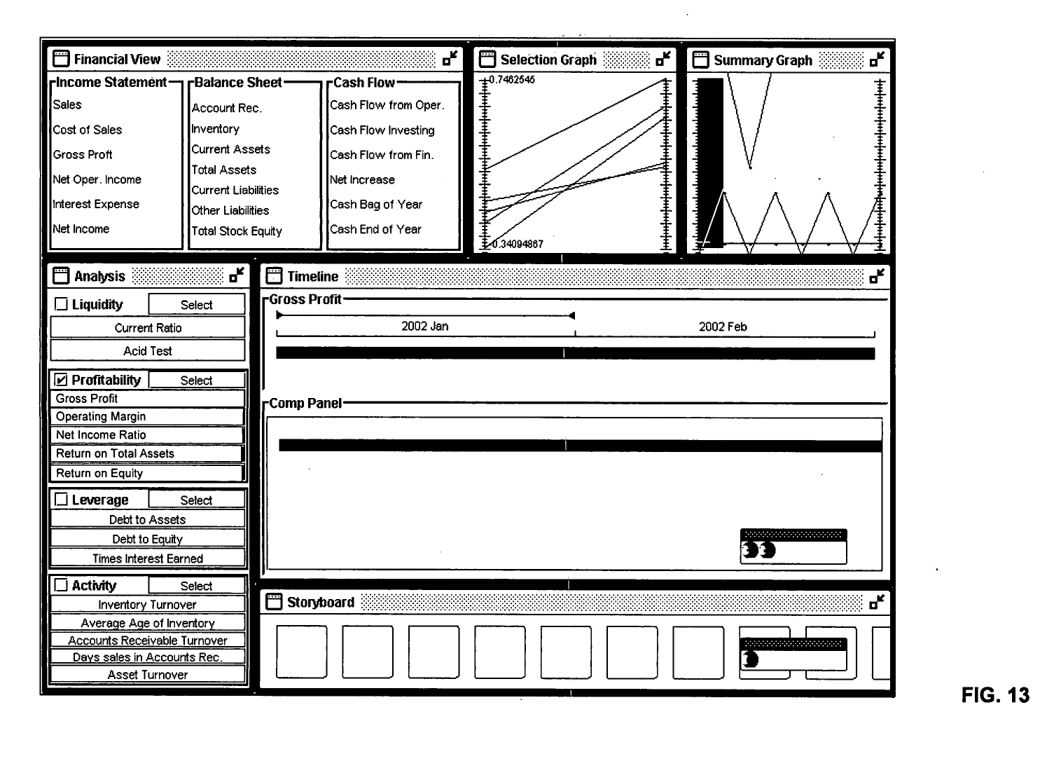

Referring again to FIG. 5, preferably a user may perform a variety of analyses using the function primary analysis screen 504, which is further described in conjunction with FIG. 10, FIG. 11, FIG. 12 and FIG. 13. Additionally, authorized users may choose to view the financial reports, e.g., Income Statement 506 and its attendant detail G/L Detail 508, Balance Sheet 510 and its attendant detail G/L Detail 512, Statement of Cash Flows 514 and its attendant detail G/L Detail 516 or Supplementary Information 518 and its attendant detail G/L Detail 520.

Further, preferably from the primary analysis screen 504, an authorized user may create a new analysis presentation or modify an existing analysis presentation in function create/modify presentation 522. Preferably, authorized users may identify financial analysis segments by recording navigation among the various analysis tools provided by primary analysis screen 504 related financial report information, e.g., Income Statement 506 and its attendant detail G/L Detail 508, Balance Sheet 510 and its attendant detail G/L Detail 512, Statement of Cash Flows 514 and its attendant detail G/L Detail 516 or Supplementary Information 518 and its attendant detail G/L Detail 520. Each financial analysis segment preferably begins when recording is started and ends when the recording is stopped. Preferably, authorized users may create as many financial analysis segments as desired within a particular analysis presentation. During the creation of a financial analysis segment, authorized users may preferably optionally annotate any point in the financial analysis segment by accessing the function attach files/links 524, attach audio 526, attach video 528, attach image 530 and/or attach streaming audio/video 532. The function attach files/links 524 preferably permits an authorized user to create and identify a text note, an existing file such as a word processing document, spreadsheet, or other permissible format, and associate/attach with a selected point within a financial analysis segment.

The function attach files/links 524 also preferably permits an authorized user to identify a web site URL and associate with a selected point within a financial analysis segment. The function attach audio 526 preferably permits an authorized user to create and identify an audio recording or an existing recording and associate/attach with a selected point within a financial analysis segment. The function attach video 528 preferably permits an authorized user to identify an existing video recording and associate with a selected point within a financial analysis segment. The function attach image 530 preferably permits an authorized user to identify an existing image and associate with a selected point within a financial analysis segment. The function attach streaming audio/video 532 preferably permits an authorized user to create an existing streaming audio or video recording and associate with a selected point within a financial analysis segment (at least herein embodying providing, as part of such computer application, at least one first software tool adapted to permit such at least one first analyzer to add at least one sequentially-appropriate annotation to such at least one analysis).

Referring again to FIG. 5, an authorized user may preferably select an existing analysis presentation and preferably view it by selecting the function presentation playback 534. The presentation playback function preferably permits the authorized user to view the various financial analysis segments and related annotations in a manner similar to playing a video on a typical computer-based video player. The user may preferably use pause, rewind, fast forward, restart, or other similar functions, to view an existing analysis presentation. Each attachment, regardless of type, is preferably identified on the display and is available for selection by the user. Selection of any annotation point will preferably automatically take the user to the appropriate display depending on the type of attachment.

An authorized user may preferably use the function view files/links 536 to view any files or links associated with an annotation in any analysis segment. An authorized user may preferably use the function play audio 538 to listen to any audio files associated with an annotation in any analysis segment. An authorized user may preferably use the function play video 540 to view any video files associated with an annotation in any analysis segment. An authorized user may preferably use the function view image 542 to view any image files associated with an annotation in any analysis segment. An authorized user may preferably use the function play streaming audio/video 544 to listen to any streaming audio files or view any streaming video files associated with an annotation in any analysis segment.

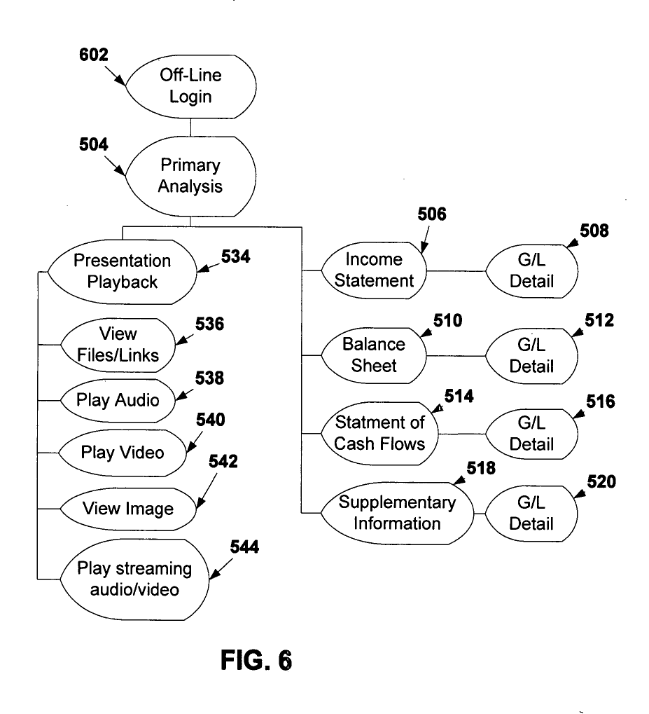

Referring now to FIG. 6, a diagrammatical view of the preferred relationship of the primary user interface screens used in off-line playback of a presentation according to a preferred embodiment of the present invention. Preferably, an analysis presentation may be distributed via any appropriate form of removable storage media, such as compact disk (CD), diskette, digital video disk (DVD), etc., to permit users to view an analysis presentation in situations where the Internet may not be available. A user may access an offline analysis presentation and view it by selecting the function presentation playback 534 preferably after providing the appropriate user ID and password in the function Off-line Login 602.

Upon reading the teachings of this specification, those with ordinary skill in the art will now understand that, under appropriate circumstances, considering such issues as accommodation of user access without limitations, no user ID and password may be used. The presentation playback function preferably permits the authorized user to view the various financial analysis segments and related annotations in a manner similar to playing a video on a typical computer-based video player. The user may preferably use pause, rewind, fast forward, restart or other similar functions to view an existing analysis presentation. Each attachment regardless of type is preferably identified on the display and is available for selection by the user. Selection of any annotation point will preferably automatically take the user to the appropriate display depending on the type of attachment. An authorized user may preferably use the function view files/links 536 to view any files or links associated with an annotation in any analysis segment if there is an active connection to the Internet. An authorized user may preferably use the function play audio 538 to listen to any audio files associated with an annotation in any analysis segment. An authorized user may preferably use the function play video 540 to view any video files associated with an annotation in any analysis segment. An authorized user preferably may use the function view image 542 to view to any image files associated with an annotation in any analysis segment. An authorized user may preferably use the function play streaming audio/video 544 to listen to any streaming audio files or view any streaming video files associated with an annotation in any analysis segment.

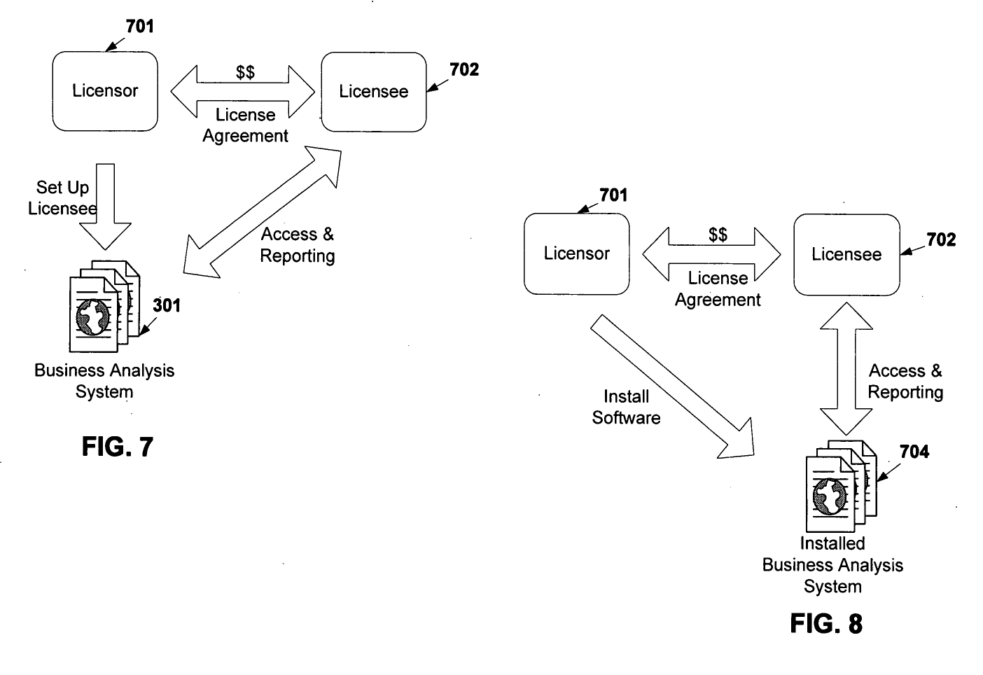

Referring now to FIG. 7, a diagrammatical view of the preferred licensing and business relationship of a licensor and licensee when the licensor provides the instant system as a service to the licensor is shown. Preferably, a licensing relationship will be established which permits a licensee 702 usage of the instant system via a telecommunications connection such as the Internet in return for an agreed fee. Preferably, the fee will be based on a set period of time and usage by the licensee 702 of the instant system. Preferably, licensor 701 will, for an agreed fee, permit licensee 702 to utilize the instant system for the purposes of the licensee 702 without regard to other licensees. Preferably, the instant system is structured to permit usage by multiple licensees, where each licensee 702 is provided its own analysis database specifically identified and available for its exclusive use. Under this structure, upon completion of a license agreement, licensor 701 preferably establishes an exclusive environment for the licensee 702 on the business analysis system 301 and provides the licensee 702 the necessary access authorizations to set up one or more desired analysis databases associated only with the particular licensee 702.

Referring now to FIG. 8, a diagrammatical view of the preferred licensing and business relationship of a licensor and licensee when the licensor provides the instant system for installation on the computing systems of the licensee is shown. Preferably, a licensing relationship will be established which permits a licensee 702 to install the instant system on the computer hardware of the licensee 702. Preferably, the fee will be based on a set period of time and the usage of the instant system by the licensee 702, or some analog of usage such as the number of authorized users. Preferably, the instant system is structured to permit installation in various, but compatible, computer hardware and network environments. Under this structure, upon completion of a license agreement, licensor 701 assists licensee 702 with the installation and initial set up of the operating environment for the licensee 702 for the installed business analysis system 704 and provides the licensee 702 the necessary access training to set up one or more desired analysis databases.

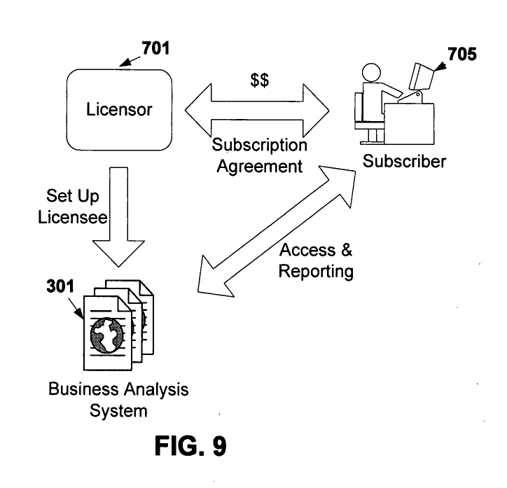

Referring now to FIG. 9, a diagrammatical view of the preferred licensing and business relationship of a licensor and licensee when the licensee is an individual is shown. Preferably, a licensing relationship will be established which permits a subscriber 705 access to prepared analysis presentations by accessing the business analysis system 301 usage of the instant system via a telecommunications connection such as the Internet in return for an agreed fee. Preferably, the fee will be based on a set period of time and the usage by the subscriber 705 of the instant system. Preferably, the instant system is structured to permit usage by multiple subscribers 705, where each subscriber 705 is provided access to pre-selected analysis reports. Under this structure, upon completion of a license agreement, licensor 701 preferably establishes a login ID and password for the subscriber 705 on the business analysis system 301 and provides the subscriber 705 the necessary access authorizations.

Referring now to FIG. 10, a diagrammatical view of the preferred primary analysis screen in mockup form according to a preferred embodiment of the present invention is shown. The preferred primary analysis screen 504 is preferably structured into eight key areas which a user may preferably access in any sequence. Although no strict sequence of usage is imposed by the preferred primary analysis screen 504, each of the areas will be described in a sequence which permits the best understanding of the functions of each area and its relationship to the other areas. Additionally, preferably all of the areas described below are interrelated to permit a user to analyze complex sets of financial information in the most effective manner possible from a single source screen.

Upon initial presentation of the primary analysis screen 504, a user will first select the company or companies to be analyzed by selecting the named tabs in the company area 801. Preferably, selecting a company tab will open the analysis database and make the selected company's financial data available for analysis. Preferably, a user may select as many or as few companies as desired. Additionally, a user may preferably choose to perform comparative analysis on multiple companies or to switch between companies as desired.

Once a company or companies have been chosen, a user will preferably select one or more specific analysis calculations to be applied to the selected company's financial data from the calculations area 803. The instant system preferably will include analysis calculations as defined by Generally Accepted Accounting Principles (GAAP) as shown in the calculations area 803. Preferably the analysis categories include: 1) liquidity, 2) profitability, 3) leverage, 4) activity and 5) other—which may include other statistical measures and diagnostics. Preferably, additional analysis calculations will be included for performing investment analysis and financial projections including budgeting. Preferably, other analysis calculations will be permitted, including tax basis conversions and comparison and contrast of differing methods of financial reporting. Finally, preferably, users with appropriate authorization will be permitted to create and save custom analysis calculations as well as modify any of the standard analysis calculations (at least herein embodying at least one computer interface adapted to assisting input of at least one user-defined analysis calculation formula by such at least one first analyzer; and at least herein embodying at least one computer processor adapted to performing at least one calculation using such at least one user-defined analysis calculation formula on such at least one first set of data records having time-relevant values to obtain at least one user-defined performance measure relating to such at least one first analysis time period). Preferably, diagnostic calculations, included in the “other” analysis category, automatically compute deviations from expected values or ranges of values thus identifying potential defects within the financial reports of a selected company (at least herein embodying at least one computer processor adapted to providing at least one plurality of preset analysis calculation formulas; and at least herein embodying at least one computer processor adapted to comparing at least one of such at least two second performance measures to at least one quality-standard range of values; and at least herein embodying at least one computer display adapted to displaying such at least one of such at least two second performance measures not within such at least one quality-standard range of values).

Selecting one or more of the analysis calculations displayed in the calculations area 803 will, in the preferred described embodiment, result in the trend lines for the selected analysis calculations being graphically displayed in the current monitor area 813. All trend lines are preferably displayed simultaneously in the current monitor area 813 to present a visual summary to the user. Preferably only analysis calculations within a group may be selected for analysis. Users with appropriate authorization may alternatively select analysis calculations from more than one group (at least herein embodying at least one computer interface adapted to permitting selecting such at least two first performance measures for display by such at least one first analyzer; and at least herein embodying at least one computer interface adapted to assisting selecting, by such at least one first analyzer, of such at least one user-defined performance measure for display; and at least herein embodying at least one computer display adapted to simultaneously displaying at least two of such at least one user-defined performance measures in at least one second graphical visualization relating to such at least one first analysis time period).

Preferably, the instant system will display the time period associated with the financial data of the selected company or companies in the timeline area 805. In other words, the financial data for a selected company may cover, for example, one year—so the time period displayed will be between the beginning and end dates of the year with the data segmented by any sub-periods (months) available within the data.

Preferably, the comparative area 807 provides a working space for selecting items for comparison. The comparative area 807 also preferably permits a user to select one or more sub-periods to permit a more detailed analysis of any analysis calculation (at least herein embodying at least one computer interface adapted to permitting selecting at least one first analysis time period by such at least one first analyzer). Preferably a user may select a sub-period and “drag” it under another sub-period to permit comparison of the selected analysis calculations for two sub-periods. Preferably, there is no limitation on the number of sub-periods with may be compared (at least herein embodying at least one computer interface adapted to permitting selecting at least one second analysis time period by such at least one first analyzer; and at least herein embodying at least one computer processor adapted to assisting comparison of such at least one first performance measure relating to such at least one first analysis time period to such at least one first performance measure relating to such at least one second analysis time period).

The same process may be used to compare selected companies (at least herein embodying at least one computer processor adapted to assisting comparison of such at least one second performance measure relating to such at least one first entity to such at least one second performance measure relating to such at least one second entity). Preferably in each case the trend lines for selected analysis calculations for the selected sub-periods are preferably displayed simultaneously in the current monitor area 813 (at least herein embodying at least one computer display adapted to simultaneously displaying such at least two first performance measures in a single second graphical visualization relating to such at least one first analysis time period).

Preferably, the financial report area 809 provides access to the underlying financial information for each company selected. As shown, each financial area is preferably summarized by the commonly accepted classifications within four primary segments or generally accepted financial reporting: 1) Income Statement, 2) Balance Sheet, 3) Statement of Cash Flow, and 4) Accompanying data (not shown in FIG. 10). These commonly accepted classifications are preferably automatically highlighted when the user selects an analysis calculation in the calculations area 803. Highlighting the classification further permits the user to focus on the details because the user may preferably select any classification, highlighted or not, to view the financial report for the time period or sub-period indicated in the timeline area 805.

Preferably, the user may select an individual line item from the selected financial report to “drill down” further into the details. When available, authorized users may preferably “drill down” to individual transactions underlying a line item on the selected company's financial report. Preferably, selection at each level within the financial report area 809 opens a window displaying the next level of detail of the company's financial information. Each window may be minimized, but preferably will remain open until closed by the user. A user may preferably keep as many windows open as desired (at least herein embodying at least one computer display adapted to permitting display of at least one subset of such at least one first set of data records having time-relevant values relating to such at least one first analysis time period relating to such at least one first entity).

Preferably, the current monitor area 813 provides a simultaneous display of all analysis calculations selected by a user in the calculations area 803 (at least herein embodying at least one computer processor adapted to performing at least two calculations using at least two of such plurality of preset analysis calculation formulas on such at least one first set of data records having time-relevant values to obtain at least two first performance measures). Overall, the current monitor area 813 preferably utilizes a time-based horizontal axis and differing numeric scales on the left and right vertical axes. Use of differing and variable vertical numeric scales permits simultaneous display of selected analysis calculation trend lines with dissimilar value ranges. The horizontal time scale is preferably adjusted to the time scale selected in the comparative area 807.

Preferably, the graphical display in the composite monitor area 815 preferably presents a trend line of the weighted average of the analysis calculations within each analysis category (at least herein embodying at least one computer processor adapted to calculating at least two second performance measures from such at least two first performance measures). Overall, the composite monitor area 813 preferably utilizes a time-based horizontal axis and differing numeric scales on the left and right vertical axes. Use of differing and variable vertical numeric scales permits simultaneous display of weighted average composite trend lines with dissimilar value ranges (at least herein embodying at least one computer display adapted to simultaneously displaying such at least two second performance measures in a single first graphical visualization). The horizontal time scale reflects the time period of the financial reports; however the sub-period time scale selected in the comparative area 807 is preferably highlighted within the composite monitor area 815. Also preferably provided within the composite monitor area 815 are a reliability gauge 817 and a company thermometer 819. The reliability gauge 817 is preferably an analog presentation representing the overall reliability of the financial reports for a company. The reliability is preferably based on the following scale from high to low:

Audited financial reports, no exceptions,

Audited financial reports, exceptions noted,

Reviewed financial reports, no exceptions,

Reviewed financial reports, exceptions noted,

Compiled financial reports, full disclosure, no exceptions noted,

Compiled financial reports, full disclosure, exceptions noted,

Compiled financial reports, no disclosure,

Special purpose financial reporting,

Non-CPA prepared: i.e. Bookkeeping services,

Self prepared.

This arrangement at least embodies herein at least one computer display adapted to displaying at least one overall measure of the reliability of such financial data using pre-set reliability standards.

Preferably, the company thermometer 819 provides a dynamic measurement of the overall health of a selected company based on the weighted average of the weighted average trends lines for each of the five analysis categories. Preferably, the calculations for both the analysis category weighted averages and the overall weighted average may be altered by a user with appropriate authorizations (at least herein embodying at least one computer display adapted to displaying at least one overall measure of financial health of such at least one first entity; and at least herein embodying wherein such at least one overall measure of financial health comprises at least one weighted average value calculated from such at least two first performance measures).

Preferably, an authorized user may complete an analysis and not save any of the work or may choose to save the details of the analysis either for further work in the future or to create an analysis presentation for others. The storyboard area 811 provides the preferred interface for access to the tools required for saving the analysis done by a user as well as to review a saved analysis. Preferably, the storyboard area 811 provides a set of tools and methods that are similar to those used for creating and editing digital video. First, a user may choose to record all the points of navigation during an analysis session by using a record button to start and stop recording. Each segment created in this manner is then preferably saved and identified with the user. Preferably, these segments are analogous to video clips. Additionally, during the recording process, an authorized user may preferably annotate an aspect of the analysis by “marking” a point on a trend line, a value in a financial report, a point in time, or a range of dates, category, general ledger item, individual item or transaction. Each “mark” then may preferably have one or more attachments associated with it. Preferably the attachment may be any commonly accepted file format such as text, word processing, spreadsheet, audio, video or image or a URL reference to a web site or streaming audio or streaming video. Preferably, after marking a point and attaching a desired file, any other authorized user may view it by selecting the displayed “mark”.

Preferably a saved analysis consisting of multiple recorded segments and related attachments may be re-opened and edited in a manner analogous to editing digital video. In particular, an authorized user may record and insert additional segments of analysis, delete existing segments, add, modify or delete any attachment within a segment or rearrange the order of the segments.

Preferably, any saved analysis presentation may be provided to an authorized user for “playback” using the playback buttons in the storyboard area 811. Preferably, as with the creation and editing tools, the playback functions are analogous to video playback: forward, pause, fast forward, reverse, single frame forward, single frame reverse, fast reverse, rewind, jump to beginning, jump to end, etc. Preferably, an authorized user will be able to start a presentation and view each recorded segment including attachments through to the end without intervention, as is possible with a movie or video.

Referring now to FIG. 11, a diagrammatical view of the preferred primary analysis screen according to a preferred embodiment of the present invention is shown.

Referring now to FIG. 12, a diagrammatical view of the preferred primary user interface screen illustrates selection of a timeframe and analysis of one profitability factor according to a preferred embodiment of the present invention.

Referring now to FIG. 13, a diagrammatical view of the preferred primary user interface screen illustrates selection of a timeframe and analysis of multiple profitability factors according to a preferred embodiment of the present invention.

### ALTERNATE PREFERRED EMBODIMENT

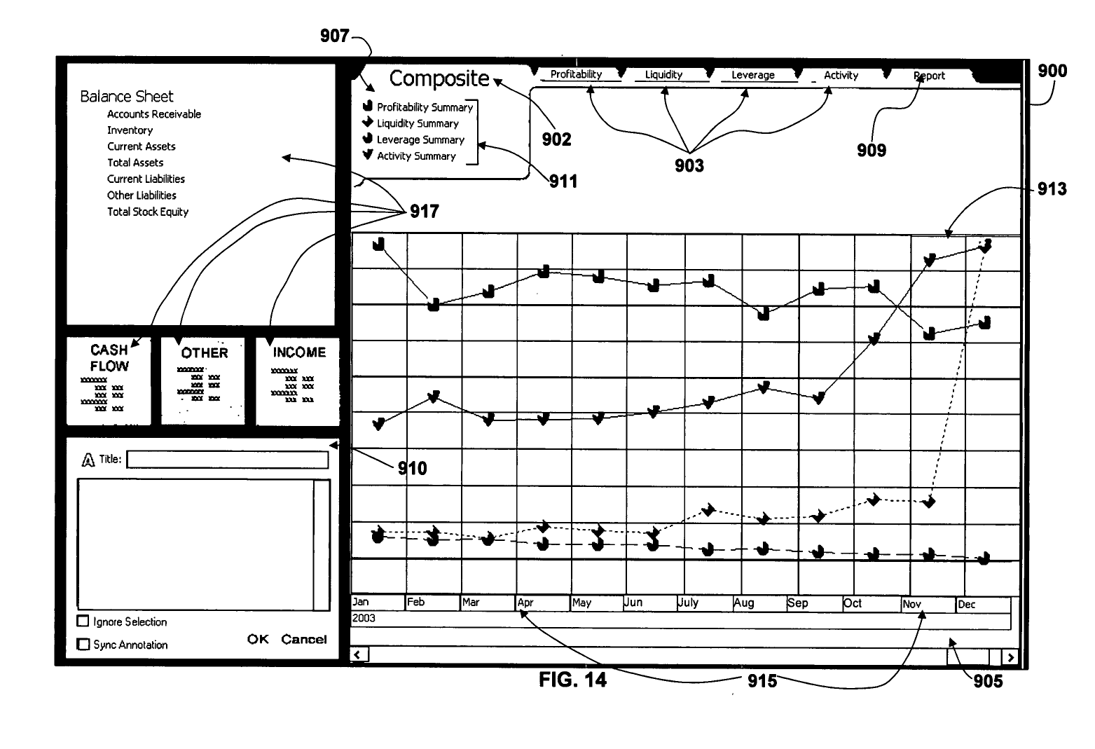

Referring now to FIG. 14, a diagrammatical view of the preferred user interface presenting a composite overview screen of company financial performance according to an alternate preferred embodiment of the present invention is shown. Where not otherwise stated hereinafter, this alternate preferred embodiment includes properties and functions of the first-described preferred embodiment. The alternate preferred composite overview screen 900 is preferably structured into key areas which a user may preferably access in any sequence. Although no strict sequence of usage is imposed by the preferred composite overview screen 900, each of the areas will be described in a sequence which permits the best understanding of the functions of each area and its relationship to the other areas. Additionally, all of the areas described below are preferably interrelated to permit a user to analyze complex sets of financial information in the most effective manner possible from a single source screen.

Upon initial presentation of the composite overview screen 900, according to this alternate preferred embodiment of the present invention, a user will preferably select a specific analysis category 903 to be applied to the selected company's financial data from the tab associated with the analysis category 903. Preferably the analysis categories 903 rely on those defined by Generally Accepted Accounting Principles (GAAP) and preferably comprise: 1) liquidity, 2) profitability, 3) leverage, and 4) activity. Preferably a fifth analysis category 903, composite, is also provided which permits display, and thus comparison, of a summary analysis calculation 911 from each of the four GAAP-based analysis categories 903.

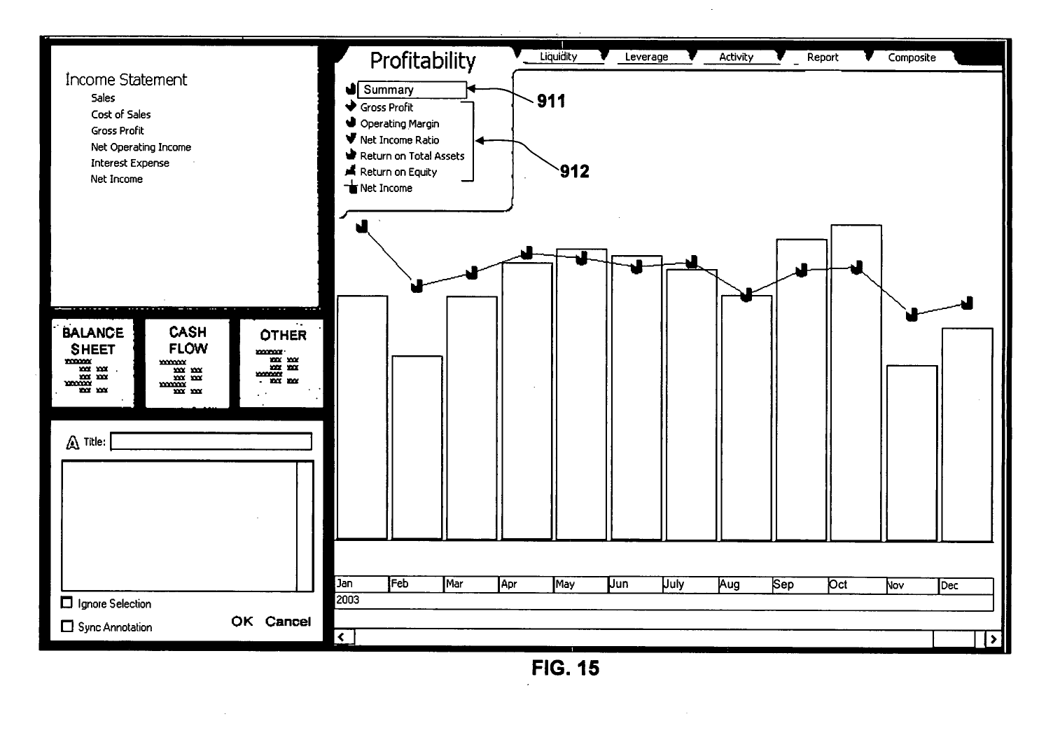

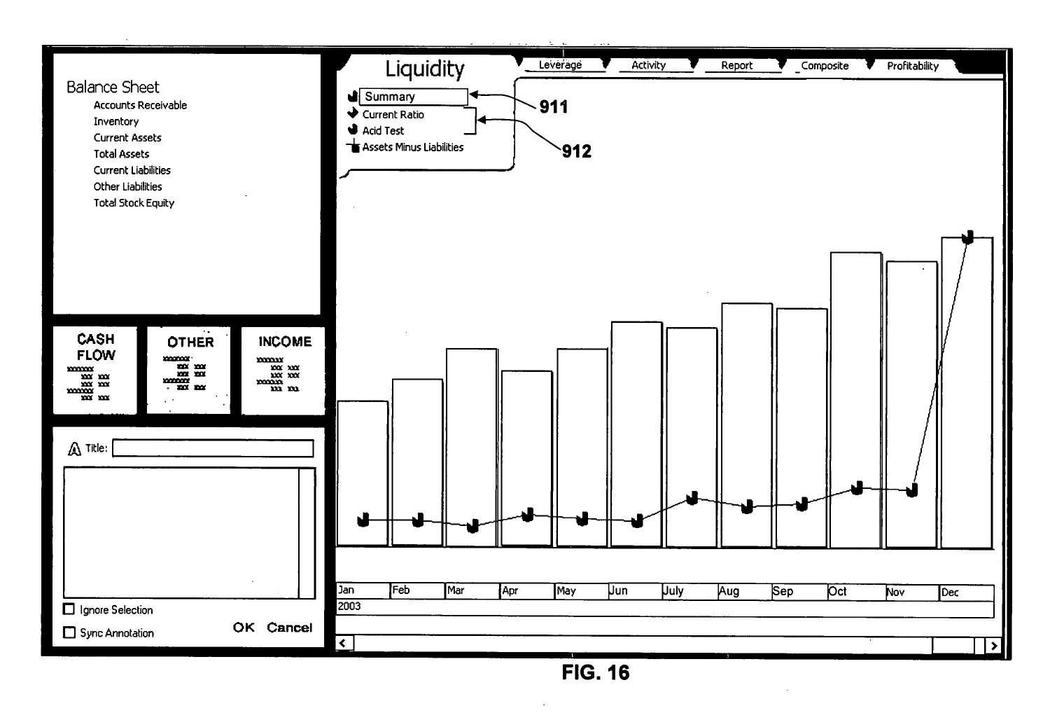

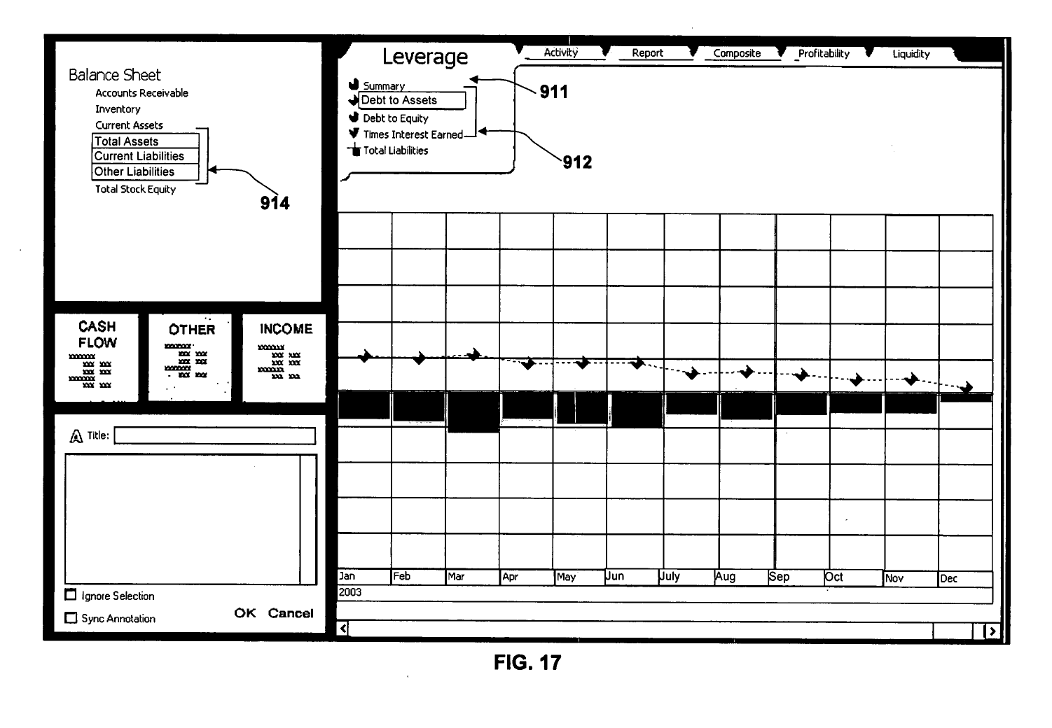

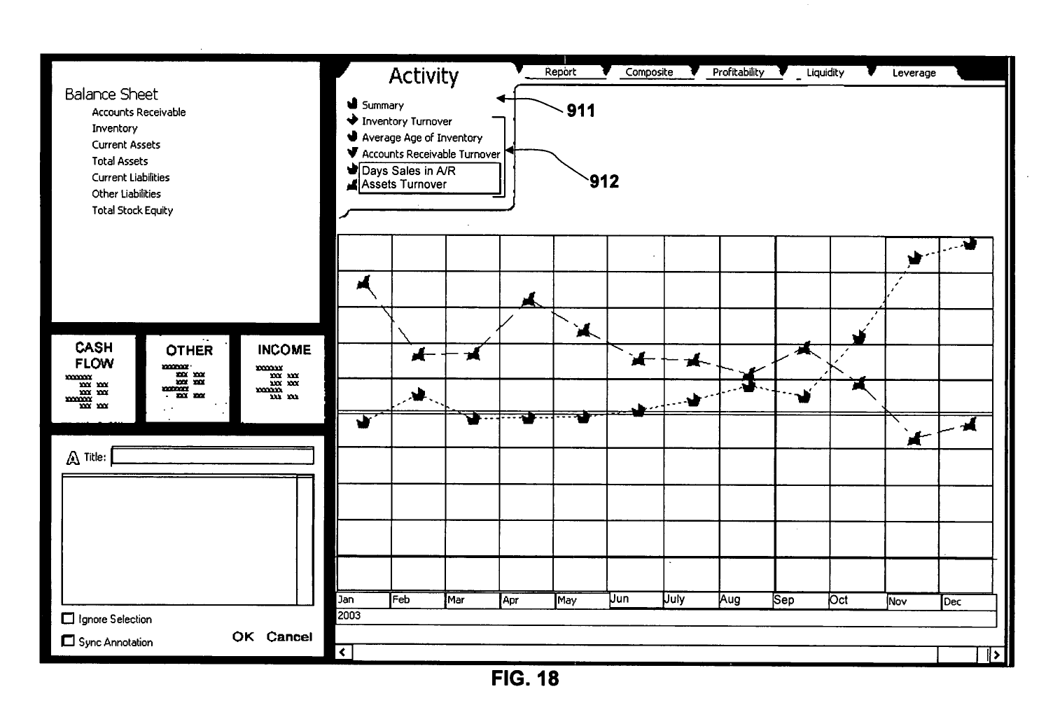

According to such alternate preferred embodiment of the present invention, selecting a tab for an analysis category 903 moves the selected analysis category 903 to the left and displays the associated analysis calculations 912 in the calculations area 907. Additionally, this action will result in the trend lines for the selected analysis calculations 911 for the selected time periods being graphically displayed in the display area 913. All trend lines for the selected analysis calculations 912 are preferably displayed simultaneously in the display area 913 to present a visual summary to the user. Preferably, only analysis calculations 912 within an analysis category 903 may be selected for presentation. However, users with appropriate authorization may preferably alternatively select analysis calculations 912 from more than one analysis category 903. Reference is made to FIG. 15, FIG. 16, FIG. 17 and FIG. 18 for examples of presentation of analysis displays for each analysis category 903 and related analysis calculations 912.

According to such alternate preferred embodiment of the present invention, the time period associated with the financial data is preferably displayed in the timeline area 905. In other words, the selected financial report 917 may cover, for example, one year—so the time period displayed will be between the beginning and end dates of the year with the data segmented by any sub-periods (months) available within the underlying financial data.

Preferably, a user may use the composite overview screen 900 to compare financial results from one or more other companies.

The display area 913 preferably provides a simultaneous display of all analysis calculations selected by a user in the calculations area 907. Overall, the display area 913 preferably utilizes a time-based horizontal axis and no specific scale on the vertical axis. Use of no vertical scale permits simultaneous display of selected analysis calculation trend lines with dissimilar value ranges. The horizontal time scale is preferably adjusted to the time scale related to underlying financial information or selected by the user. Preferably, the time periods selected by the user are highlighted in the timeline area 905.

Preferably, when the composite tab 902 is selected a trend line of the weighted average of the analysis calculations 912 for each analysis category 903 is presented in the display area 913. This permits the user to compare the trends within each analysis category 903 in relation to trends of all other analysis categories 903 in one display.

Also preferably presented, when the composite tab 902 is selected, are a reliability gauge 817 (not shown on FIG. 14, refer to FIG. 10 and related discussion for a detailed description) and a company thermometer 819 (not shown on FIG. 14, refer to FIG. 10 and related discussion for a detailed description).

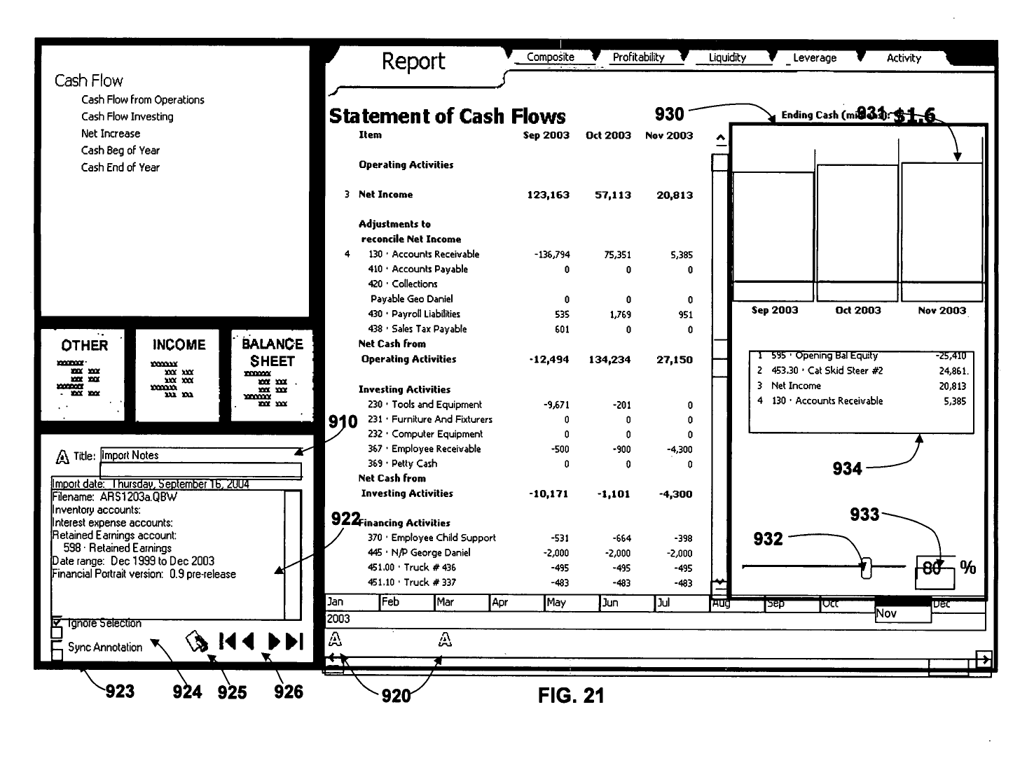

Further according to such alternate preferred embodiment of the present invention, an authorized user may preferably complete an analysis and not save any of the work or may choose to save the details of the analysis either for further work in the future or to create an analysis presentation for others. Preferably, the annotation and playback area 910 provides the preferred interface for access to the tools required for saving the analysis done by a user as well the tools for presentation or review of a saved analysis and related annotations and attachments. (Refer to FIG. 21 for an example of annotation and playback area 910 for a save presentation/analysis according to such alternate preferred embodiment of the present invention, and refer to the first preferred embodiment for a detailed discussion of preferred methods for creating, updating and saving analysis sessions.)

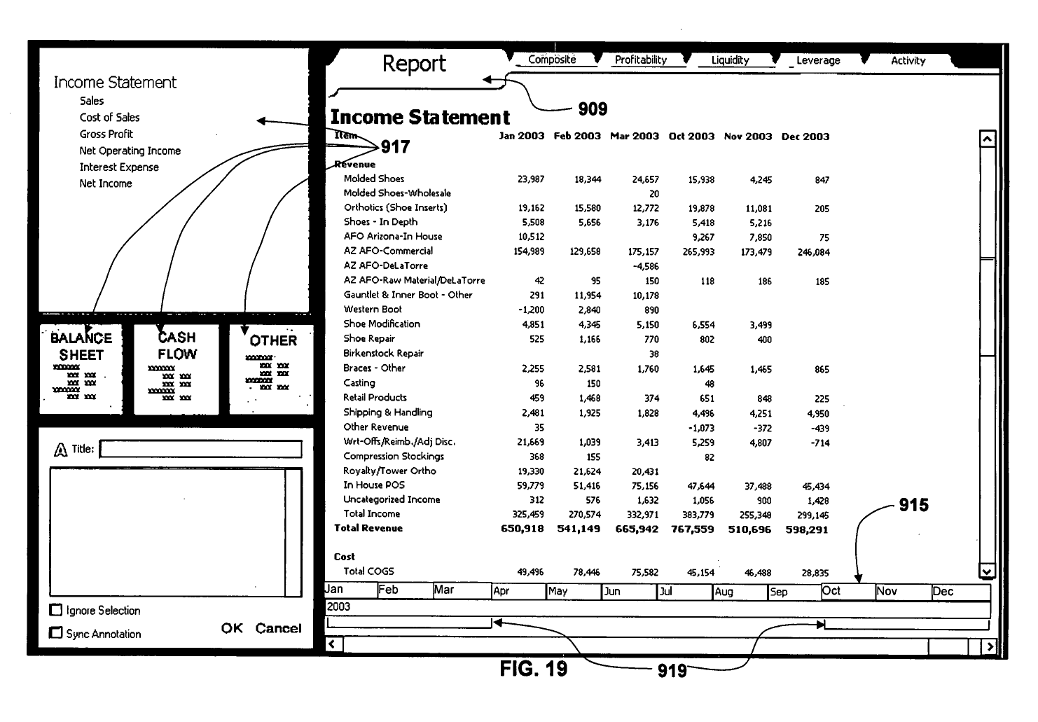

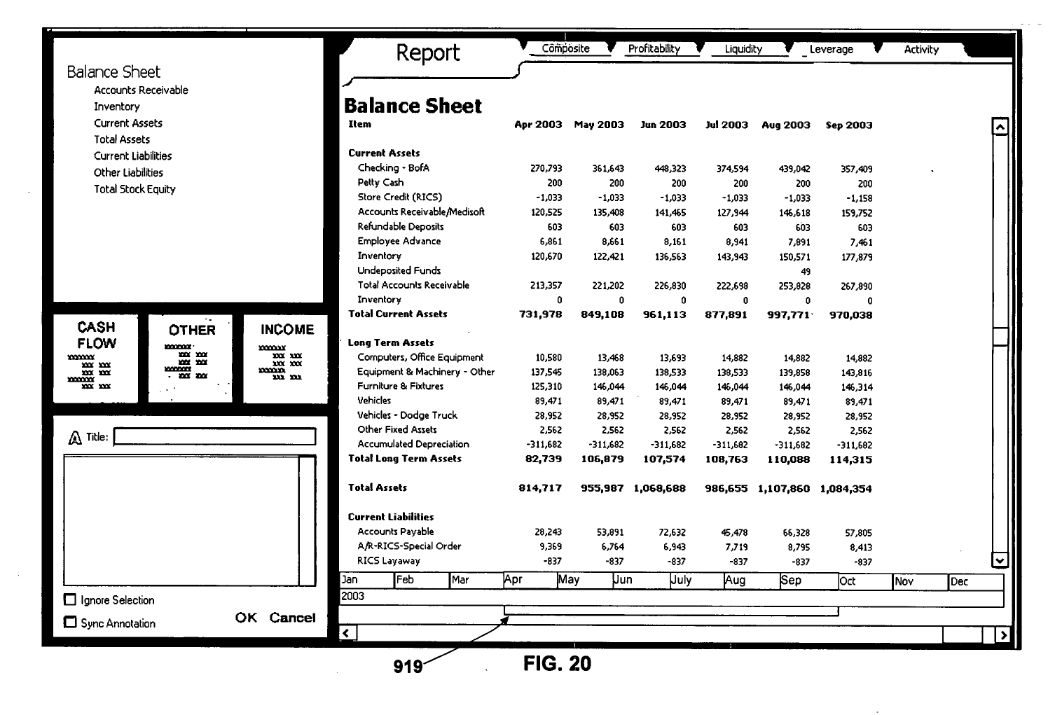

As shown in FIG. 21, any saved analysis presentation may preferably be provided to an authorized user for “playback” using the playback buttons 926 located in the annotation and playback area 910. Preferably, the playback buttons 926 are analogous to video playback: forward, pause, fast forward, reverse, single frame forward, single frame reverse, fast reverse, rewind, jump to beginning, jump to end, etc. Preferably, an authorized user will be able to start a presentation and view each recorded segment including attachments through to the end without intervention, as is possible with a movie or video. Preferably, a user may choose to view annotations and attachments in synchronization with the presentation by selecting the synchronize checkbox 923. Preferably, a user may view annotations and attachments independently of the presentation by selecting the ignore selection checkbox 924. Preferably, an authorized user may select the annotation icon 925 to add a new annotation, attach at the selected point in the presentation, or edit an existing annotation. Preferably, the playback buttons 926 will be available only if viewing a saved analysis or presentation. Reference is to FIG. 14, FIG. 15, FIG. 16, FIG. 17, FIG. 18, and FIG. 19 for examples in which no saved analysis or presentation is being viewed.

Referring to FIG. 19, a diagrammatical view of the preferred user interface screen presenting an example of a detail report of company income by period according to such alternate preferred embodiment of the present invention is shown. Preferably, the display area 913 provides a working space for presenting selected time periods for comparison. The display area 913 also preferably permits a user to select one or more time periods 915 to permit a more detailed comparison of any summary analysis calculation 911 or any analysis calculation 912. As illustrated, this report compares the selected time periods 919, January 2003, February 2003 and March 2003, to another set of selected time periods 919, October 2003, November 2003 and December 2003, for the selected company's Income Statement. Preferably, there is no limitation on the number of time periods 915 which may be compared.

Referring to FIG. 19, FIG. 20 and FIG. 21, according to such alternate preferred embodiment of the present invention, the report tab 909 preferably provides access to the underlying financial information for a selected company. Preferably selecting the report tab 909 and a financial report 917 will result in the presentation of the line item detail in the display area 913. As shown, each financial report 917 is consistent with four primary segments of generally accepted financial reporting: 1) Income Statement, 2) Balance Sheet, 3) Statement of Cash Flows, and 4) Accompanying data (accessed by selecting the Other Tab). The commonly accepted classifications within each financial report 917 which are the basis for an analysis calculation are preferably automatically highlighted when a user selects an analysis calculation 912 in the calculations area 907 under one of the tabs for the particular analysis category 903. Highlighting the classification further permits the user to focus on the details underlying the analysis calculation 912. The user may preferably select any classification, highlighted or not, to view the underlying financial detail for the time period or sub-period indicated in the timeline area 905.

Preferably, the user may select an individual line item from the selected financial report 917 to “drill down” further into the details. When available, authorized users may preferably “drill down” to individual transactions underlying a line item on the selected company's financial report. Preferably, selection at each level within each financial report 917 opens a window displaying the next level of detail of the company's financial information (not shown). Each window may be minimized, but preferably will remain open until closed by the user. A user may preferably keep as many windows open as desired.

The selected time periods 919 chosen by a user are used to preferably display the report information, shown in FIG. 19. Preferably, the selected time periods 919 may be contiguous, as shown in FIG. 20, or non-contiguous, as shown in FIG. 19.

Referring to FIG. 21, a diagrammatical view of the preferred user interface screen presenting an example of a sensitivity analysis using the Statement of Cash Flows report for a company by period according to an alternate preferred embodiment of the present invention is shown. Preferably, a user may use the sensitivity analysis tool 930 with selected reports as an aid in the evaluation of the factors that have the largest impact on financial results. Preferably, this method of analysis permits a user to quickly identify the primary factors which affect the results presented by the selected report, thereby minimizing the time required to identify the key areas and simplify the analysis for users without a financial background.

Preferably, the sensitivity analysis tool 930 may be applied to a company's income statement, statement of cash flows, balance sheet, or non-financial reports such as activity-based reports such as unit sales by product, etc (at least herein embodying assisting presenting such at least one report containing such first set of line items having time-relevant values to at least one user). Additionally, the sensitivity analysis tool 930 may preferably be used to analyze the changes from one reporting period to another for any of the reports listed above. For example, as shown in FIG. 21, the sensitivity analysis tool 930 has been chosen for use with the company's statement of cash flows. Preferably, the sensitivity analysis tool 930 comprises: 1) a bar graph 931 of the total values for the selected report for the selected periods; 2) the sensitivity slider 932 for setting the sensitivity level expressed as a percentage; 3) the sensitivity level 933; 4) the line items 934 from the report that are encompassed by the boundaries calculated from the sensitivity level 933; and 5) line item selection calculations (at least herein embodying permitting such at least one user to select at least one percentage limit relating to calculating cumulative values boundaries).

Preferably, the line item selection calculations comprise the following steps: 1) sum the numerical values (without regard to positive or negative sign) of all the line items contained in the report; 2) arrange the report line items in descending order based on their numerical values; 3) calculate a cumulative total for each line item which is the sum of all numerical values of the current line item plus the cumulative total of the previous line item; 4) multiply the sensitivity level and the sum of the numerical values of all line items to get the sensitivity value; 5) compare the sensitivity value to the cumulative total for each line item; 6) display the line items which comprise the cumulative total that is equal to or less than the sensitivity value and highlight the individual line items in the associated report [a. Upon reading the teachings of this specification, those with ordinary skill in the art will now understand that, under appropriate circumstances, considering such issues as developer preferences, the nature of the application and changes in technology, etc., other methods of calculation may suffice.

Preferably, the result of this calculation is a displayed list of the line items 934 which have the biggest impact on the reported values at the selected sensitivity level. Preferably, a user may set the sensitivity level by moving the sensitivity slider 932 to the left to decrease the sensitivity level 933 or to the right to increase the sensitivity level 933 (at least embodying herein permitting such at least one user to continuously reselect such at least one percentage limit relating to calculating cumulative values boundaries until the desired number of such identified line items having time-relevant values are presented; and at least embodying herein at least one computer interface adapted to permitting continuously re-selecting, by such at least one first analyzer, such at least one percentage limit relating to calculating cumulative values boundaries until the desired number of such identified fourth set of most-significant data records having time-relevant values are presented). Preferably, as the sensitivity level 933 is changed the number of items 934 displayed will be adjusted automatically based on the results of the line item selection calculations (at least embodying herein identifying such at least one second set of line items having time-relevant values, included in such at least one first set of line items having time-relevant values, within such cumulative values boundaries; and at least embodying herein presenting such identified second set of line items values having time-relevant values to such at least one user). Preferably, a user is permitted to change the sensitivity level in saved analyses or presentations because all the underlying data necessary for the calculations are available.

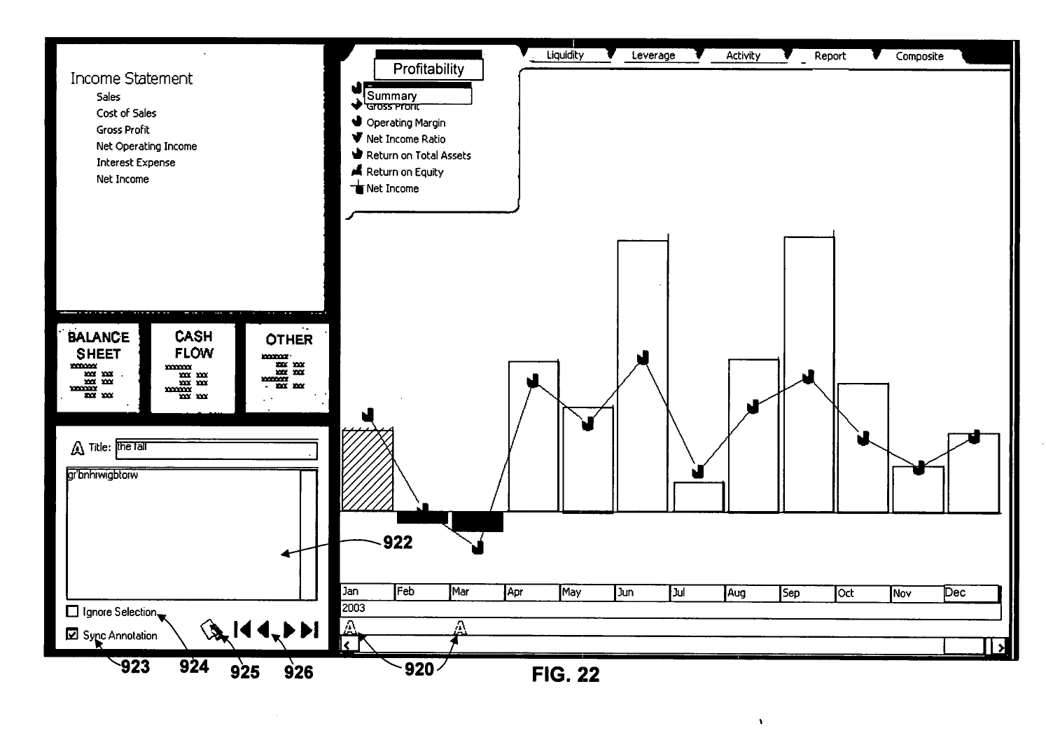

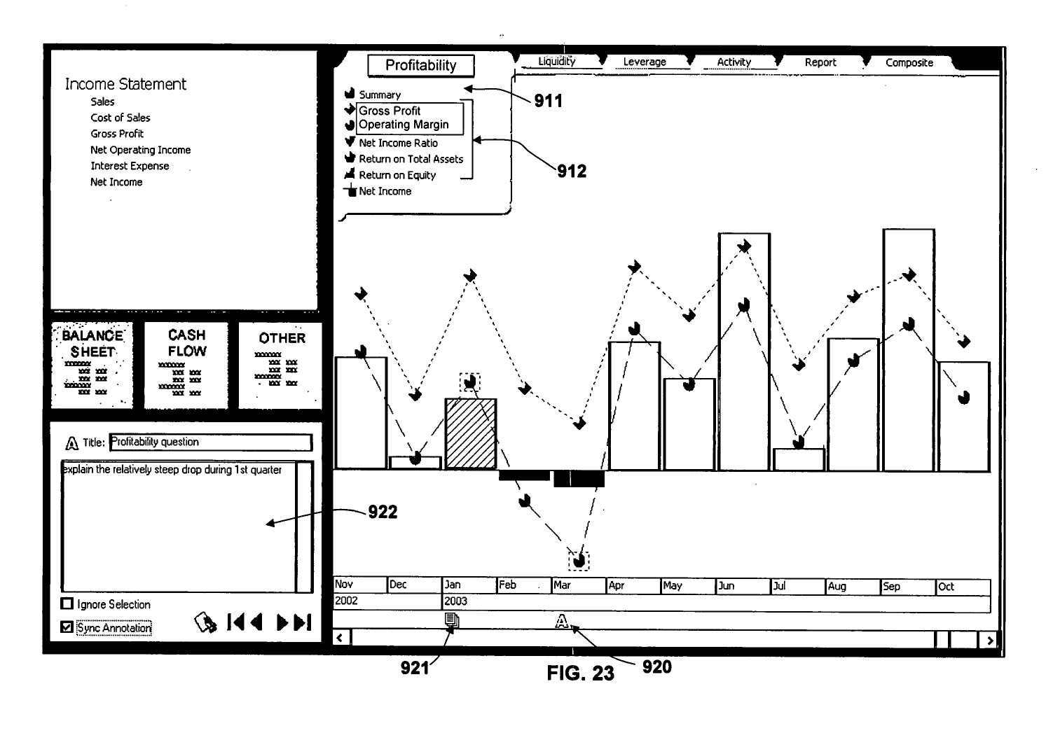

Referring again to FIG. 2 1, an example of a saved analysis or presentation is shown. Particularly, the annotation and playback area 910 and timeline area 905 contain additional information and icons. Preferably, when a user is viewing a saved analysis/presentation the annotation icon 920 is displayed in the timeline area 905 immediately under the time period 915 with which it is associated when an annotation 922 is available. Preferably, a user may select the synchronize checkbox 923 to permit displaying annotations 922 associated with particular reports or points of time within a report as the report is being displayed. Preferably, clicking on the annotation icon 920 causes the annotation 922 to be displayed in the annotation and playback area 910. Referring to FIG. 22 and FIG. 23, the annotations 922 shown are examples of annotations 922 associated with specific reports or points in time for a particular report. Preferably, a user may alternatively select the ignore selection checkbox 924 to permit review of annotations 922 and attachments without regard to the analysis/presentation information being displayed including annotations 922 made to the presentation/analysis in general. Referring to FIG. 21, the annotation presented is an example of the display of a general annotation 922 when the ignore selection checkbox 924 is selected. Preferably, selecting the add/edit annotation icon 925 permits an authorized user to add their own annotation or edit an existing annotation 922. Preferably, the playback buttons 926 permit a user to “play” a presentation in the same manner that a video or audio recording can be played. For additional details on the operation of the playback buttons, see the discussion related to FIG. 5, FIG. 10, and FIG. 14.

Referring to FIG. 22, a diagrammatical view of the preferred user interface screen presenting an example of a profitability analysis with related annotations of company income by period according to such alternate preferred embodiment of the present invention is illustrated. As shown, preferably the initial Profitability report presents the company's net profit as a histogram by time period which is overlaid with line graph of the summary profitability calculation (average of the analysis calculations 912) for each period. This presentation preferably assists the user in determining what, if any additional analysis may be necessary to better understand and or explain the company's profitability results.

Referring to FIG. 23, a diagrammatical view of the preferred user interface screen presenting an example of a profitability analysis using multiple analysis measures with related annotations of company income by period according to such alternate preferred embodiment of the present invention is shown. Preferably, as illustrated, the user has chosen to examine two analysis calculations 912 in particular, gross profit and operating margin. As can be seen in the months where losses occurred, operating margin declined more rapidly than gross profit indicating an area for further analysis or explanation. Additionally, as can be seen an attachment icon 921 and an annotation icon 920 are displayed, which may provide more insight into the problem.

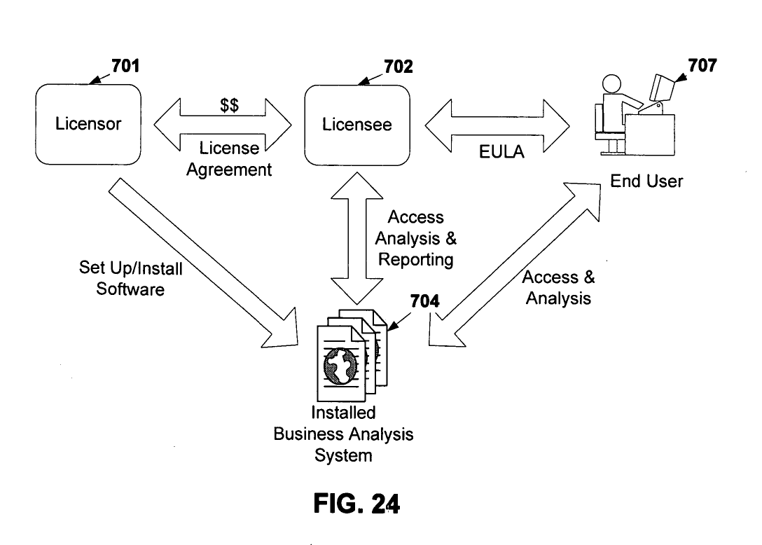

Referring to FIG. 24, an overall summary diagrammatical view of the preferred licensing and business relationship of a licensor, licensee and an end user, according to such alternate preferred embodiment of the present invention is shown.

Preferably, the system developer will market the instant invention to selected industries which will benefit from availability of an analysis tool which permits preparation of financial analyses which are understandable by people other than accountants, and finance managers. Preferably, the instant system provides a set of analysis and communications tools which are consistent with the five elements of Enhanced Business Reporting conceived of by the Innovation Special Committee of the AICPA (American Institute of Certified Public Accountants). Preferably, those markets will comprise the financial audit industry, the commercial lending industry, the venture capital industry, not-for-profit fund raising and the financial software industry. Additional markets will preferably include litigation support where concise clear analysis and explanations of financial information are of importance in the litigation. In each environment, the availability of a presentation “reader” for viewing of a particular presentation/analysis that may be distributed without charge to the end user is preferably a key component of the alternate preferred business method.

According to such alternate preferred embodiment of the present invention, preferably, a licensing relationship will be established which permits a licensee 702 to install the instant system on the computer hardware of the licensee 702. Preferably, the license fee will be based on a set period of time and the usage of the instant system by the licensee 702, or some analog of usage such as the number of authorized users. Preferably, the instant system is structured to permit installation in various, but compatible, computer hardware and network environments. Under this structure, upon completion of a license agreement, licensor 701 assists licensee 702 with the installation and initial set up of the operating environment for the licensee 702 for the installed business analysis system 704 and provides the licensee 702 the necessary access training to set up one or more desired analysis databases.

According to such alternate preferred embodiment of the present invention, a first licensing example is preferably in industries such as commercial lending, venture capital and not-for-profit funding where the licensee 702 will be the company or organization receiving the funds and the provider of funds will be the end user 707. Preferably, the licensor 701 will identify and market the instant invention to providers of funds 707 as a means of better monitoring and managing the outcomes achieved by the recipient organizations (. Preferably, licensor 701 will suggest that the providers of funds 707 either require the use of the installed business analysis system 704 as a funding requirement or, at least, strongly encourage its use ( ). Preferably, in these environments, licensee 702, which is the company or organization receiving the funding, will preferably utilize the instant system to analyze the financial results of the company or organization and prepare presentations and analyses for use by the funding source for the purpose ensuring the provided funds are used to achieve the desired/agreed result and to identify problem areas requiring attention by the recipient company or organization. In this example, licensee 702 will authorize access for end user 707, which may also comprise individuals employed by the provider of funding for the purpose of reviewing and annotating the presentations and analyses prepared by licensee 702. Preferably, the installed business analysis system 704 will permit each party, licensee 702 and end user(s) 707, to maintain a “running dialog” within any particular annotation regarding the financial results of the licensee 702 using the annotation and attachment functions of the business analysis system 704. The benefit to both licensee 702 and end user 707 is better understanding of the financial results and how best to manage any problem areas.

According to such alternate preferred embodiment of the present invention, in a second preferred licensing example the instant system will preferably be used in the financial audit industry in which audit firms license the installed business analysis system 704 from licensor 701 for use in performing audit work for their clients. In this second example the licensing relationship permits the audit firm, acting as licensee 702, to utilize the software as part of the audit work with a variety of clients and to permit employees of the audit client, as end user(s) 707 to access, annotate, etc., presentations/analyses prepared by the audit firm. Thus, communication and understanding are improved for both the audit firm and client.

According to such alternate preferred embodiment of the present invention, in a third licensing example, the installed business analysis system 704 may be integrated with various financial accounting software systems. Preferably, in this third licensing example, a licensee of a financial accounting software system would be given the opportunity to become a licensee 702 of the installed business analysis system 704 for the company's internal use, or as an external reporting tool. In the first case, the company's employees would preferably be the end user(s) 707. If the installed business analysis system 704 is used for external reporting, the company may choose to make the system available in the form of a downloadable “reader” which is provided free of charge to end user(s) 707. Preferably, the end user(s) 707 may only use the “reader” to perform a limited number of functions, such as provide comments and questions as annotations to an existing presentation. In this example, the end user(s) 707 benefits from providing improved tools for its investors and stakeholders to better understand its financial results. Additionally, the licensee 702 benefits from improved feedback from the end user(s) 707.

Upon reading the teachings of this specification, those with ordinary skill in the art will now understand that, under appropriate circumstances, considering such issues as user preference, the nature of the application and changes in technology, etc., other methods of licensing the instant system may suffice.

### ANOTHER ALTERNATE PREFERRED EMBODIMENT

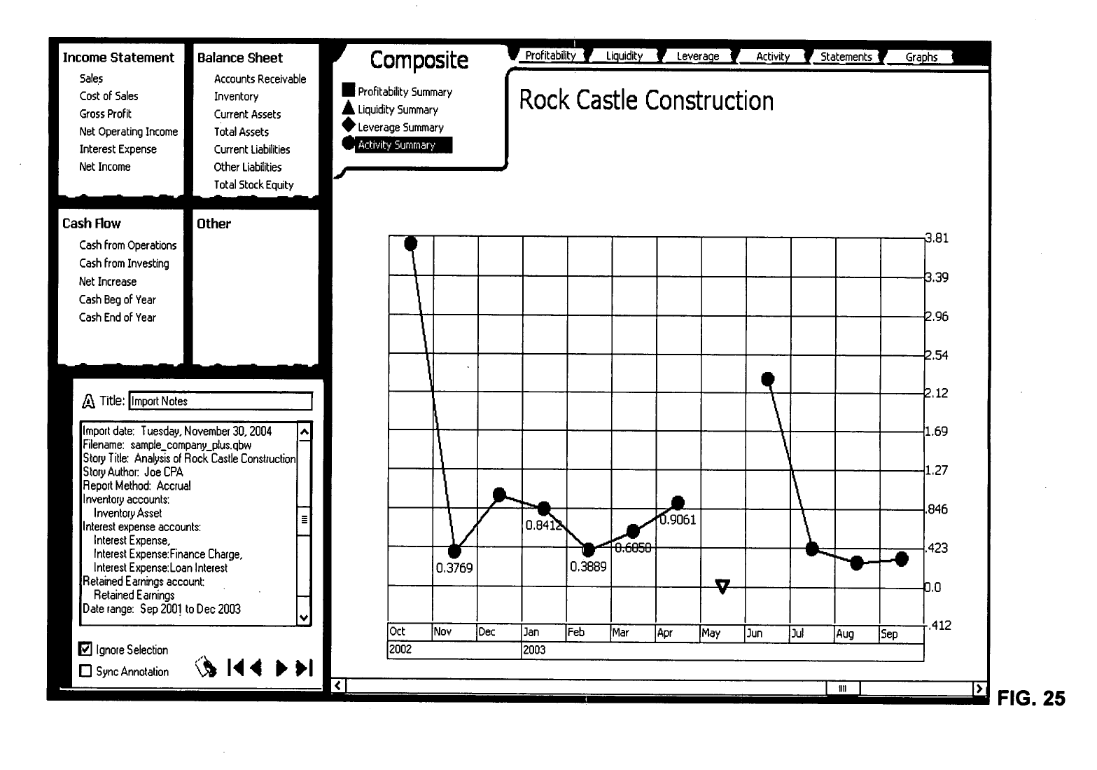

Referring to FIG. 25, a diagrammatical view of another alternate preferred user interface presenting a composite overview screen of company financial performance according to another alternate preferred embodiment of the present invention is provided. Refer to FIG. 14 for a description of the functions associated with the composite overview of company financial performance screen.

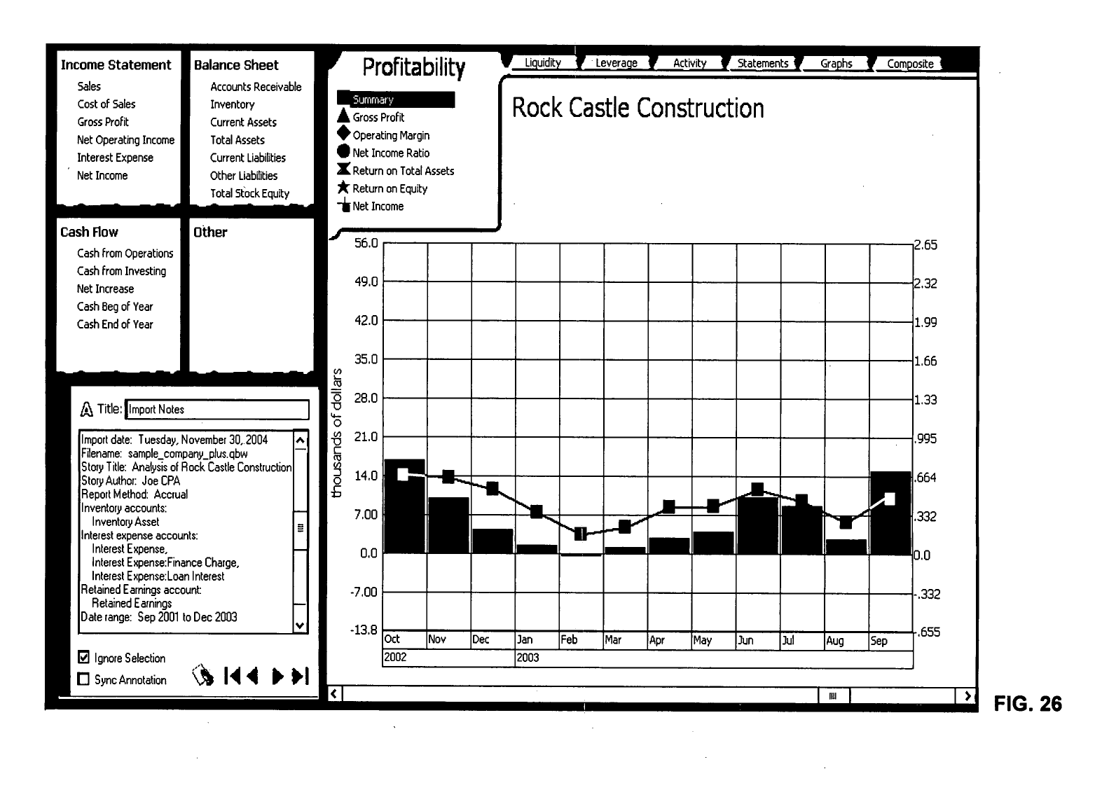

Referring to FIG. 26, a diagrammatical view of another alternate preferred user interface presenting a company profitability analysis according to another alternate preferred embodiment of the present invention is presented. Refer to FIG. 15 for a description of the functions associated with the composite overview of the company profitability analysis screen.

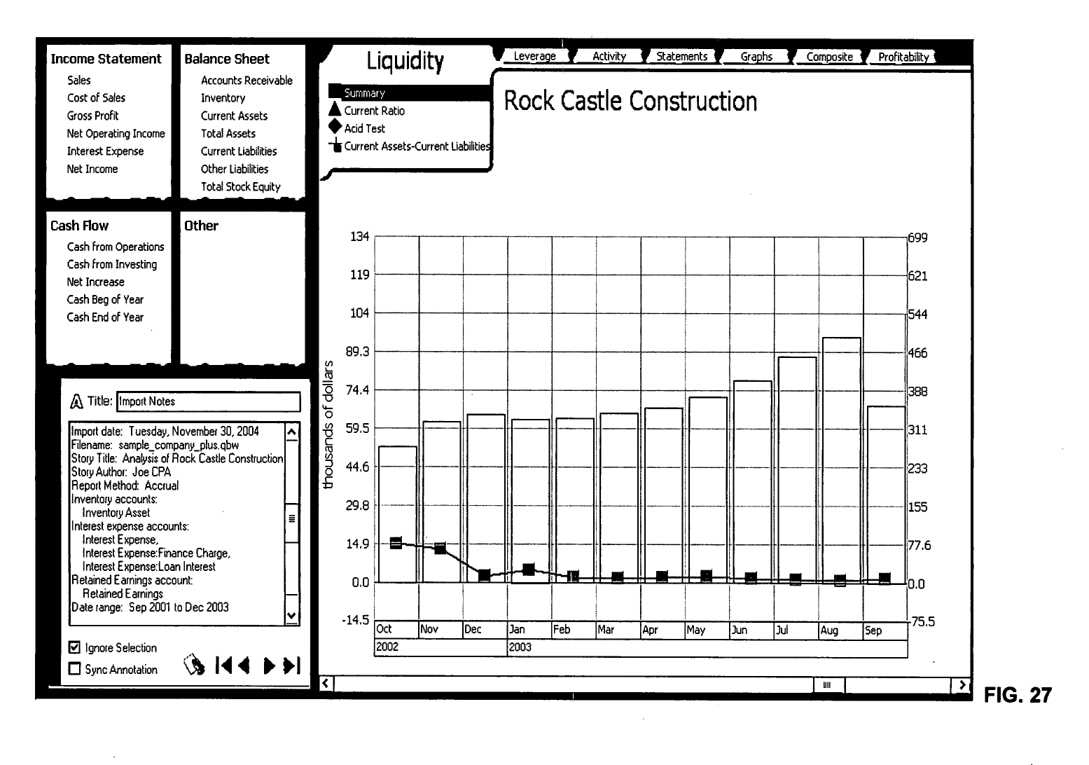

Referring to FIG. 27, a diagrammatical view of another alternate preferred user interface screen presenting an example of company liquidity analysis according to another alternate preferred embodiment of the present invention is provided. Refer to FIG. 16 for a description of the functions associated with the company liquidity analysis screen.

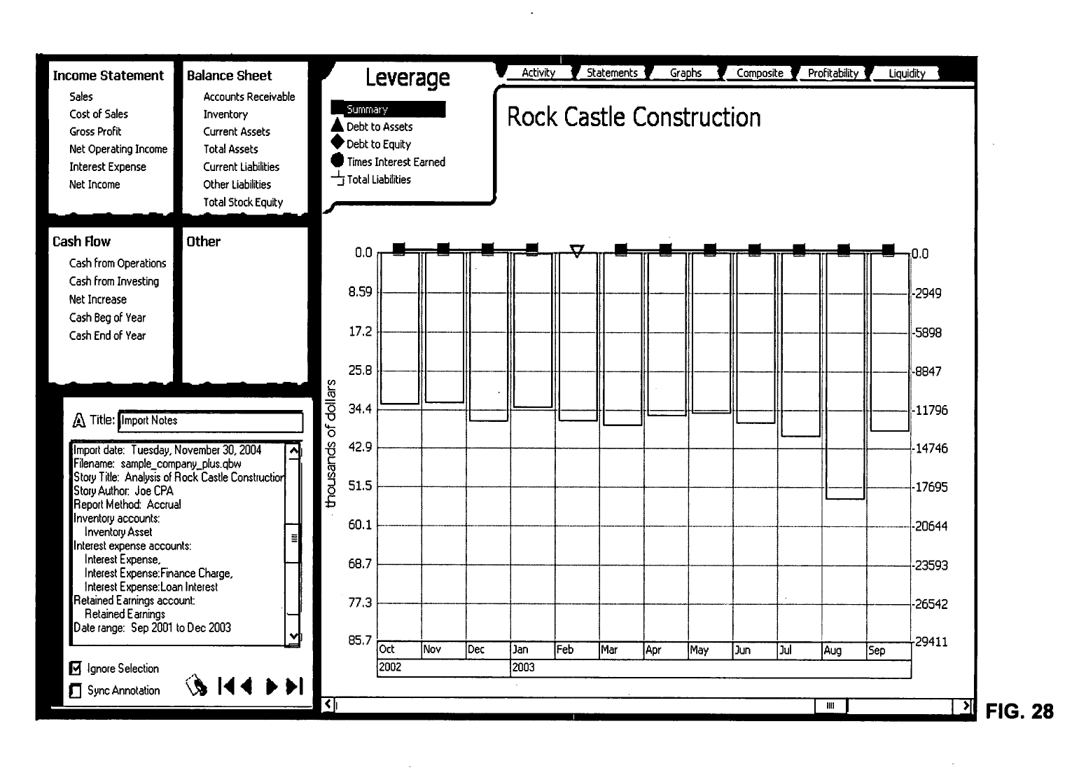

Referring to FIG. 28, shows a diagrammatical view of another alternate preferred user interface screen presenting an example of company leverage analysis according to another alternate preferred embodiment of the present invention is provided. Refer to FIG. 17 for a description of the functions associated with the screen.

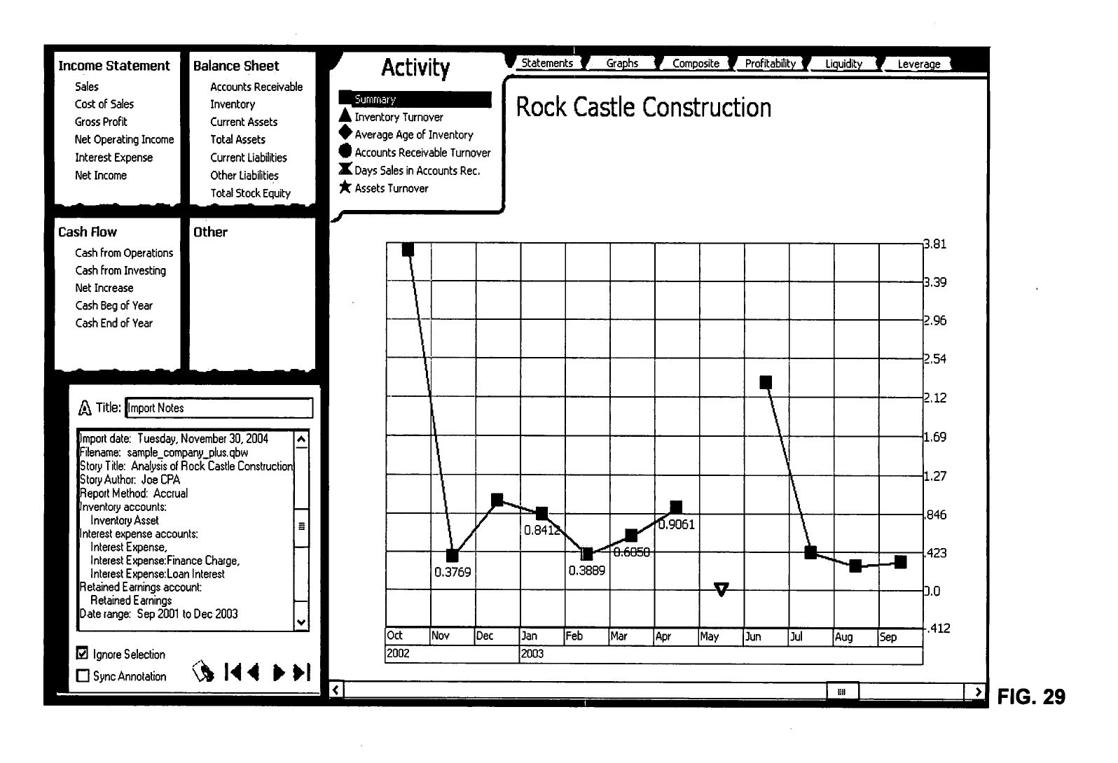

Referring to FIG. 29, a diagrammatical view of another alternate preferred user interface screen presenting an example of company activity analysis according to another alternate preferred embodiment of the present invention is presented. Refer to FIG. 18 for a description of the functions associated with the screen.

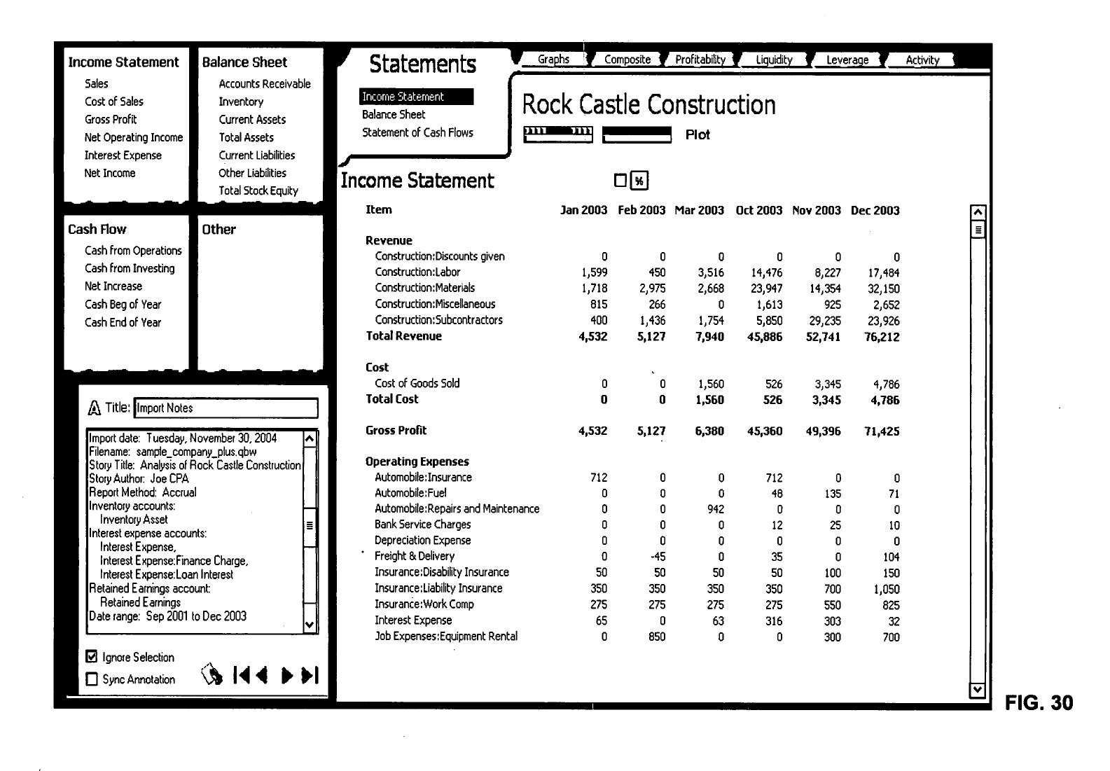

Referring to FIG. 30, a diagrammatical view of another alternate preferred user interface screen presenting an example of a detail report of company income by period according to another alternate preferred embodiment of the present invention is provided. Refer to FIG. 19 for a description of the functions associated with the screen.

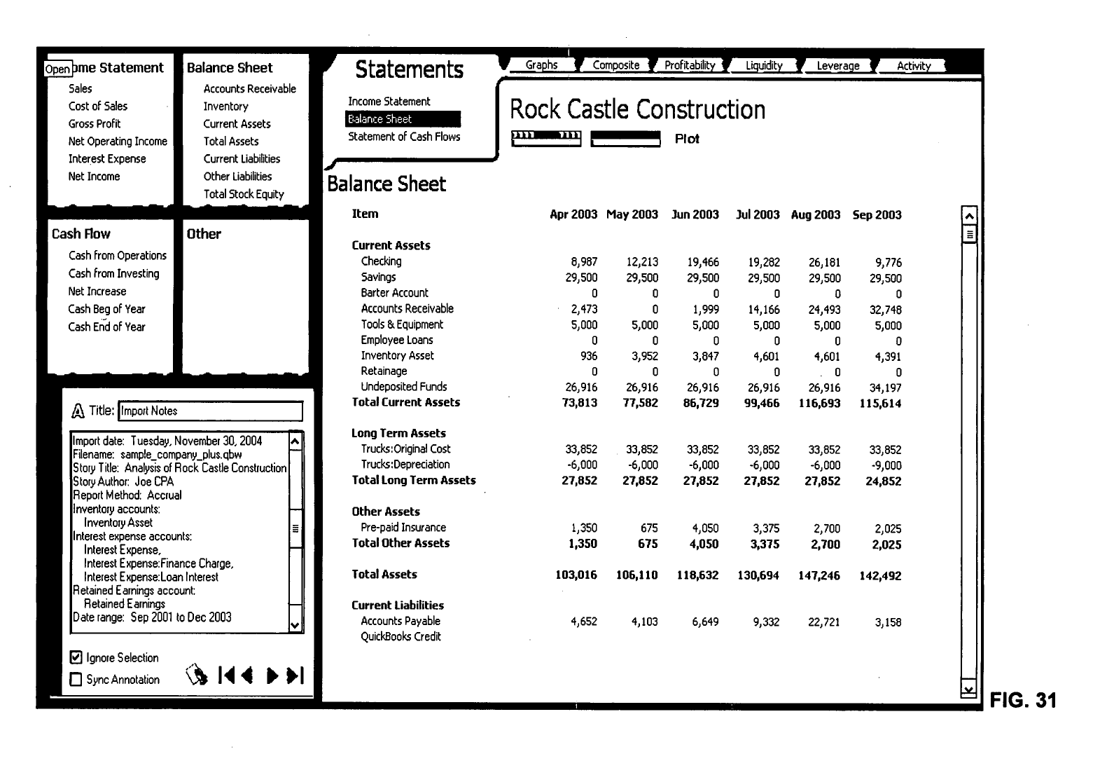

Referring to FIG. 31 a diagrammatical view of another alternate preferred user interface screen presenting an example of a detail balance sheet report for a company income by period according to another alternate preferred embodiment of the present invention is presented. Refer to FIG. 20 for a description of the functions associated with the screen.

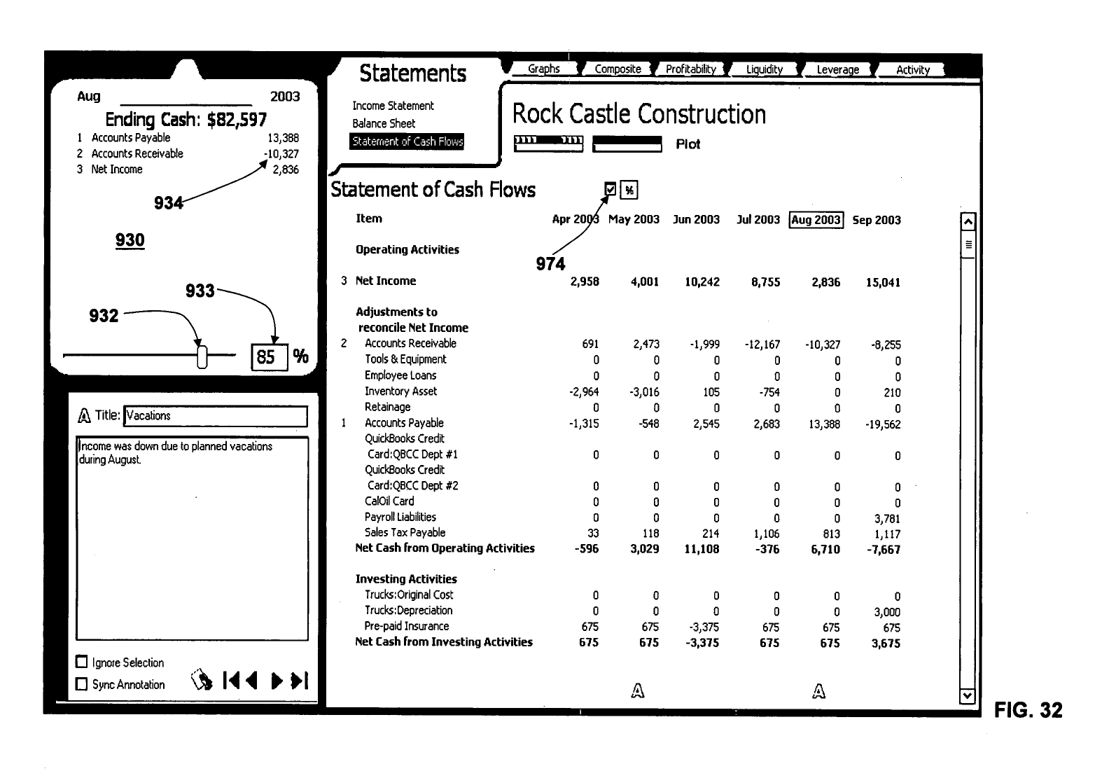

Referring to FIG. 32 a diagrammatical view of another alternate preferred user interface screen presenting an example of a sensitivity analysis using the Statement of Cash Flows report for a company by period according to another alternate preferred embodiment of the present invention is presented. Refer to FIG. 21 for a description of the functions associated with the screen. Clicking on the sensitivity analysis checkbox 974 preferably invokes the sensitivity analysis tool 930. Once the sensitivity analysis tool 930 is presented the user may preferably choose any time period to view the most significant line items comprising the value being analyzed (at least herein embodying wherein such at least one report is at least one financial report).

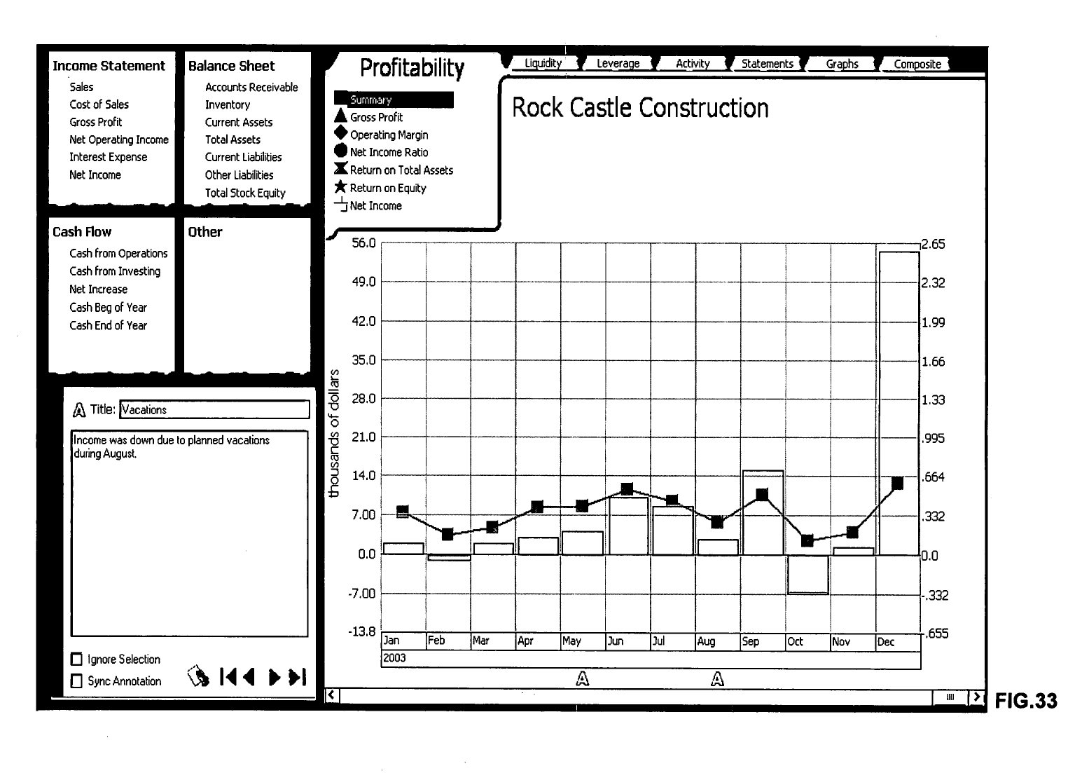

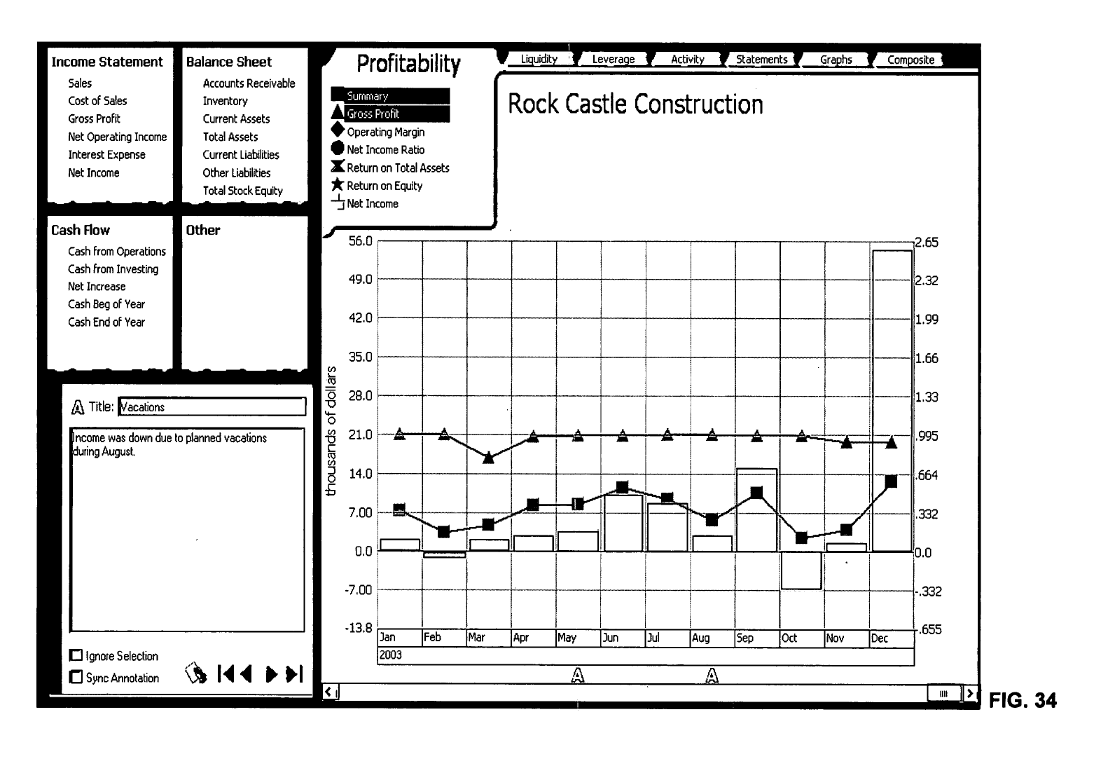

Referring to FIG. 33 a diagrammatical view of another alternate preferred user interface screen presenting an example of a profitability analysis with related annotations of company income by period according to another alternate preferred embodiment of the present invention is provided. Refer to FIG. 22 for a description of the functions associated with the screen.

Referring to FIG. 34, a diagrammatical view of another alternate preferred user interface screen presenting an example of a profitability analysis using multiple analysis measures with related annotations of company income by period according to another alternate preferred embodiment of the present invention is shown. Refer to FIG. 23 for a description of the functions associated with the screen.

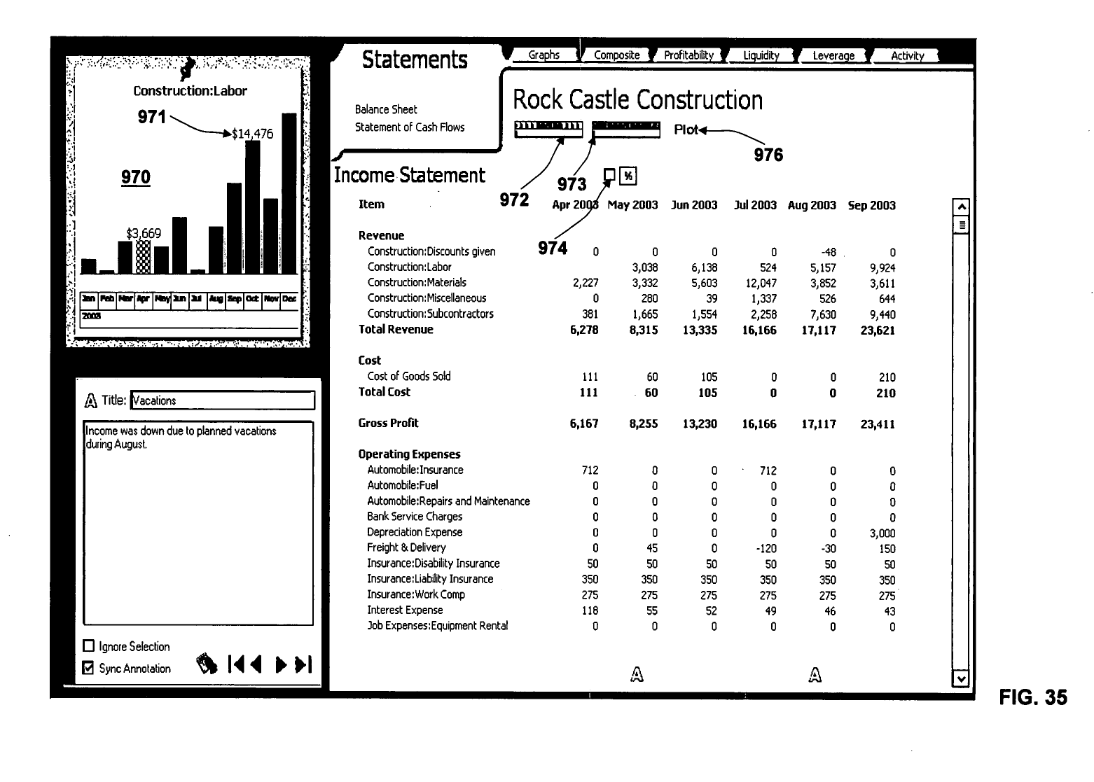

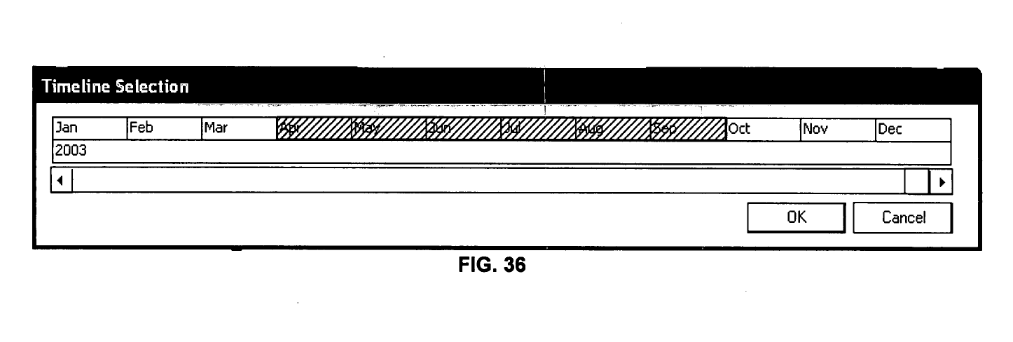

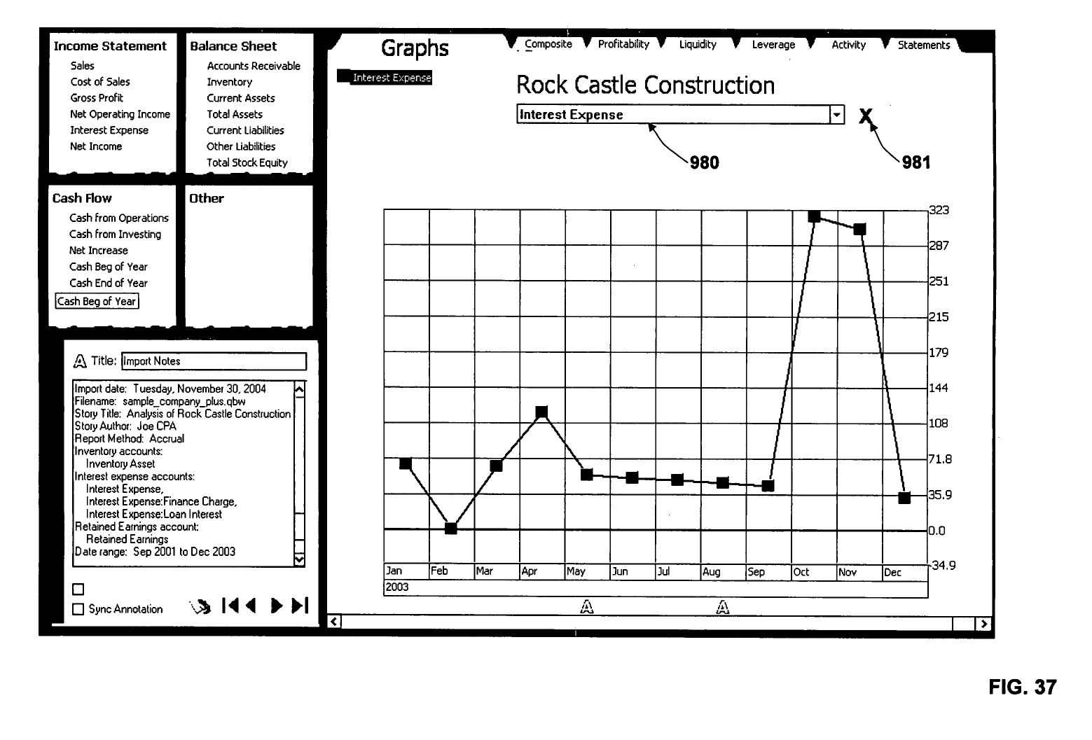

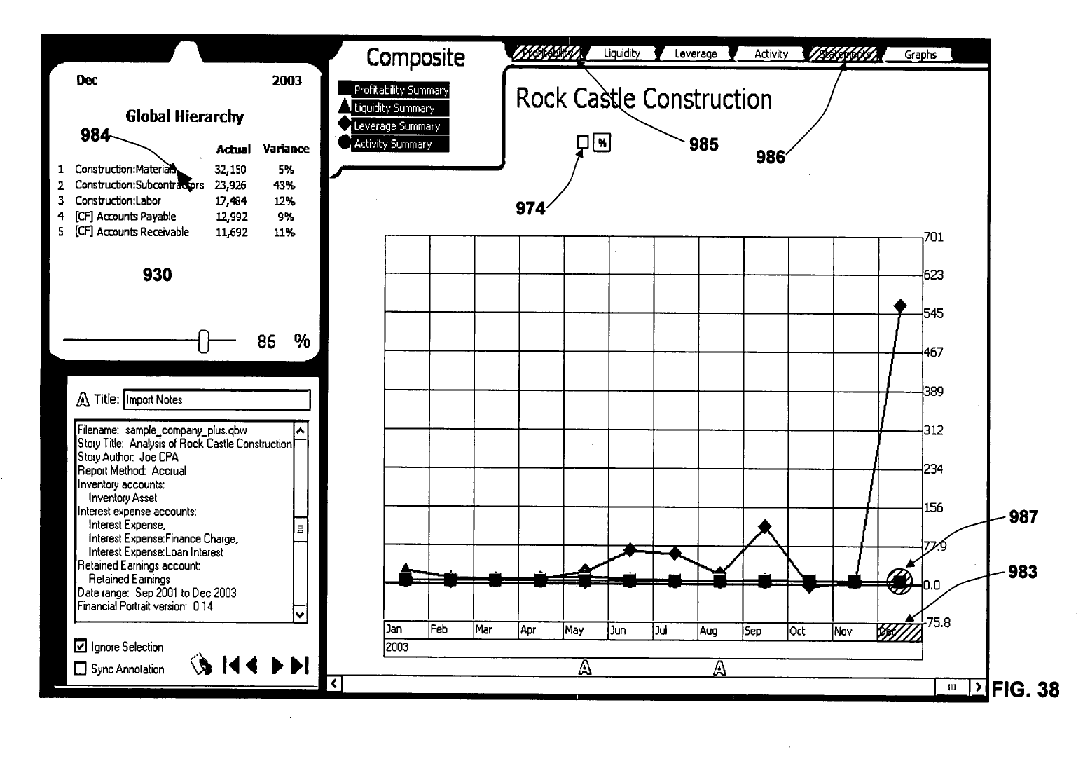

Referring to FIG. 35, a diagrammatical view of another alternate preferred user interface screen presenting an example of a graphical analysis tool related to a selected line item from the Income statement according to another alternate preferred embodiment of the present invention is provided (at least herein embodying wherein such at least one report is at least one financial report). Preferably, a user may “double click” a value for a line item shown in the Income statement, or any other report of data for a period of time and invoke the graphical analysis tool 970 (at least herein embodying at least one computer interface adapted to permitting selecting at least one data record having time-relevant values from such displayed data records having time-relevant values by such at least one first analyzer). As shown, the graphical analysis tool 970 preferably provides a time-based histogram of the variations in the values for the selected line for the period encompassed in the report (at least herein embodying at least one computer display adapted to displaying, simultaneously with such displayed data records having time-relevant values, at least one third graphical visualization relating to such selected at least one data record having time-relevant values; and at least herein embodying wherein such at least one third graphical visualization comprises at least one graphical representation of such selected at least one data record having time-relevant values relating to each sub-set time period included within such first analysis time period of such displayed data records having time-relevant values). Preferably, a user may view the specific value 971 of the selected line item by placing the mouse pointer over the desired bar and as long as the pointer resides on the bar the specific value will be displayed. Preferably, the specific value for a bar will be continuously displayed if the user clicks on the desired bar (at least herein embodying display adapted to continuously displaying at least one numeric value, relating to such selected at least one data record having time-relevant values, relating to such at least one sub-set time period selected by such at least one first analyzer). Preferably, the graphical analysis tool provides the histogram for the same time period as the report being displayed. The time period covered by the displayed report may be selected or modified by selecting the time line selection button 972. Preferably, the time period selection button 972 invokes the time line selection screen, as shown in FIG. 36, which preferably permits the user to set the report time periods. Preferably, selecting the reset time period button 973 will reset the selected time period for the report back to the default value for the report. Clicking on the sensitivity analysis checkbox 974 preferably invokes the sensitivity analysis display 975, as shown in FIG. 32. Once the sensitivity analysis tool 930 is presented the user may preferably choose any time period to view the most significant line items comprising the value being analyzed. Additionally, the user may preferably select the plot button 976 to invoke the plot display of a selected line item from the displayed report, as shown in FIG. 37.

Referring to FIG. 37, a diagrammatical view of another alternate preferred user interface screen presenting an example of a plot analysis for a selected report line item according to another alternate preferred embodiment of the present invention is shown. Preferably, the plot analysis for a selected report line item is saved with a unique name at the time the plot analysis is requested by the user so that it may be referenced at any time by selecting it from the plot list drop down list 980. Preferably, selecting the delete plot button 981 (symbolized by a red X) the currently displayed plot will be deleted.

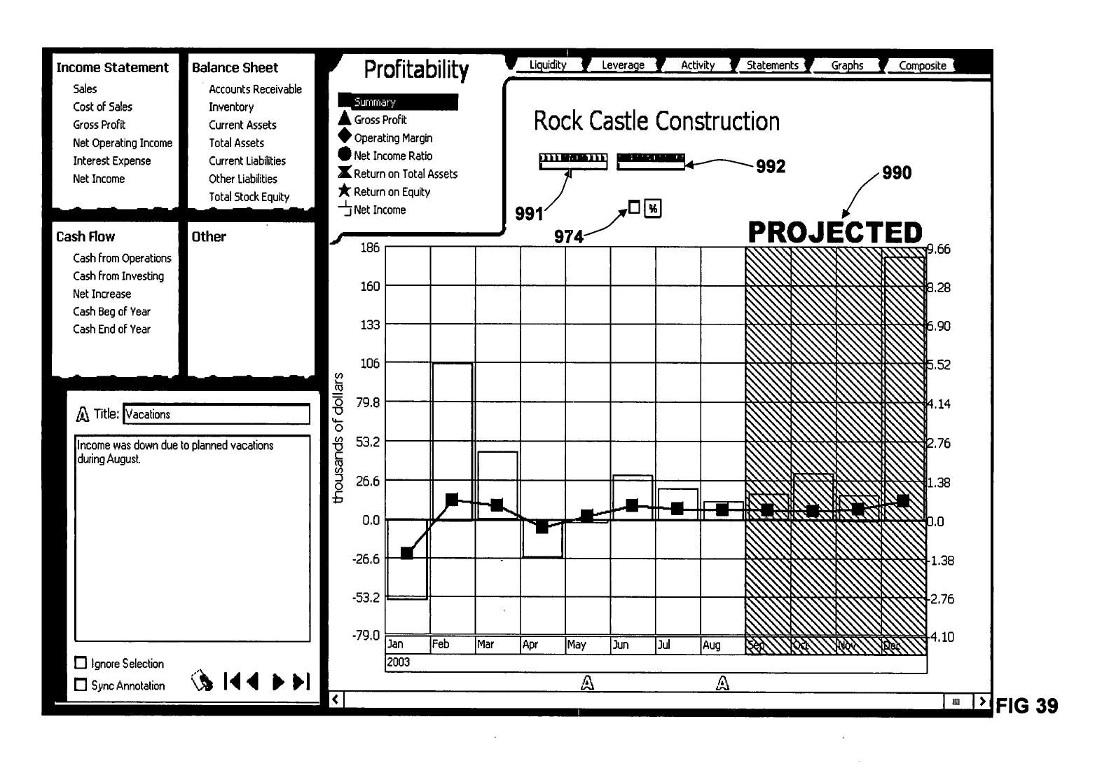

Referring to FIG. 38, a diagrammatical view of another alternate preferred user interface screen presenting an example of a composite sensitivity analysis tool in use with the a composite overview screen of company financial performance according to another alternate preferred embodiment of the present invention is shown. Preferably, a user may view the sensitivity analysis tool 930 for the most significant line items comprising the four primary performance measures being considered in the composite view of a company's performance. Preferably, the sensitivity analysis tool 930 behaves in the same manner as with financial reports, except that the sensitivity analysis encompasses all financial reports and information used to compile the performance measures displayed in the composite screen for a company. The sensitivity analysis time period is preferably indicated by highlighted month 983, as shown. Preferably, placing the mouse pointer 984 over a line item display in the sensitivity tool 930 will result in all related calculations 985, statements 986 and data points 987 being highlighted to assist the user in understanding and evaluating the underlying values.

Referring to FIG. 39, a diagrammatical view of another alternate preferred user interface screen presenting an example of a financial projection for a company according to another alternate preferred embodiment of the present invention is presented. Financial projections, budgeting and forecasting are critical elements to financial analysis. Therefore, the projection toolset preferably provides for creating, editing and previewing vector based projection data curves in addition to traditional budgeting tools. Preferably, the resulting projection data may be exported for use in other accounting or financial software systems. Preferably, a user may use this screen to make future projections of financial performance for a selected future time period. Preferably, a user may select one or more line items to be forecast and the number of prior periods to be considered in the forecast (at least herein embodying at least one computer processor adapted to calculating trends of at least one set of future trend-values relating correspondingly to at least one set of historical data records having time-relevant historical values, using at least one trend-line approach). For example, a user may preferably choose to use twelve prior periods as the basis for projecting the company's performance for the next nine future periods. Preferably, the method for selecting prior and future periods will be in the same manner as shown in FIG. 36, when the user selects the projection basis button 991 to set the prior periods to be used and when the user selects the future periods button 992 to set the future periods to be projected. Preferably, the projection algorithm performs at least two calculations to obtain the projected values. First, the algorithm will preferably use well known methods of projecting prior periods performance. Second, the algorithm will preferably evaluate period-to-period fluctuations and make adjustments to the results of the first projection on a period-by-period basis (at least herein embodying at least one computer processor adapted to re-calculating each such calculated future trend-value of such at least one set of calculated future trend-values considering each correspondingly related one of such at least one set of historical data records and varying each such future trend-value according to at least one direction and at least one amount of variation from at least one such trend line of such corresponding historical value, wherein at least one set of re-calculated values is provided). Preferably, a user may then revise any projected value by selecting the point on the plot and moving the plot point up or down to better reflect the user's judgment (at least herein embodying at least one computer display adapted to displaying at least one graphical analysis of such at least one set of re-calculated values; and at least herein embodying at least one computer interface adapted to permitting selecting of at least one of such at least one set of re-calculated values displayed within such at least one graphical analysis by such at least one first analyzer; and at least herein embodying at least one computer interface adapted to permitting modification of such selected re-calculated at least one value to produce at least one first amended re-calculated value by such at least one first analyzer). Preferably, simultaneously with the user's adjustment a Bezier curve calculation, or a rational B-spline calculation, or a polygonal area calculation, or a variable edge blur calculation is performed for the adjacent periods to reflect the impact of the user's changes to the selected value for the selected time period (at least herein embodying at least one computer processor adapted to re-calculating, using a Bezier curve calculation method, at least one second amended re-calculated value; and at least herein embodying comprises at least one computer processor adapted to re-calculating, using a rational B-spline calculation method, at least one second amended re-calculated value; and at least herein embodying at least one computer processor adapted to re-calculating, using a polygon area calculation method, at least one second amended re-calculated value; and at least herein embodying at least one computer processor adapted to re-calculating, using a variable edge blur calculation method, at least one second amended re-calculated value).

Preferably, historical data shapes derived from profitability, liquidity, leverage and activity can be adjusted, by interactively editing with a live update of the resulting projection. The projections may be viewed as a composite four summary performance measures or at the individual performance measure level. Individual graphical elements, such as points or areas and individual values may be independently or dependently calculated over a projection date range by the user. These re-calculations may be preferably accomplished by freehand movement of points on a graphic along with the application Bezier curves, and/or rational B-splines, and/or polygons evaluation calculations can be used to highlight, move, remove, isolate or combine various related data points.

The use of variable edge blur can be applied to whole data shapes, or individual curve segments, and simulated seasonal variation blur may also be used. Preferably the use of variable edge blur techniques results in a range of projection targets to accommodate the expected potential variation in future events.

Preferably the financial projections may be compared to actual outcomes to measure the performance and accuracy of management forecasting. Preferably budgets may be compared in finite numbers or as graphical representations.

Referring again to FIG. 39, preferably, a user may also elect to have the projection calculations consider target or goal values for any line item value being projected which have preferably been specified by the user. Additionally, preferably, projections may be analyzed using the same tools and methods used to analyze historical periods, including, but not limited to, attachment of annotations, graphical analysis, sensitivity analysis (by selecting the sensitivity analysis checkbox 974, and plot analysis and comparison of actual result with projected values.

Upon reading the teachings of this specification, those with ordinary skill in the art will now understand that, under appropriate circumstances, considering such issues such as licensor's requirements, the tools and methods encompassed by the preferred embodiments of the present invention, as described above, may be used with non-financial data exclusively or in combination with financial data.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

1) A system, relating to assisting sequential presentation of at least one analysis of at least one set of data records by at least one first analyzer, comprising the steps of:
a) providing at least one computer application adapted to assist computer-manipulating of such at least one set of data records by such at least one first analyzer to assist providing at least one sequential presentation of at least one set of analyses;
b) wherein such step of providing at least one computer application adapted to assist computer-manipulating of such at least one set of data records by such at least one first analyzer to assist providing at least one sequential presentation of at least one set of analyses comprises the steps of
i) providing, as part of such computer application, at least one first software tool adapted to permit such at least one first analyzer to add at least one sequentially-appropriate annotation to such at least one analysis, and
ii) providing as part of such computer application at least one second software tool adapted to permit such at least one first analyzer to sequentially organize such at least one set of analyses; and
c) permitting access to such resulting at least one sequential presentation of such at least one set of analyses.

2) The system according to claim 1 wherein such step of providing at least one computer application adapted to assist computer-manipulating of such at least one set of data records by such at least one first analyzer to provide at least one sequential presentation of at least one set of analyses comprises the step of providing at least one third software tool, as part of such computer application, adapted to permit editing of such at least one sequentially-appropriate annotation by such at least one first analyzer.

3) The system according to claim 1 wherein such step of providing at least one computer application adapted to assist computer-manipulating of such at least one set of data records by such at least one first analyzer to assist providing at least one sequential presentation of at least one set of analyses comprises the step of providing at least one fourth software tool, as part of such computer application, adapted to editing such at least one analysis by such at least one first analyzer.

4) The system according to claim 1 wherein such step of providing at least one computer application adapted to assist computer-manipulating of such at least one set of data records by such at least one first analyzer to assist providing at least one sequential presentation of at least one set of analyses comprises the step of providing at least one fifth software tool, as part of such computer application, adapted to re-sequence such at least one analysis by such at least one first analyzer.

5) The system according to claim 1 further comprising the step of permitting such at least one sequential presentation to reside on at least one Internet website.

6) A computer system, relating to assisting sequential presentation of at least one analysis of at least one set of data records having time-relevant values by at least one first analyzer, comprising:
a) at least one computer processor adapted to assisting computer-manipulating of such at least one set of data records having time relevant values by such at least one first analyzer to assist providing such at least one sequential presentation of at least one set of analyses;
b) at least one computer interface adapted to permitting use of said computer system by such at least one first analyzer to add at least one sequentially-appropriate annotation to such at least one analysis;
c) at least one computer interface adapted to permitting use of said computer system by such at least one first analyzer to sequentially organize such at least one set of analyses; and
d) at least one computer interface adapted to permitting use of said computer system by such at least one first analyzer to create at least one such sequential presentation from such at least one set of analyses.

7) The computer system according to claim 6 wherein such at least one computer processor adapted to assisting computer-manipulating of such at least one set of data records by such at least one first analyzer to provide such at least one set of analyses comprises at least one computer processor adapted to assisting recording at least one computer selection made by such at least one first analyzer.

8) The computer system according to claim 6 further comprising:
a) at least one computer processor adapted to accepting at least one first set of data records having time-relevant values relating to at least one first entity;
b) at least one computer processor adapted to providing at least one plurality of preset analysis calculation formulas;
c) at least one computer processor adapted to performing at least two calculations using at least two of such plurality of preset analysis calculation formulas on such at least one first set of data records having time-relevant values to obtain at least two first performance measures;
d) at least one computer processor adapted to calculating at least two second performance measures from such at least two first performance measures; and
e) at least one computer display adapted to simultaneously displaying such at least two second performance measures in a single first graphical visualization.

9) The computer system according to claim 8 further comprising:
a) at least one computer interface adapted to permitting selecting such at least two first performance measures for display by such at least one first analyzer;
b) at least one computer interface adapted to permitting selecting at least one first analysis time period by such at least one first analyzer; and
c) at least one computer display adapted to simultaneously displaying such at least two first performance measures in a single second graphical visualization relating to such at least one first analysis time period.

10) The computer system according to claim 9 further comprising:
a) at least one computer interface adapted to permitting selecting at least one second analysis time period by such at least one first analyzer; and
b) at least one computer processor adapted to assisting comparison of such at least one first performance measure relating to such at least one first analysis time period to such at least one first performance measure relating to such at least one second analysis time period.

11) The computer system according to claim 9 further comprising:
a) at least one computer interface adapted to assisting input of at least one user-defined analysis calculation formula by such at least one first analyzer;
b) at least one computer processor adapted to performing at least one calculation using such at least one user-defined analysis calculation formula on such at least one first set of data records having time-relevant values to obtain at least one user-defined performance measure relating to such at least one first analysis time period;
c) at least one computer interface adapted to assisting selecting, by such at least one first analyzer, of such at least one user-defined performance measure for display; and
d) at least one computer display adapted to simultaneously displaying at least two of such at least one user-defined performance measures in at least one second graphical visualization relating to such at least one first analysis time period.

12) The computer system according to claim 9 further comprising:
a) at least one computer processor adapted to comparing at least one of such at least two second performance measures to at least one quality-standard range of values; and
b) at least one computer display adapted to displaying such at least one of such at least two second performance measures not within such at least one quality-standard range of values.

13) The computer system according to claim 9 further comprising at least one computer display adapted to permitting display of at least one subset of such at least one first set of data records having time-relevant values relating to such at least one first analysis time period relating to such at least one first entity.

14) The computer system according to claim 13 comprising:
a) at least one computer interface adapted to permitting selecting at least one data record having time-relevant values from such displayed data records having time-relevant values by such at least one first analyzer; and
b) at least one computer display adapted to displaying, simultaneously with such displayed data records having time-relevant values, at least one third graphical visualization relating to such selected at least one data record having time-relevant values;
c) wherein such at least one third graphical visualization comprises at least one graphical representation of such selected at least one data record having time-relevant values relating to each sub-set time period included within such first analysis time period of such displayed data records having time-relevant values.

15) The computer system according to claim 14 further comprising at least one computer display adapted to continuously displaying at least one numeric value, relating to such selected at least one data record having time-relevant values, relating to such at least one sub-set time period selected by such at least one first analyzer.

16) The computer system according to claim 13 comprising:
a) at least one computer interface adapted to permitting such at least one first analyzer to select at least one percentage limit relating to calculating cumulative values boundaries relating to identifying such at least one second set of most-significant data records having time-relevant values;
a) at least one computer processor adapted to identifying such at least one second set of most-significant data records having time-relevant values, included in such at least one first set of data records having time-relevant values, within such cumulative values boundaries; and
b) at least one computer display adapted to presenting such identified second set of most-significant data records having time-relevant values to such at least one first analyzer.

17) The computer system according to claim 16 wherein such at least one computer interface adapted to permitting such at least one first analyzer to select at least one percentage limit relating to calculating cumulative values boundaries comprises at least one computer interface adapted to permitting such at least one first analyzer to reselect such at least one percentage limit relating to calculating cumulative values boundaries until the desired number of such identified data records having time-relevant values are presented.

18) The computer system according to claim 9 wherein such at least one annotation may be associated with at least one date.

19) The computer system according to claim 9 wherein such at least one annotation may be associated with at least one selected analysis category.

20) The computer system according to claim 9 wherein such at least one annotation may be associated with such at least one selected such performance measure.

21) The computer system according to claim 9 wherein such at least one annotation may be associated with at least one selected datum of such at least one first set of data records having time-relevant values.

22) The computer system according to claim 8 further comprising:
a) at least one computer processor adapted to accepting at least one second set of data records having time-relevant values relating to at least one second entity; and
b) at least one computer processor adapted to assisting comparison of such at least one second performance measure relating to such at least one first entity to such at least one second performance measure relating to such at least one second entity.

23) The computer system according to claim 8 further comprising;
a) at least one computer display adapted to displaying at least one overall measure of the reliability of such financial data using pre-set reliability standards;
b) at least one computer display adapted to displaying at least one overall measure of financial health of such at least one first entity; and
c) wherein such at least one overall measure of financial health comprises at least one weighted average value calculated from such at least two first performance measures.

24) The computer system according to claim 6 further comprising:
a) at least one computer processor adapted to calculating trends of at least one set of future trend-values relating correspondingly to at least one set of historical data records having time-relevant historical values, using at least one trend-line approach;
b) at least one computer processor adapted to re-calculating each such calculated future trend-value of such at least one set of calculated future trend-values considering each correspondingly related one of such at least one set of historical data records and varying each such future trend-value according to at least one direction and at least one amount of variation from at least one such trend line of such corresponding historical value, wherein at least one set of re-calculated values is provided;
c) at least one computer display adapted to displaying at least one graphical analysis of such at least one set of re-calculated values;
d) at least one computer interface adapted to permitting selecting of at least one of such at least one set of re-calculated values displayed within such at least one graphical analysis by such at least one first analyzer;
e) at least one computer interface adapted to permitting modification of such selected re-calculated at least one value to produce at least one first amended re-calculated value by such at least one first analyzer;
f) at least one computer processor adapted to re-calculating, using a Bezier curve calculation method, at least one second amended re-calculated value.

25) The computer system according to claim 24 further comprises at least one computer processor adapted to re-calculating, using a rational B-spline calculation method, at least one second amended re-calculated value.

26) The computer system according to claim 24 further comprises at least one computer processor adapted to re-calculating, using a polygon area calculation method, at least one second amended re-calculated value.

27) The computer system according to claim 24 further comprises at least one computer processor adapted to re-calculating, using a variable edge blur calculation method, at least one second amended re-calculated value.

28) The computer system according to claim 6 further comprising at least one computer processor adapted to identifying at least one fourth set of most-significant data records having time-relevant values, with respect to a plurality of performance measures, calculated from at least one third set of data records having time-relevant values used to calculate such plurality of performance measures.

29) The computer system according to claim 28 comprising:
a) at least one computer interface adapted to permitting selection of at least one percentage limit relating to calculating cumulative values boundaries relating to identifying such at least one fourth set of most-significant line items by such at least one first analyzer;
b) at least one computer processor adapted to identifying such at least one fourth set of most-significant data records having time-relevant values, included in such at least one plurality of third set of data records having time-relevant values, within such cumulative values boundaries; and
c) at least one computer display adapted to presenting such identified fourth set of most-significant data record having time-relevant values.

30) The computer system according to claim 29 wherein such at least one computer interface adapted to permitting selection of at least one percentage limit relating to calculating cumulative values boundaries for identifying such at least one fourth set of most-significant line items by such at least one first analyzer comprises at least one computer interface adapted to permitting continuously re-selecting, by such at least one first analyzer, such at least one percentage limit relating to calculating cumulative values boundaries until the desired number of such identified fourth set of most-significant data records having time-relevant values are presented.

31) The computer program according to claim 6 wherein such at least one computer interface adapted to permitting use of such computer program by such at least one first analyzer to create at least one such sequential presentation from such at least one set of analyses comprises at least one computer interface adapted to assisting editing of such at least one such sequential presentation from such at least one set of analyses by such at least one first analyzer.

32) The computer system according to claim 31 wherein such at least one computer processor adapted to assisting editing of at least one such sequential presentation from such at least one set of analyses by such at least one first analyzer comprises at least one computer interface adapted to permitting re-sequencing such at least two of such at least one set of analyses by such at least one first analyzer.

33) The computer system according to claim 32 wherein such at least one sequential presentation may comprise at least one customized-sequence annotated sequential presentation from such at least one set of analyses.

34) The computer system according to claim 6 further comprises the step of preparing at least one such sequential presentation viewable independently from such computer program.

35) The computer system according to claim 34 further comprising at least one computer processor adapted to permitting granting permission to alter such at least one sequential presentation to at least one second analyzer.

36) The computer system according to claim 34 further comprising at least one computer processor adapted to permitting granting permission to view such at least one sequential presentation to at least one third analyzer.

37) The computer system according to claim 6 wherein such at least one annotation comprises digitized text.

38) The computer system according to claim 6 wherein such at least one annotation comprises digitized audio.

39) The computer system according to claim 6 wherein such at least one annotation comprises digitized video.

40) The computer system according to claim 6 wherein such at least one annotation comprises at least one digitized image.

41) A system, relating to assisting sequential presentation of at least one analysis of at least one set of financial records by at least one first analyzer, comprising the steps of:
a) providing at least one computer application adapted to assist computer-manipulating of such at least one set of financial records by such at least one first analyzer to assist providing at least one sequential presentation of at least one set of analyses;
b) wherein such step of providing at least one computer application adapted to assist computer-manipulating of such at least one set of financial records by such at least one first analyzer to assist providing at least one sequential presentation of at least one set of analyses comprises the steps of
i) providing as part of such computer application at least one first software tool, as part of such computer application, adapted to permit such at least one first analyzer to add at least one sequentially-appropriate annotation to such at least one analysis, and
ii) providing as part of such computer application at least one second software tool, as part of such computer application, adapted to permit such at least one first analyzer to sequentially organize such at least one set of analyses; and
c) permitting access to such resulting at least one sequential presentation of such at least one set of analyses.

42) The system according to claim 41 wherein such step of providing at least one computer application adapted to assist computer-manipulating of such at least one set of financial records by such at least one first analyzer to assist providing at least one sequential presentation of at least one set of analyses comprises the step of providing at least one fourth software tool, as part of such computer application, adapted to editing such at least one analysis by such at least one first analyzer.

43) The system according to claim 41 wherein such step of providing at least one computer application adapted to assist computer-manipulating of such at least one set of financial records by such at least one first analyzer to assist providing at least one sequential presentation of at least one set of analyses comprises the step of providing at least one fifth software tool, as part of such computer application, adapted to re-sequence such at least one analysis by such at least one first analyzer.

44) The system according to claim 41 further comprising the step of permitting such at least one such sequential presentation resulting from such computer application labors to reside on at least one Internet website.

45) A computer program relating to identifying a second set of line items having time-relevant line item values from within at least one report containing at least one first set of line items having time-relevant values comprising the steps of:
a) assisting presenting such at least one report containing such first set of line items having time-relevant values to at least one user;
b) permitting such at least one user to select at least one percentage limit relating to calculating cumulative values boundaries;
c) identifying such at least one second set of line items having time-relevant values, included in such at least one first set of line items having time-relevant values, within such cumulative values boundaries; and
d) presenting such identified second set of line items values having time-relevant values to such at least one user.

46) The computer program according to claim 45 wherein such step of permitting such at least one user to select at least one percentage limit relating to calculating cumulative values boundaries comprises the step of permitting such at least one user to continuously reselect such at least one percentage limit relating to calculating cumulative values boundaries until the desired number of such identified line items having time-relevant values are presented.

47) The computer program according to claim 45 wherein such at least one report is at least one financial report.

48) A computer program relating to time-based graphical analysis of at least one line item having time-relevant values within at least one report relating to at least one time period comprising the steps of:
a) assisting presenting such at least one report containing such line items having time-relevant values to at least one user;
b) permitting selecting such at least one line item having time-relevant values from such displayed at least one report by at least one user; and
c) displaying, simultaneously with such displayed at least one report, such at least one time-based graphical analysis relating to such selected at least one line item having time-relevant values;
d) wherein such at least one time-based graphical analysis comprises at least one graphical representation of such selected at least one line item having time-relevant values relating to each sub-set time period contained within such at least one time period of such displayed at least one report.

49) The computer program according to claim 48 wherein such at least one report is at least one financial report.

50) A computer program relating to forecasting at least one set of future values relating to at least one set of historical data records having time-relevant historical values comprising the steps of:
a) using at least one trend-line approach, calculating trends of such at least one set of future trend-values relating correspondingly to such at least one set of historical data records having time-relevant historical values;
b) re-calculating each such calculated future trend-value of such at least one set of calculated future trend-values considering each correspondingly related one of such at least one set of historical data records and varying each such future trend-value according to at least one direction and at least one amount of variation from at least one such trend line of such corresponding historical value, wherein at least one set of re-calculated values is provided;
c) displaying at least one graphical analysis of such at least one set of re-calculated values;
d) permitting selecting of at least one of such at least one set of re-calculated values displayed within such at least one graphical analysis;
e) permitting modification of such selected re-calculated at least one value to produce at least one first amended re-calculated value;
f) re-calculating, using a Bezier curve calculation method, at least one second amended re-calculated value.

51) The computer program according to claim 50 further comprises re-calculating, using a rational B-spline calculation method, at least one second amended re-calculated value.

52) The computer program according to claim 50 further comprises re-calculating, using a polygon area calculation method, at least one second amended re-calculated value.

53) The computer program according to claim 50 further comprises re-calculating, using a variable edge blur calculation method, at least one second amended re-calculated value.

54) The computer program according to claim 50 wherein such at least one set of data records having time-relevant historical values is at least one set of financial data records having time-relevant historical values.

55) A computer program relating to identifying at least one second set of most-significant line items having time-relevant values, with respect to at least one plurality of performance measures, calculated from at least one first set of line items having time-relevant values, used to calculate such plurality of performance measures, comprising the steps of:
a) permitting selection of at least one percentage limit relating to calculating cumulative values boundaries relating to identifying such at least one second set of most-significant line items by at least one user;
b) identifying such at least one second set of most-significant line items having time-relevant values, included in such at least one plurality of first set of line items having time-relevant values, within such cumulative values boundaries; and
c) presenting such identified second set of most-significant line items values having time-relevant line item values to such at least one user.

56) The computer program according to claim 55 wherein such step of permitting selection of at least one percentage limit relating to calculating cumulative values boundaries relating to identifying such at least one second set of most-significant line items by at least one user comprises permitting continuously reselection of at least one percentage limit relating to calculating cumulative values boundaries relating to identifying such at least one second set of most-significant line items by such at least one user.

57) The computer program according to claim 55 wherein such at least one first set of line items having time-relevant values is at least one set of financial records.
